(19) United States
(12) Patent Application Publication
(10) Pub. No.: US 2010/0230508 A1
(43) Pub. Date: Sep. 16, 2010

(54) God device genres cadres

(76) Inventor: Svetozar B. Petrovich, Chicago, IL (US)

Correspondence Address: Svetozar B. Petrovich, 6526 North Pondartrain Blvd., Chicago, IL, 60646, US

(21) Appl. No.: 12/453,444

(22) Filed: May 12, 2009

Related U.S. Application Data
(62) Division of application No. 12/153,032, filed on May 13, 2008.

(51) Int. Cl. A01G 15/00

(52) U.S. Cl. 239/14.1

(57) ABSTRACT

Globose-conduit (GC) conforming embodiments Universe of quintessential, core, natural disposition mass energy highest conserving (QCNDMEHC) forces completely matched complete complements compact composite Sets. ‘Fluids functions’ conforming least mass compositions at highest elevations least GC height least length continuous compact composite, fluid free-surfaces composite least rotations, fluids quanta forms least height perimeters most conserve mass energy. Buried GC QCNDMEHC thermal aqueducts transfer their mass-energy heat portion into subsoil, combat ‘global warming’, the Earth's crust surface cooling, sea levels rising and submicroscopic, subatomic to cosmos mass systems heat energy forced electro-thermodynamics electromagnetics perimeters buoyancy/density, evaporation and suction. Universal stratifications, gradations (SG) processes ‘global warming’, energy crises and water masses depletions which imperil the Earth's survival, fluids MEHC, QCMEHC and QCNDMEHC combat; the God device said Earth's fluids ‘functions’, said perimeters' mass energy highest conserving said cadres genres ardently enforce.

This application is the following applications serial number continuations:
DIV CON of Ser. No. 12/153,036 May 13, 2008 and is a Ser. No. 11/809,132 May 31, 2007 and is a continuation of Ser. No. 11/807,748 May 30, 2007 and is a continuation of Ser. No. 11/788,172 posted Jun. 4, 2007 (Apr. 18, 2007 Confirm. No. 5382) and is a continuation of Ser. No. 11/724,752 claiming filing date Mar. 9, 2007, assigned Mar. 15, 2007 and is a DIV CON of Ser. No. 12/382,448 Mar. 17, 2009 and is a DIV CON of Ser. No. 12/320,441 Jan. 26, 2009 and is a DIV CON of Ser. No. 12/320,440 Jan. 26, 2009 and is a DIV CON of Ser. No. 11/809,132 May 31, 2007 and is a DIV CON of said Ser. No. 11/788,172 Jun. 4, 2007 date and is a DIV CON of said Ser. No. 11/724,752 Mar. 15, 2007 and is a Petition to revive dated Oct. 21, 2007 DIV CON of Ser. No. 11/418,157 May 3, 2006 and said DIV CON of said Ser. No. 12/382,448 Mar. 17, 2009 is a DIV CON of said Ser. No. 12/320,441 Jan. 26, 2009 and is a DIV CON of said Ser. No. 12/320,440 Jan. 26, 2009 and is a DIV CON of said Ser. No. 12/153,036 May 13, 2008 and is a DIV CON of said Ser. No. 11/809,132 May 31, 2007 and is a DIV CON of said Ser. No. 11/788,172 Jun. 4, 2007 and is a DIV CON of said Ser. No. 11/724,752 Mar. 15, 2007 and said DIV CON of said Ser. No. 12/320,441 Jan. 26, 2009 and is a DIV CON of said Ser. No. 12/153,036 May 13, 2008 and is a DIV CON of said Ser. No. 11/809,132 May 31, 2007 and is a DIV CON of said Ser. No. 11/788,172 Jun. 4, 2007 and is a DIV CON of said Ser. No. 11/724,752 Mar. 15, 2007 and said DIV CON of said Ser. No. 12/320,440 Jan. 26, 2009 and is a DIV CON of said Ser. No. 12/153,036 May 13, 2008 and is a DIV CON of said Ser. No. 11/809,132 May 31, 2007 and is a DIV CON of said Ser. No. 11/788,172 Jun. 4, 2007 and is a DIV CON of said Ser. No. 11/724,752 Mar. 15, 2007 and said Ser. No. 11/809,132 May 31, 2007 is a continuation of said Ser. No. 11/807,748 May 30, 2007 and is a continuation of said Ser. No. 11/788,172 Jun. 4, 2007 and is a continuation of said Ser. No. 11/724,752 Mar. 15, 2007 date and is a continuation of Ser. No. 11/504,304 Aug. 14, 2006 and is a continuation of said Ser. No. 11/418,157 May 3, 2006 and is a continuation of Ser. No. 11/385,078 Mar. 20, 2006 and said Ser. No. 11/418,157 May 3, 2006 is a continuation of Ser. No. 11/233,546 Sep. 23, 2005 and is a continuation of Ser. No. 10/869,752 Jun. 16, 2004 and is a continuation of Ser. No. 10/156,192 May 28, 2002 and said 11/504,304 is a continuation of said Ser. No. 11/385,078 Mar. 20, 2006 and is a continuation of Ser. No. 11/342,006 Jan. 30, 2006 and is a continuation of said Ser. No. 11/233,546 Sep. 23, 2005 and is a continuation of Ser. No. 11/212,943 Aug. 25, 2005 and is a continuation of Ser. No. 10/840,152 May 5, 2004 and is a continuation of said Ser. No. 10/156,192 May 28, 2002 and is a continuation of Ser. No. 11/188,339 Jul. 25, 2005 and is a continuation of Ser. No. 11/028,982 Jan. 3, 2005 and is a continuation of Ser. No. 10/742,485 Dec. 19, 2003 and is a continuation of Ser. No. 10/190,993 Jul. 8, 2002 and is a continuation of Ser. No. 10/195,668 Jul. 15, 2002 and is a continuation of said Ser. No. 10/190,993 Jul. 8, 2002 and is a continuation of said Ser. No. 10/156,192 May 28, 2002 and is a continuation of Ser. No. 10/073,914 Feb. 14, 2002 and is a continuation of Ser. No. 09/850,927 May 8, 2001 and is a continuation of Ser. No. 09/376,957 Aug. 18, 1999 and said Ser. No. 11/223,546 Sep. 3, 2005 is a continuation of said Ser. No. 11/212,943 Aug. 25, 2005 and is a continuation of said Ser. No. 11/188,339 Jul. 25, 2005 and is a continuation of said Ser. No. 10/869,752 Jun. 16, 2004 and is a continuation of said Ser. No. 10/840,152 May 5, 2004 and is a continuation of said Ser. No. 10/156,192 May 28, 2002 and is a continuation of Ser. No. 10/074,966 Feb. 13, 2002 and is a continuation of said Ser. No. 09/850,927 May 8, 2001 and said Ser. No. 10/869,752 Jun. 16, 2004 and is a continuation of said Ser. No. 10/742,485 Dec. 19, 2003 and is a continuation of said Ser. No. 10/190,993 Jul. 8, 2002 and is a continuation of said Ser. No. 09/850,927 May 8, 2001 and said 10/742,485 is a continuation of said Ser. No. 10/156,192 May 28, 2002 and is a continuation of said Ser. No. 09/850,927 May 8, 2001 and is a continuation of said Ser. No. 09/376,957 Aug. 18, 1999 and said Ser. No. 09/850,927 May 8, 2001 claims benefit of 60/231,514 Sep. 9, 2000 and claims benefit of 60/226,750 Aug. 21, 2000 and claims benefit of 60/220,358 Jul. 24, 2000 and claims benefit of 60/217,308 Jul. 11, 2000 and is continuation of Ser. No. 09/518,884 Mar. 6, 2000 (contains 09/376,957 Aug. 18, 1999) and claims benefit of 60/123,153 Mar. 6, 1999 and claims benefit of 60/123,207 Mar. 8, 1999 and claims benefit of 60/123,504 Mar. 9, 1999 and is a continuation of said Ser. No. 09/376,957 Aug. 18, 1999 and claims benefit of 60/123,153 Mar. 6, 1999 and claims benefit of 60/123,207 Mar. 8, 1999 and claims benefit of 60/123,504 Mar. 9, 1999 and is a continuation of Ser. No. 08/950,898 Oct. 15, 1997, U.S. Pat. No. 5,941,273

### BACKGROUND OF THE INVENTION

Domestic priority data filed applications fluids mass and energy sciences herewith extend to minimal appreciation they deserve, referred to the science communities for global recognition.

### SUMMARY OF THE INVENTION

Globose-conduit (GC) conforming embodiments Universe of quintessential, core, natural dispositions mass energy highest conserving (QCNDMEHC) force completely matched complete complements compact composite Sets. ‘Fluids functions’ conforming least mass compositions at highest elevations least GC height least length continuous compact composite, fluid free-surfaces composite least rotations quanta mass forms perimeters least height most conserves mass energy; an inflow Inlet and the GC, basin-outlet, perimeter enclosure Sets or forms force quanta quantum mass paths-of-passage, PP, least sum lengths, in part upper retention submerged transition region respective undersurfaces-form as a globose Inlet lower end, an End 2, or a globose-inverse outlet spout lower end, a First End; the Inlet End 2 or the outlet First End globose perimeters fluid mass steady transports along lowest surfaces short slopes height, length and narrow breadths narrowest PPLD bands width force conduits mode forms; manipulated cross-sections varied areas complete complement breadths lift, raise, and set up higher density masses in front of much larger, globose boundaries, frictionless free surfaces, and conforming least mass uniform atmospheric, restrained hydrostatic, fluids steadied pressures dynamic flows; quanta masses transports, especially highest density fluids with raised mass centroids have right-of-ways entirely through said lowest surfaces at least three manipulated cross-sections modulating areas. A Set complete complement breadths complete complement globose open channel large free-surface forms least perimeter, height, and PAP angle (less than 180°) quanta mass least rotations are mass energy highest conserving FESD forms. Globose-conduit functions need much smaller fluids quanta mass Set or forms than those of ubiquitous art. The End 2 or the First End, from sidelong to anti-sidelong locations, constitute domain Sets; globose and circumferential strain mutations make up hybrid domains; the globose-conduits drainage lines complete complement composite breadths enforce a small lower region, a mostly submerged transition region, and large upper globose region forms. Flush Apparatus pre-assembled inside walls of forms adeptly flush, sterilize, and or coat surfaces; the globose-conduit Inlet, basin-outlet GC Universe Sets and forms force QCNDMEHC conforming two globose two conduit ‘fluids functions’ mass energy synchronous coincident four-perimeters, boundaries mass energy highest conserving (MEHC), QCNDMEHC respective QCMEHC transistors/processors.

The conforming GC Universe fluids mass-energy four ‘functions’ confirm said continual Universe omnipresent four generic claims defined perimeters boundaries as one and the same, as the ‘functions’ force ‘sub-functions’ retained, transported mass-energy forces said generic claims quantum masses paths and patterns enforced perimeter boundaries forms and Sets and vice versa. Thus, the ‘forms equal functions’ confirm, reconfirm and resolve Arts and Sciences many issues, such as, forcing reply to the Earth's ‘global warming’ mass-energy forced outflows into Cosmos.

These innovations correct the scientific community resources overlooked GC Sets, forms Universe, mass-energy highest conserving, MEHC, and QCNDMEHC formations and processes. Valid enormous GC Sets significance is on par with the Laws of Mass and Energy Conservation. The GC Sets MEHC perimeters enforce enormously significant boundaries implements the Laws of Mass and Energy Conservation in latent efforts to save the God device from goddamn devices. Four generic claims physics, chemistry, thermodynamics laws and forbidden mechanisms merge. Buried GC QCNDMEHC thermal aqueducts transfer their mass-energy heat portion into subsoil-surroundings through perimeter boundaries (except for insulated globose crown portions) with or without irrigation combat ‘global warming’, the Earth's surface cooling, and the sea levels rising. Near vacuum, least density least globose masses energy light pushed to infinity globose-conduits (GC) Sets mass-energy paths and patterns approach the speeds of light; the GC aqueducts cycled subatomic submicroscopic to cosmos mass heat energy systems combat electro-thermodynamics electromagnetics bounded perimeters Universe forced buoyancy/density, evaporation and suction forcing; energy ions, sequential equilibriums transport, generic claims compliant, force pressures and temperatures funnel spouts gravitational and dipolar electromagnetic fields' hydrodynamics, thermodynamics boundaries flux ions and electrons electro-superconducting up to speed of light.

Said aqueducts are the first and only pro growth, supplied side economics, geological age periods direct intervention for the Earth's, Milky Way Galaxy living organisms' survival, highest conserving mass energy transports that conserve orbital masses irreplaceable commodity—water. Aqueducts GC Sets and forms mass energy highest conserving in potential energy least elevation drop toward water-vapor emissions cuts force ‘greenhouse gases’ evaporations emissions cuts, in what are the Earth's atmosphere, “fast heating” potentially irreversible ‘global warming’ effects. Inflow water screens, intakes, and the GC aqueducts engineering construction technologies exist.

Aqueducts with invert at steady state temperatures 2-3 m below grade dissipate heat easier than a stagnant air mass-media; as rivers strategic parts, said aqueduct energy highest conserving makes them rise continually in respect to natural-rivers. Aqueducts detained storm/ground water mass slowly moves, enforcing heat energy radiated into subsoil as transported water mass energy steady flows ambience normally near coolest temperature and constitute investing into a precious commodity retention, detention and transport into industrial zones drinking, potable, recreational, commercial, or heavy industrial water usage processes. Pitched aqueducts into said zones reduce circulating water pumps operations, power consumption, and plants down time repair costs, labor and materials; conserving purified or processed, commercial or industrial water energy, aqueduct sets rout to the next destination or industrial zone or eventual aqueducts water last length cooling prior to a discharge into a major water body. Said mass energy conserving enforces cooler water masses management with no water evaporation loss to avoid water-vapor mass in the atmosphere prior to eventual release, with rivers land erosion managed or reversed, with industrial waste heat by-products land mass retained. Said heat energy transfer forces the Earth's crust as heat-sink to cool or in irrigation retain water-vapors precipitation or raise groundwater elevations indefinitely continually forced cooler large water bodies for atmospheric masses smaller water-vapor masses.

The aqueducts essential heat energy transfers from atmospheric precipitations and surface runoffs to subsoil also provides for irrigation means to raise groundwater levels with a watershed runoff and topsoil losses control; an ecosystem support can include hydronic farming agriculture.

Groundwater levels at prior historically higher natural elevations provide significant fresh water forced underground retention or detentions, especially where forced throughout continental climate zones; the underground aqueducts reduced evaporation, make for riverbanks, flood levies related structures, river water temperature curbs and topsoil moisture control to counteract higher precipitation rates, raised ocean levels and polar caps or glaciers melting. The continental crusts' water evaporations conforming to crustal geology, groundwater, and recent topsoil historical data removes significant water-vapor masses retained by the atmosphere, in a water mass global effort transports, by safe best technologies most cost effective methods for paybacks through centuries.

Water-vapor models showed ‘greenhouse-effects’ three times those of the carbon dioxide with the two combined forcing about half of the ‘global warming’. Said structural GC-aqueducts MEHC Sets strategic locations in the Earth's crust, gravity field, and its atmosphere mass energy thermodynamics as the God device genres cadre must enforce strategic magnetic field's systemic equilibriums' stabilities; from rivers and river flood plains, aqueducts claim orbital globose crust, gravity magnetic field, atmosphere, ionosphere, and solar winds deformed magnetosphere fluids' configured multiple systems flux balanced equilibriums consistencies, affixed strategic locations.

Aforesaid point to oceans masses forcing ‘global warming’. Greenhouse gases force heat transients peaks; the ionosphere as the cooling media ionized water-vapors replenish. Irrefutable corrective action, unquestionable germane scientific factual data force the God device aqueducts.

The Earth's uniform radially directional gravitational force spherical field forces orbiting crust masses atmosphere, ionosphere constituted globose forms; the atmosphere, troposphere and stratosphere similar perimeter forms are contained by the ionosphere inside a perimeter boundary shapes controlled by the Earth's dipolar magnetic field lines globose shapes that in said magnetic cusps conceal funnel like shapes and their access into the Earth's fluids. At the geographic poles proximities, the funnel like forms retain access into the atmosphere, ionosphere quantum masses, especially when a cusp's innermost or dipolar outermost lines disconnect. With the two cusps as conduits, the Earth's electromagnetic field generates its GC, globose-conduit, Set where either of said cusps' lower end the Earth's fluids submerge for an End 2 and a globose domains Set, which forces the other cusp as an outlet with a fluids submerged First End in a globose-inverse domains Set; fluids flow directions enforce the Earth ‘functions’ as the globose or the globose-inverse Set.

Milankovic's timing mechanisms ties the Earth's motions cyclic rotational tilt from about 21.5 to 24.5 degrees, precession periods, and orbital eccentricities to Earth's glacial periods. The timing mechanisms here include magnetic and gravitational field fluids, elector-thermodynamics, and entire cosmos galaxies systemic effects as the largest and subatomic, submicroscopic entities as the smallest gears of the time clock mechanisms that is universe. The Earth has fluids electro-thermodynamics mass energy sequential equilibriums thermodynamics forms superconducting in the Milky Way galaxy Solar System that includes smallest to largest globose-conduit forms, with each living organism detail conforming to the universal mass energy laws that enforce a must fit.

The Earth's magnetic field atmosphere, ionosphere, and the cusp funnels tilt, wobble, and hold the Moon in a synchronous orbit eccentrically about the Sun, located asymmetrically within one of the Milky Way galaxy limbs generally traveling through interstellar dust regions of varied compositions, densities, and radiations, and changing gravitational and magnetic field forces. To the Milankovic's work background noise, but herein, the Earth's GC mass crust, atmosphere, and magnetosphere fluid-thermodynamics electro-superconducting forces its mass energy accounted.

The solar radiation ionizes the atmosphere 50-80 km above the Earth's surfaces. At these altitudes molecular structures break into ions; the atmosphere's extension into the ionosphere has negatively charged electrons insignificant masses float around monatomic ions' masses. Under a forcing the electrons flow along the magnetic field lines; the ionosphere mass is restrained by the gravity and electromagnetic field forces usually stronger than ions, free electrons collision forces but not always stronger than the solar or cosmic winds and radiations and their forcing pressures. The dynamic perimeters fluxing GC magnetosphere boundaries try to preclude ions escaping into space, but each of the two magnetic field lines spout funnel cusps can function as an outlet vent.

The Earth's magnetosphere dipole magnetic field perimeter boundaries enclose the cusps' funnels to constitute GC perimeter forms, highly influenced by the solar and interplanetary winds pressure and radiations that affect magnetic field lines and the funnels; said winds with pressures deform the magnetosphere; the magnetic field instantly engages to constitute the magnetic field's lines stable equilibrium boundaries. Said atmosphere, magnetosphere dynamics force ionosphere temperatures pressures magnetic field lines electrons flow to counteract, restore, and reconnect to reassemble magnetic lines into stable electro-thermodynamic equilibrium fluxing configurations.

Recent satellites observed plasma fountains shaped by the magnetic poles cusps extended from geographic poles proximity through the magnetosphere spew hydrogen, helium and oxygen ions plasma into space; cosmic, solar wind pressures coronal mass ejections and plasma outflows distort the magnetosphere shoulders skimming passed the Earth's rotations tilted magnetic cusps' mouths forced monatomic ions energetic plasma discharges into space; the ionosphere boundary suction indeed exists as a catalyst to plasma discharges and atmosphere's catastrophic blow-offs.

The Earth's magnetosphere cusps converge the magnetic field lines into the only singular regions where cosmos and solar radiations and winds have direct access to altitudes of molecular air or vice versa. The cusps regions magnetic field lines connect virtually to everywhere with the magnetic field lines and convection processes; the cusps bunch closely magnetic lines very much to inhibit a fluids access; solar wind pressures, interplanetary radiations and magnetic fields, with the solar and the very close Moon gravitational force pull force the atmospheric, the oceanic, and the Earth's molten core tidal forces. Any suction from the cusp's mouth tilted toward Sun forces the ionosphere electro-thermodynamic pressure relief prompt response which always occurs with the magnetosphere under said forces and pressures; incoming and outgoing magnetic lines break-off innermost pair increasing plasma fountain ions' flow; as flows increase, the break-offs occur; at lower altitudes cusp's breadths broaden; least molecular density, highest buoyancies hydrogen, helium, and oxygen ions spew into space separated as a fountain's concurrent discharge; ozone, a triatomic oxygen, ionosphere's stratified layer above isotropic air masses depletes near the poles.

The magnetic field lines ions' flows electrical currents may attain enormous velocities; an Ionosphere funnel cusp spout pure pressures large enough suction or high energy ions, sequential equilibriums transport, generic claims compliant, force pressures and temperatures funnel spouts, gravitational and dipolar electromagnetic fields hydrodynamics thermodynamics boundaries flux ions and electrons electro-superconducting up to speed of light. Supra least densities fluids ‘pure pressures’ enforce ions masses transfers and thermodynamic pressures, electrical forces magnetic field electrons flows with least energy loss. A cusp centric incoming and outgoing proximities of directionally opposite electrical currents forces the magnetic field lines' constructions disconnect links; boundary pressures stopped magnetic lines instantaneous reconstruction has consequences.

‘Pure pressures’ large enough suction unless alleviated promptly can cause the following:
I. At magnetized planets, solar winds wakes forced boundaries vacuum conditions and the polar ionosphere forcing supersonic plasma fountain flows, the “Jean's fountain, atmospheric escape enhancements”, recent observations; Universe space huge “hole” one-billion light years breadth of nothing and entirely devoid of matter space vacuum.
II. Historical geologic ice sheets extended into the Earth's tropical belt. The Pleistocene glacial interglacial periods, North American land based chronology, glacial advances: Wisconsin, Illinoian, Kansan, Nebraskan, interglacial Sangamon, Yarmouth, Aftonian geologic evidence that points to the glaciers mass water budget significant depletions.
   Said Earth's fluids most critically modulate to magnetopause said electromagnetic field boundary flux perimeter integrity, volume and ionosphere noted mass depletions cosmos dynamics, solar winds/radiations and atmospheric pressures/radiations forced. Thus, ocean levels rise with glaciers melting significantly happily confirms said Earth fluids escape is slowed; otherwise the imperiled Earth is passed the point of no return.
   The ionosphere nearly constant pressures rising temperatures expand its perimeter boundaries that face the cosmic pressures and radiations much like air balloon inflates to greater surface areas and greater volume; the magnetic field lines bound ionosphere must spew out contained mass that is almost entirely water vapor ions along magnetic field cusps as plasma flows fountain discharge rather than a magnetic line disconnect;
III. Observed extrasolar planet's hydrogen, oxygen, and carbon hydrodynamic escape from a huge volume atmosphere with supersonic whirlwinds “swept up” oxygen, with single carbon ions from low elevations; the planet's star ultraviolet radiations allowed for the “blow-off” escape; the star's light energy ‘pushed’ the hydrogen cloud outside the planet's gravity field, with said ‘pure pressure’ no cohesion, adhesions, or friction.

Supra brief details of the Earth's geological history with astronomical observations reveal the iron clad evidence that the Earth is in the fight for the survival of its living organisms, as it is loosing its water “cooling/heating” fluids, from aged or inefficient thermodynamics mechanisms; we must act because the organisms in part is us; internal processes density, buoyancy, along with evaporation and suction mechanisms force said fountains, ‘blow-off bursts or suctions perimeter dynamic boundaries forbidden disequilibrium mechanism. The Earth's gravity and fluids masses electro-thermodynamics’ energy responses to said solar-cosmos wind pressures, radiations on its atmosphere and ionosphere masses with dynamic perimeters resort to the forbidden mechanisms; hundreds of millenniums of tectonic movements and crustal erosion aged the Earth's cooling and heating combined mechanism which now has, with few exceptions, its major rivers in or flowing into the tropical belt, against the Earth's globose form equatorial bulge. Said glacial ice erosions forced the rivers directionality and supplied the water to establish or cut shorter paths. Herewith “fluid” or “hydro” refers to identical liquids with gaseous phases' state fully inclusive, within the thermodynamic constituents; the tropical belt concentrated water masses readily evaporate water-vapor quantities for fountains spewed discharge except for the periods when temperatures trigger the thermodynamics forced onset of an ice age; electromagnetic field's higher temperatures force ions mass spewed into space under cosmic/solar pressures/winds battered magnetopause retained volume surfaces forcing mass volume perimeter boundaries instantaneous larger oscillations with plasma, ions mass, fountain discharges to reduce the magnetopause size and retained fluids mass, ions, temperatures. Forcing thermodynamics ionized water-vapor monatomic ions replenish said lost plasma to attain fluids masses balance; spewed mass burst triggered significant suction force can singly cause the atmospheric mass losses and temperatures default drop for the ice age onset.

Milankovich glacial triggers timing mechanisms with modulations fluctuate considerably. Scientific community accepted calculations predict no glaciation period for the next thousands of years. Natural thermodynamics forced the Earth's losing water-vapor for 4.5 billion years which predict historical water-vapor exhausted resources for the Earth's lifeless freeze default outcome.

Said magnetopause boundaries perimeters behave roughly like a water droplet exposed to supersonic flows; the Earth's outermost magnetic field lines magnetopause enormous boundaries ripple or flap and sometimes droplets will break off, or said outermost magnetic line disconnects. The Earth gravitational and electromagnetic fields magnetopause hydrodynamic thermodynamics electrons and ions enormous mass flows velocities response to solar and cosmos winds, pressures and radiations force magnetic and gravitational (cosmos, solar, Moon tidal, seasonal and diurnal) Universe perimeters bound equilibrium states that avoid a forced forbidden mechanism response.

The Earth's electromagnetic field functions as the Nikola Tesla's motor-generator version and the magnetosphere as a turbine enforcing instantaneous reversals of said three forced by said radiations, wind pressures, and gravitational forces; the cusps as said turbine trust engine nozzles spew ions to space forced by said forces and the magnetosphere hydrodynamics thermodynamics equilibriums disconnect, reconnect and restore the magnetosphere and the magnet lines integrity.

The atmosphere with ionosphere required stable electromagnetic and thermodynamic flux equilibriums split air molecules enlarge magnetic lines ionosphere boundaries unless said plasma fountain occur with cooling effects; when the uppermost atmosphere ionizes, said turbine, motor-generator continual reversals light energy discharges are analogous to the Tesla fluorescent light.

The process of magnetic-reconnection details scientific explanation has the auroran lights phenomena occurs when electrically charged ions collide with upper atmosphere atoms mainly at altitude above 80 km, which increases the magnetopause volume boundary perimeter. The larger magnetopause volume leads to said Jean's fountain discharges. Said Tesla's inventions electrons flow is considered friendly and Aurora electrons inflow from space unfriendly in these processes. Said ionic mass losses, ionization of the upper atmosphere, and electrons and plasma inflow from space enforced magnetic lines fluxing forces electrons and ions forbidden mechanism transitions. Default forbidden mechanisms result from forcing temperatures, pressures, together with cosmic-solar pressures and radiations magnetopause forms fluxing boundaries which can lead to suction.

Suction forces pure pressures energetic motions modulate mass energy densities; said GC conforming embodiments force QCNDMEHC, and the Earth enforces said GC domains globose-inverse Sets; said GC are cosmos mass energy reservoirs, and meteorites with their gas perimeter constitute with the Earth said inflow Inlet forms with air mixtures atmospheric mass gravitational forces held retention and the ionosphere the gravitational and magnetic fields retained detentions; Said interstellar radiations wind pressures deform said magnetic field lines outer boundaries with said dipolar magnetic field's two cusps, spout funnels and said electrons bound ions mass fluxing boundaries globose-inverse forms; the cusp closer to the Sun atmospheric temperatures pressures force QCNDMEHC GC forms as said outlet spout funnel sequential equilibriums, generic claims compliant gravitational forces electromagnetic dipolar field electrons bound ions boundaries flux forcing the other outlet cusp as the counterpart vent, for hydrodynamics thermodynamics electro-superconducting less than the speed of light; said hemisphere forced boundaries flux triggers said outlets blow-off bursts, hydrodynamics thermodynamics default equilibrium to ice age onset, and pressures and temperatures drop to default values; said dipolar magnetic field lines said pressures and radiations equilibriums fluxing perimeters force said Earth's orbital water-vapor, air and ions mass perimeters globose-inverse oblate Set forms; the oceans feeding water-vapor to ions forcing said reversing turbine with polar cusps reversible rockets engines ions masses discharge enforces the Earth's gravitational mass balanced wobbling; minimal water vapor masses excess conserves the Earth's water mass, for a cooler ‘global warming’ temperatures and the Earth's warmer crust.

Said QCNDMEHC GC Sets sequential equilibriums forces energy from smallest particles to cosmic infinity from submicroscopic microbes living cells evolutionary processes and humans to omnipotent and omnipresent intelligence constituted in space time infinity. GC QCNDMEHC Said magnetosphere's instantaneous boundaries enforce GC Sets and forms; said Laws forbidden mechanisms govern leading to overriding extinctions laws for non-zero acceptability, technically ‘forbidden’ mass energy forced spontaneous transitions' occurrences. Emitted greenish and dark red glows dominating the atomic oxygen Aurora phenomena light emissions represent forbidden transmissions. ‘Aurora ovals’ illuminate magnetic field cusp said GC Set QCNDMEHC outlet's First End, electro-hydrodynamics, thermodynamics ‘unfriendly’ or future forbidden mechanisms.

Magnetic field structures contained higher mass density plasmas force stable fundamental configurations enforcing where particles can and cannot go. Said Solar and interstellar radiations and pressures do contain higher density plasmas that force said magnetic field perimeters fluxing to suite; said GC Sets mass readily transpose to higher energy excitation states GC Sidelong Sets.

Said Jean's plasma fountain magnetosphere perimeters basically GC globose-inverse Sets higher energy occasionally transferring into said GC Sidelong Sets force said four generic claims physics, chemistry, thermodynamics and forbidden mechanisms laws to merge. GC Globose Set forms higher energy excitation states allow transfers back to lower energy states, globose-inverse Sets complying to forbidden mechanisms that come in pairs, provided lost fluids vapor to space is replenished; said default states lowest mass energy excitations rise to repeat significant events. Said Milankovich's statistical calculations predict ice age onset forced by said GC Sidelong Sets higher excitations at magnetosphere's largest volumes multiple times enlarged over said globose-inverse Set volumes to force a ‘blow-off’; said default energy states forced glacial ice advances left behind cooling/heating fluids retreated glacial ice Earth's geology crustal landmarks features.

Variable density mass energy populates omnidirectional space infinities by its unrelenting stratification through ‘mother of all processes’; entire mass perfectly stratifies into its omnipotent black hole mass with the densest mass in the core and least dense mass perimeter as perfect mass in space; said stratification last significant mass circumnavigates cosmos perimeter at light speed plunges at great speed into a black hole to superior stratifications perfections or another big bang.

Said forced Sidelong Sets constitute forbidden mechanisms that come in pairs; a return to globose-inverse Sets default excitation state completes said forbidden mechanisms pair of one or more cycles. During ‘blow off’ bursts the magnetosphere goes through such Set pairs in onset of ice age default states; Set Partitions or cell splits in a sense unfriendly processes must lead to said forbidden mechanisms stratifications gradations enforce processes highly destructive to GC Sets.

Contrary to cosmos activities end controlling outcome, said QCNDMEHC growth unique partitioning and splitting processes combat said ‘mother of all processes’ physical, chemical, and forbidden mechanisms infinite mass energy; said stratifications universally force splitting and/or breaking down fluids of atomic table lowest ranked atoms into respective ions plasma transports. Deadly radiation energy streams either from a star or a black hole sterilize or decompose; planets shown tectonic movements arrange land masses by gravity force influenced by minerals' specific gravity, density; lead forbidden mechanisms to the Earth, Moon's synchronous orbits reconfirm—their origins are of one creation. Pluto, Charon locked synchronous orbits shown crusts different densities leads some to believe they formed independently; said stratification processes of atomic chart lowest elements ions lost by the planets by ongoing stratifications, gradations processes the Milky Way Galaxy, Solar System enforces; the Earth fluids action eroded orbital crust; the Moon is largely regolith covered; said differences reflect said processes status. This views Solar System perimeter masses such as Pluto, Charon, and Kuiper Belt recipients of the Earth's and other Solar System planets' fluids mass plasma fountain discharges for billions of years; the Mars significant to with lighter fluids, atoms, crust erosional features show said atoms ions stoically free crust with insights to the planets lost atmospheres to the Solar System perimeters orbiting bodies and space.

Said Earth and planets electromagnetic fields resist stratifications, gradations mechanisms processes and only by force pass finest, lightest particles, ions, stellar energies emitted radiations waves; larger, lighter or heavier atoms or ions escape occurs only in significant ionosphere losses or highly stressed magnetic filed lines collapses said Solar and cosmic systems forced radiations.

Said cosmos stratifications force simultaneously intergalactic, galactic, and solar systems, interstellar planetoid stratifications and gradations, with the Solar System and the Earth are in yet another process—the process of cooling; the cooling processes continue from the outset currently manifested in lost cooling or heating masses most significant reserves—the lighter fluids and ice, which said pressures and radiations ionize and force into said ionosphere masses and outer space.

Said pure pressures, gravity field buoyancy, density, evaporations, and suctions force said stratifications gradations. Said forces relate to densities with suction forcing the space least mass densities that can lead to perfect vacuum; said hydrogen cloud particles mass low to least density ions nearly infinitesimal perimeters compared to unified light beams translational energy forcing them to time space infinity near the speed of light. Said particles clouds near light speeds cannot surpass such speed circumnavigating outer space but can merge by confluence. From outermost point their black hole influence will alter said cloud trajectory to a spiral into the black hole, with clouds exceeding light's speed making for a larger black hole; said clouds deadly, highest energy radiation particles shooting through a galaxy sterilize, decompose, and burn-up living organisms.

Hematite bedrock layers show the Earth's magnetic field orientation shifted several times in her 4.5 billion years life for an estimated average of once in billion years; Solar system planets common mass energy origins should show crusts and atmospheric masses common compositions much similar status rather than quite different. These are evidence that the Solar System suffered extreme energy radiation sequences. Said cusps' magnetic line disconnects in proximities of said magnetosphere shoulders analogous to electrical power grid transmission lines disconnects avoid the entire magnetosphere collapse; On a complete overload, said magnetosphere most field lines disconnect analogous to electrical power grid blackouts. Subsequently, said magnetic fields lines take said QCNDMEHC default orientation and the stripped atmosphere leaves behind bare or ice covered crust; said radiations and pressures extensively enforce said Solar planets' current states.

Said glacial, geological histories supports evidence that ice the Earth's crust had ice cover after its atmosphere stripping, likely more than once; stratifications, gradations history forced ice then water and ions with the Earth a main recipient of distributions which explain the Nebraskan glacial age ice advances anomaly influenced by preceding iced water meteorites impact. Darwin evolution theory needs species specific planet origin based on its atmosphere forced air-mixtures.

Said forbidden mechanisms nonzero probability relate intrinsically to forbidden processes exemplified by magnetic field collapse and shifts to new geographic orientations. Extremely low probabilities phenomena processes mechanisms identify forbidden, as exclusively seen on global scale. Cosmos omnidirectional, space-time infinite matrixes of galaxies and stellar systems force highly commonplace forbidden mechanisms processes and phenomena; enforced omnidirectional processes said matrix infinities lead to said stratified black holes outcome; said GC Sets or forms actually constitute valid forbidden mechanisms, Universe Sets or forms which combat, oppose or scramble said black holes stratifications gradations processes; said GC Sets and forms qualify for the God device cadres; said QCNDMEHC GC Sets and forms force said combat for fluids in said gravitational and magnetic fields cosmic interstellar wind pressures, radiations and fluid densities said related forces; cosmos implemented GC Sets populate exactly the same said omnidirectional infinite matrixes, for each instance with infinite energy and water conserving, said QCNDMEHC intelligent processes; said four generic claims physics, chemistry and thermodynamics forbidden mechanism laws merge, again. But, in this instance for respective planets' retained water masses for living organisms' potential habitats, in retained water masses not lost to space or a black hole.

Aforesaid identified said Earth's two critical processes. More frequent of the two, glacial interglacial periods sequence, Milankovic calculations predict; the other, said magnetic field very infrequent shifts large deviations forbidden mechanisms our current science most readily ignores.

And thus, GC Sidelong Set QCNDMEHC constituted highest excitation states occur prior to the time magnetosphere partial ‘blow off’ default boundaries contract to least size perimeters; unless said least densities forcing suction in said magnetosphere or said cusp's mouth or shoulders is relieved said magnetic field collapses. Said magnetic field after said partial ‘blow off’ triggers ice age with the GC Sidelong Set transposed back to its GC globose-inverse Set and said contracted default-smallest perimeters; said cusp discharges fluids as said magnetic field GC Set flows' outlet; said other cusp restores electromagnetics, hydrodynamics and thermodynamics fields stable equilibriums as a pressures relief vent with said Inlet End 2 and said outlet First End respectively submerged in air masses, unless a collapse occurs; said magnetic field's rotation and orientation forbidden mechanism in respect to the Sun said QCNDMEHC forces. Said forbidden primarily magnetic field mechanisms trigger ice age forcing said Earth's fluids mass huge losses. Then, under Sun radiations ice masses sublime, waters evaporate, the atmosphere and ionosphere replenish and expand and with time restart plasma fountains. Said glacial period sequences force Earth's water budget continual huge losses and glaciation periods left behind geological features. Said electromagnetic field rotation or orientation shifts force atmospheric fluid masses enormous losses to said interstellar and Sun wind pressures and radiations. The Moon's ice and fluids mass said radiations and pressures with Earth's irradiations likely blew away, at the time of the Earth's first said electromagnetic rotations with orientation shift; geological evidence points to said Earth once extensively featuring glaciation mass also was impacted by ice-water occasional meteorites.

Billions of years, cyclical heating/cooling thermodynamics hydrodynamics eroded rivers, channels, drainage features, into the Earth's crustal landscape and water masses transport into the oceans or until they are large water surfaces exposed masses to radiations, evaporations. Cleared forests, developed lands, transportations infrastructure, and industrial and commercial complexes greatly speeded warmer water masses delivered to the tropical belt much larger evaporated water vapor mass forcing the atmospheric cooling, heating processes. Rivers with few exceptions flow into the Earth's tropical globose bulge; energy generations and transfers force water-vapors, also.

Heated water-vapor densities raise air mixtures; the ‘Greenhouse gases’ higher molecular weights let lighter vapor molecules ascend; the ‘Greenhouse gases ‘temperature inversions’ force the ‘smog’ phenomena thermodynamics forcing lighter rising air masses; the air thermodynamics especially warmed water-vapors by molecular density/buoyancy force the enlarged atmosphere's perimeters troposphere's air-temperatures radiation bubble toward said glaciations period trigger.

Air boundary larger bubble perimeters intake larger Sun's radiated Earth's irradiated heat energy. The larger air boundary increases probability of Sun's radiation, loose electrons splitting water-vapor into ions that by density buoyancy forces expand said ionosphere boundaries bubble perimeters, also; said water ionosphere's enlarged plasma bubbles feed implement said fountains persistent, repeated, ions hemorrhaging effects. Water-vapors force said magnetosphere retained sustained enlarged ionosphere and molecular air said boundary perimeters bubbles, essentially by water-vapor content force said atmospheric temperatures or ‘global warming’; the glacial periods said electromagnetics thermodynamics states equilibrium enlarging bubbles forcing temperatures boundaries perimeters stop glaciation ice advances. ‘Global warming’ partial ‘blow-off’ triggers globose bubbles magnetosphere forced said GC Sidelong Set transposed to said inverse-globose Set default forms. Forced buoyancy, density, suction and evaporation transpose inverse-globose, globose Sets enforce said subatomic and cosmos masses energy systems electro-thermodynamics electromagnetics gradations; the ‘greenhouse gases’ descend onto tropical rainforests as fertilizer with precipitation that some claim, carbon dioxide radicals smog, human health hazardous which is environment absorbed damaging greatly the oceans' ecosystems. As a result greenhouse gases contribute to crustal mass stratification. When greenhouse gases curtail water vapors and/or haze blocks the Sun's radiation and the Earth's irradiations to reduce water evaporation, lower and not the upper troposphere is heated, thus not enlarging said atmosphere/ionosphere bubbles boundary perimeters and forced plasma fountain discharges; said troposphere will radiate more heat energy into space forced by air retained water-vapor mass smaller content. Said mass equilibriums must include Utilities energy generation with byproduct water vapor forcing effects; energy generation water-vapors byproduct inseparably generated effects force ‘global warning’; water-vapor hydro-thermodynamics effects merged with ‘greenhouse gases’ emissions force global climate changes.

The Earth's electromagnetic field force rotation orientation shifts, said stratifications and gradations, and said glaciation periods ‘global warming’/cooling cycles geologic history depleted water mass/vapor mass-energy budgets enforcing waterless state frozen planet status enormously forcing by said pressures, radiations and hydrodynamics thermodynamics equilibriums processes need no ‘greenhouse gases’ effect. Emissions outflow goals in combat with said processes is like a rain drop in an ocean; foregoing QCNDMEHC processes place highest priorities to control and contain water vapors. Globose-conduit magnetosphere ions or electrons flows exhibit cusps high conductivities with QCNDMEHC processes forcing thermodynamics and hydrodynamics energy transformations with perfection; said aqueducts enforced palpable ultimate hydrodynamic energy generation enforce water mass flows maximum delays toward tropics without stagnancy emitting no water-vapor into the atmosphere, forcing largest heat transfers to subsoil and least transported eroded soils fill into the oceans' and crustal depressions. Said Sets, forms forbidden mechanisms processes counter said stratifications processes eroding peaks filled depressions, smooth, globose spherical, rotating, orbiting sterile surfaces and such ice covered similar said planets. Again, said QCNDMEHC water-vapor masses fundamentals optimal processes combat aforesaid final result.

Said QCNDMEHC and GC MEHC surfaces, Sets and forms moderating functions evolve within said stratifications and gradations processes toward final status surfaces result enforced by said solar system galactic or intergalactic transients and violent events. Thus, ice covered planets surfaces constitute certain water masses water-vapor potential atmospheres during said transients within galactic times scale. Darwin's evolution theory provides little or no data on species planet origins or propagated systems contained boundaries, their atmospheric gaseous mix and ability to bridge interplanetary space galactic time's scales to evolve and prosper by forced circumstances. There is no firm clue at all of living intelligence force or abilities to accomplish any of said tasks. Solar System's elementary life evolution requires sciences database; said GC MEHC, QCMEHC and QCNDMEHC Sets constitute living intelligence; said quintessential, core, natural, buried GC aqueducts perimeters heat energy transfers with or without irrigations combats fluxing oceans levels, ‘global warming’ effects, the Earth's surface cooling, said atmosphere, ionosphere enlarging and thus water ions plasma outflows into space. In near vacuum, least density globose masses light pushed into infinity as globose-conduits GC Sets approach speeds of light. Said GC aqueducts cycle heat energy from subatomic and submicroscopic to cosmos mass energy systems combat electro-thermodynamics, electromagnetics perimeters bound universe buoyancy, density, suction, and evaporation thus save the Earth's water; cosmos Sets and forms creative intelligence databases do not exist; said GC Sets, forms physical state, QCNDMEHC and MEHC intelligence structural arrangements counter said gradations stratifications processes stratified, graded atomic weights, solid state matter, universal forms gaseous, liquids, and solids. Said GC Sets and forms make liquids states universe mechanisms which counter to them mortal stratifications, gradations processes thereby avoiding catastrophic default states said QCNDMEHC forbidden mechanisms.

Said GC thermal aqueducts' structure crucially enforce atmospheric heat energy transfers into the orbital crust stop plasma fountains primarily water ions discharges into deep space which conserves the Earth's heat energy and water mass by heat containment within the orbital crust. Instrumental for this process are said GC aqueducts Sets, forms, inside atmosphere's conforming GC, globose-inverse Set, form. Said aqueducts must make huge capacities heat sink for retained water heat transfers into orbital crusts; said GC Sets and forms conserve infinite water mass and energy with prototypes and on global planetary scale as they curtail or shut-off plasma fountains, documented prior applications prototypes verified mass-energy conserving; said globose-conduit Universe makes perimeters boundaries internal structures intelligent arrangements (IA) functions and stratifications gradations arrangements (SGA) Order, atomic weights' compositions IA, SGA continual one against the other conflicts/confrontations for forbidden mechanisms final outcome;

In forced conflicts, least mass energy dissipations or highest QCNDMEHC prevails; mass energy forced relative densities enforce said buoyancy, density, suction, and evaporation forcing. Said atmospheric air mass water-vapor penetrated, analogous to water saturating soil, alters mass energy densities. Water-vapor especially has ability to penetrate and fill finest interstitial spaces. In air water-vapor displaces other molecules, also. Triatomic water vapor molecules replacement of the generally diatomic air molecules leads to very slight volume change on finite bases and for huge air masses huge volume increases. However, rounded more diverse particles avoid uniform perimeters sizes gap graded masses molecules higher numbers compacted in smaller volume than the sum of separated uniform diatomic and triatomic molecules volume same number for smaller interstitial spaces total volume; water-vapor triatomic perimeters in diatomic air mixtures enforce less porous or penetrable higher compacted volume greater volume fewer voids mass compaction that retains said radiation, irradiation heat energy. Said compaction is a misnomer in a sense that water-vapor least atomic weights make-up molecules forcing expanded rather than compacted air masses. Relatively constant atmospheric pressure higher temperatures with water-vapor contents force enlarged air masses into higher elevations proportional to water-vapor content percentages, especially with evaporated water molecules much lower molecular weight larger perimeters adds mass even greater volume to the atmosphere; thus, water vapor content expanded atmosphere can retain sufficient heat energy that avoids a deep freeze but in time enforces said ‘global warming’.

In diatomic masses, two water-vapor molecules, triatomic perimeters compact better than diatomic oxygen, nitrogen three molecules combinations and lighter air masses specific gravities, especially with diatomic perimeters air mass uniform gradation higher specific gravities; Greater molecular structures variety gradations, greater compaction, lighter mass per unit volume include triatomic water-vapor molecules; thus, greenhouse gases stratified layers with water vapor makes for thermal inversions phenomena mainly over cities; said air masses retain even more of the Sun radiated, the Earth irradiated heat energy thus peaking atmosphere's temperatures. Water-vapors gas masses built to high altitudes force ‘global warming’; condensed gaseous vapor, greenhouse ‘acid rain’ are the Earth's counters to stratifications gradations processes, forced more interstitial voids proportionally lower radiation and reradiation intakes for higher irradiation heat into space.

Said Generic Claims, QCNDMEHC, GC Sets, and forms highly define nonhomogeneous, nonuniform, nonsteady, laminar flows perimeters, boundaries makes for intelligent arrangements (IA) perimeters, boundaries devices, including aqueducts as hydrodynamics and thermodynamics electromagnetics mass energy transistors/processors; said transistors/processors process, conduct quantum mass energy analogous to transistors, processors electrons charges binary method but in fairly complex fashion for highly variable environment. Said I/A devices, fluids flows analogous to transistors/processors force quantum masses energies, densities state, quantum masses laminar flows, perimeter forms and interfaces boundary forces, including evaporation, buoyancy, suction.

‘Global warming’ is a misnomer in the sense that it is the Earth's water budget continual, cyclical depletions' effects, solid masses cooling, forcing the Earth into a frozen state status; Greenhouse gases are unfairly accused of ‘global warming’; here, said ‘global’ is atmospheric warming due to following causes:

I. Multi-atoms molecular perimeters replacing uniform gradation masses of diatomic gases,

II. Nonuniform perimeters molecular compactions reducing interstitial voids' space, volume,

III. Diatomic air mass enlarged atmosphere's volume forms by triatomic water vapor masses;

IV. Air masses rising to higher altitudes with higher water vapor contents lower mass weight,

V. Nonuniform perimeters compacted air mass retains larger radiated, irradiated heat energy,

VI. Air volume larger water vapor contents mass forces the air and ionosphere larger bubbles,

VII. Electromagnetic field must have low moisture contents air mass in proximity of its cusps,

VIII. Hydrodynamics, thermodynamics need heat energy transfers, across its fluids boundaries,

IX. Earth's ice/water and gases cyclical equilibriums fluxing boundaries transfer heat energy,

X. Earth's aging erosional effects accelerate rates in thermodynamics hydrodynamics cycles,
Heat energy transfers need water/vapor budget fluids and ice masses appropriate margins;
   Subsequent passages describe aforesaid ‘atmospheric warming’ in greater details.

The Sun's radiation taken instantaneously, as infinitesimal steady state parts, radiates part of its energy onto the Earth's orbital masses, which taken similarly, has a normal distribution bell curve shape for hypothetical uniform diatomic perimeters homogeneous uniform atmospheric air mixtures. Said curve due to the Earth wobbles, the one year period wobble as predominant, has a symmetrical bell shape only when the Earth's equatorial plane aligns with the Sun's; extending a perfect modes analogy to an extreme, to said evaporation process start first water vapor triatomic molecules' perimeters appear at the equator; the evaporation process, then, propagates toward the poles, together with vapor penetrations into higher elevations; off course this is idealistic; and the Earth's wobble, direct alignments are evaporation probability density value peaks short durations located geographically in the summer hemisphere. The water-vapors travel in upward paths then as the air mixtures condensates fall out, with radiations dynamics among many variables present.

Said atmosphere's water-vapors mass-units saturation compacted volume (WVMUSCV), force highest altitudes upper boundaries and said atmospheric ‘global warming’. Said numerous variables existences further include aforesaid cosmic, orbital, seasonal, and diurnal variations for evaporation rates intensity physical property, which constitutes atmosphere's dynamics said most illusive WVMUSCV property as parts of 14.7 psi atmospheric pressures uppermost water-vapors contributions. Said WVMUSCV penetrations that make air masses highest altitudes form water-vapors broad domal peaks at geographical locations directly underneath the Sun; then, follow the Sun, air currents thermodynamics effects distorted, enforcing constituted water vapors uppermost dynamic penetration thermodynamics equilibrium bulbs and peaks; said water-vapors coagulated in bulbs at lower elevations constitute clouds. The Polar Regions sublimation rate low intensities increase into temperate zones WVMUSCV forced highly increased slopes smooth transitions and gentler slopes tropical belt WVMUSCV domal peaks; evaporation higher intensity rates force the water vapor WVMUSCV to higher elevations; higher molecular air perimeter variations generate higher compaction WVMUSCV globose bulbs above or within the described WVMUSCV bulbs.

Said WVMUSCV bulbs feathering perimeter boundaries volumes retain higher radiations Earth's irradiation portions and clouds reflections due to said higher compactions lower porosity. Two triatomic water vapor molecular weight of 2 times 10 have six atoms perimeters total, which replace diatomic gases six atom perimeters molecular weight either 3 times 7 for gas nitrogen, or 3 times 8 for oxygen. Aforesaid compares to two triatomic carbon dioxide molecules twice 6+16 or twice 16+16, two sulfur dioxide molecules, which shows that water vapor rises and precipitate out of the atmosphere alone or with the greenhouse gases as acid rain; two carbon dioxide, sulfur dioxide, water vapor, and three nitrogen, oxygen molecules, each forms six atomic perimeters, or molecular weights 44, 64 20, 42, 48, respectively. Said molecular air various diatomic, triatomic gaseous mixes water-vapor contents force atmospheric masses compactions decreased interstitial space lower porosity atmospheric masses lower densities which validate said WVMUSCV bulbs.

Air mass vapor contents coagulated into clouds rise to significant altitudes. Water-vapors air mixture contents compactions with feathered, no-cloud surfaces, reaching high altitudes attain higher radiations energy at higher altitudes for the air masses larger atmosphere volumes; 14.7 psi atmospheric pressures prove lighter water-vapor masses molecules larger perimeters' boundaries.

Vapors compacted WVMUSCV bubbles enlarge enormously atmospheric volume masses gaseous state amounts, globose forms, surfaces radiations retentions forcing said hydrodynamics, thermodynamics cycles that usually feed on themselves, thus magnify, diminish or reverse cycle.

Said greater globose forms and bulbs mass volume, surfaces generated larger ions masses buoyancy/density evaporation and suction due to forcing temperatures pressures hydrodynamics, thermodynamics create a larger ionosphere globose form; the six oxygen atoms ozone molecules loosely bonded three diatomic oxygen pairs perimeters force an ozone layer density less than the atmosphere air masses molecular nitrogen, oxygen density to cover them as a blanket. Hydrogen and helium ions least mass density-perimeters, radiation split from water-vapors or hydrocarbons readily penetrate through the ozone layer and into space. Oxygen ions, especially those loosened atop of the top of the ozone layers constitute the ionosphere's globose mass including said cusps.

Electromagnetic field retains hydrodynamics, thermodynamics generated ions within said least perimeter boundaries which by forcing temperatures, pressures, and ions generation enlarge and thereby deform to cosmic, Sun radiations and pressures. Boundaries flux forced equilibrium deforms boundaries or said fountain squirts ions to space or outermost magnetic line disconnects, to avoid forbidden mechanisms magnetic field shift or Earth's orbit-mechanics induced wobbles.

Large WVMUSCV bulbs, globose air masses, ionosphere and magnetosphere forms and Sets force electrons, ions enormous velocities, thus said fountains and magnetic lines disconnects and reconnects. Said velocities need said pure pressures, poor compactions, and high ion masses density, especially proximate outer magnetic field lines and cusps. The Earth's dipolar magnetic field QCNDMEHC, globose forms Set, retains water-vapors mass inside the magnetosphere with WVMUSCV least height at cusps, for thermodynamics forcing generated vapor ions least losses. However, said stratifications gradations hydrodynamics force supply side thermodynamics water vapor masses enforcing said ionosphere masses, fountain discharges, and partial or full blow-off.

A greenhouse gas has generally one cycle lifespan. Water masses or their derivative once activated stay in heating cooling cycles or till a hydrodynamic thermodynamic release into space.

Said WVMUSCV, air masses and ionosphere bulbs, globose Set larger volumes retain the cosmic and the Sun's radiations larger share for higher internal energy that at pressure of 14.7 psi further expands its bulb, or radiate or release internal excess energy perimeters boundaries retain. The orbital crust is one the atmosphere, magnetosphere and cusps are other strategic boundaries.

Cooling and heating phases water-vapor masses heat transfers are most important. During glacial periods, as glaciation ice enlarges the orbital crust and glacial ice boundaries; thus, said WVMUSCV bulb shrinks and decreases. A glaciation period continues with interstitial highest porosity volume present and said WVMUSCV bulbs shrink; and cycle continues with the cosmos/Sun radiated and the Earth irradiated heat energy irradiated into space until orbital crust generates WVMUSCV size bulbs retain proportionally more heat energy reversing WVMUSCV bulb shrinkages, which likewise terminates glacial ice advances.

Interglacial periods' fluids masses heat energy net radiation transfer to space also cool the entire orbital masses. Said Earth's globose-inverse omnidirectional radiations Set boundaries and said fountains minimal outflows deemed insignificant, an unfriendly mechanisms atmospheric blow-off looked unlikely.

As the WVMUSCV bulb grows during interglacial periods, the retained radiation net energy gain forces heat transfers across perimeters' boundaries; glacial period ice advances retreat forcing enlarged air bulb masses, magnetosphere and ionosphere Set forms that eventually trigger a partial blow-off. Enlarged Set forms force ions electrons into said enormous velocities flows. Said ionosphere's media plasmas pure pressures near vacuum temperatures and densities supportions electrons masses flows that approach light velocities, or force outer magnetic lines disconnects or fountain outflows. Said Tesla's invention, friendly mechanism, thus, forces fluids into closed system high velocity ions and electrons, while said Auroras are unfriendly stratifications, gradations phenomena. The Earth according to said mathematical computations is in its interglacial period; a partial blow-off is unlikely for decades. It is near certain that at present rates of the Earth's growth current fossil fuels energy generation must quickly become an archaic or abandoned technology. In the long run, provided we get there said ‘greenhouse gases’ are not an imperiling concern;

Said compaction, porosity interstitial spaces effect and conversely mass continuity is very basic; science literature has atoms or molecules basic data. Water-vapors science studies refer to vapor behavioral complexities as a confounding ‘lurking’ variable; its air buoyancy, larger as the temperature rises is such variable that provides energy to cyclones, tornados and hurricanes. Air, water-vapor compactions are a significant density property that shows up on radar imagery. Said WVMUSCV bulbs over land and ocean masses dim indistinct cap-forms composite radar images show, with air masses water-vapor flux content highest in tropical regions and least at polar caps.

Magnetic field ions inside magnetosphere perimeter outermost interface boundaries inner surface experience gravity and magnetic field force inversely proportional to respective distances to the center of gravity, magnetic field dipole axis squared, cubed, respectively. As said air mass water-vapor contents increase, said interstitial space decreases, but mass volume, continuity and temperatures increase, expanding the atmosphere, ionosphere forms respective perimeters, which decreases respective masses density. Said pressures 14.7 psi at sea level moves said interface out into space, forcing said gravity, magnetic field force fall-off in said proportions. Said forces fall-offs, force mass densities fall-offs at said interfaces; the air masses water vapor increased content added critically detrimental distances effect with unit volume lower densities, lower unit weights.

Said atmosphere and ionosphere partial, not complete, blow-offs arise with the following:

Respective densities dominate said interface boundary forces interactions; when magnetic field plasma, ions density flows dominate boundary perimeters, magnetic field structures deform, only. When cosmos and Solar wind densities dominate, their relatively undisturbed mass energy deforms the magnetic field mass energy to suit their dynamics. Energy densities, electrons spiral movement velocities along magnetic lines increase as boundary deformations increase having the spirals amplitude decrease analogous to a stretching of a spring; when magnetic fields deforming is excessive, electron flows velocities energy demands do not support an outermost magnetic line and the line disconnects, with ions droplets formed on the boundary forced into space. Said large perimeter deformation movements can reduce ions densities to near vacuum suctions. Thus, said cusp mouth suction forced disequilibrium forces globose-inverse transposed to highest excitation globose Set and forced partial blow-offs, as most important energy release to space stratifications gradations (SG) phenomena; said SG forbidden mechanisms force orbital crust water masses into vapor and ions quantum mass energy with blow-offs discharging said ionosphere and atmosphere significant mass portions. Said mess energy releases into space lower the atmosphere's pressures and temperatures, force major water-vapor precipitation events and trigger an ice age. Said mass energy partial blow-offs force the other cusp, as a vent, to inflow least density space plasma mess energy from the Earth's lee side wind pressures and seasonal, hemispherical, winter temperatures forcing air masses toward equilibrium moderations. Flowing ions enormous masses energy force magnetic lines electrons velocities that continue to disconnect outermost lines, which shrinks and returns the atmosphere to said globose-inverse Set forms; said inflow plasma least density allows yet higher magnetic field equilibrium deformations and more line disconnects until said vent low density inflows reach proximity of said perimeter shrunk boundary to dissipate said cusp suction.

Said cycles repeat provided said budgets masses revive an atmosphere and an ionosphere. Said SG fluids mass energy cyclical processes power only interplanetary/geologic dating reveals.

Thus, said water vapor SG processes force said ‘global warming’, interglacial periods and atmosphere's warming with the Earth's forced many geologic periods cyclic cooling; thus, blow-offs shrink said atmosphere, ionosphere to lowest volume globose-inverse forms, plasma inflows low pressures, temperatures, least WVMUSCV bulbs and mass densities forcing a glaciation age.

Has the Earth passed the tipping point of no return is answered by looking at said Earth's impermanent water, ice, vapors, and ions inventories budget. Through stated interglacial, glacial periods, massive tectonic movements occurred. During the more recent geologic periods, oceans maintained relatively stable levels and glacial ice masses have shrunk in a major way. Presently, glacial ice has least masses on record, with thicknesses age often, notably much younger than ten years ago. Polar ice caps retreat is reported regularly. Glacial ice mass lowest on record appears to melt at an accelerated rate; through ages, rivers eroded deep channels or oxbow meanders into the continental crusts; the Grand Canyon on the Colorado River is one marvelous example, while deltas abound with sediment. Thus, continental crusts groundwater levels enforce their historical low levels; river beds channels and lakes continental waters at lowest elevations may become dry beds. Said SG processes have transferred enormous water masses to water-vapor and into space.

Aforesaid, ice water comparable mass which once covered the entire Earth conserved and or preserved would have sustained indefinitely climates with living organisms on several planets. Said WVMUSCV bulbs enormous expansions to historically highest altitudes is evidenced in the bulbs' lee sides moves to higher latitudes and elevations which forced most shrunk polar ice caps and their accelerated retreat; thus, present enormous air masses volume least voids at historically highest compaction continuities force entire volume least interstitial spaces least voids porosities.
Said plasma discharges occurring during present interglacial cycle's early stage attest that said globose atmosphere, WVMUSCV bulbs, and ionosphere masses are near largest volumes.
Earth's water/ice/fluids masses inventory budgets brief summary is the following:

I. Historical records least glaciation ice mass, forcing much younger glacial-ice thicknesses.

II. Continental crusts deeply cut riverbed channels, for lakes, groundwater lowest elevations.

III. Said least glaciation ice surfaces globose atmospheric air and ionosphere largest volumes.
Said water ice/fluids masses budget quantities rates show the following evidence:
I. Scientific reports have glacial masses in retreat with melting at accelerating rates.
II. Deeply eroded river beds are generally delivering water mass in largest quantities to tropical belt, based on the continental crusts corresponding groundwater levels.
III. Rivers and continental groundwater levels constituted largest exposed waters free air interface surfaces with air masses near historical high or highest temperatures.
IV. Largest ocean-waters free surfaces, air masses interface; with ice caps by far near historical least surface areas; said air masses near historical highest temperatures.
V. Fluids currents cool enlarging volume masses with glacial ice by far least masses.
VI. Said historical largest volumes least air mass voids retain Sun's, cosmic radiation large part; solids and vapors clouds reradiation with historically highest amounts.
VII. Aforesaid has plasma fountains start at glaciation period historically earliest time.
VIII. Smallest polar ice caps least coldest-air mass least engulfs magnetic field's cusps.
   The following show that the Earth's heating is at historically higher rate:
   I. Smallest polar ice caps are observed melting at accelerated rates,
   II. Said malting ice caps rates create surfaces accelerated water rate,
   III. Historical interglacial period forced early plasma fountain starts,
   IV. Unfriendly WVMUSCV large bulbs enforcing plasma fountains,
   V. Said WVMUSCV bulbs growth is ionosphere ions faster growth,
   VI. Said masses growth rates forces atmosphere volume growth rate.
   VII. Atmosphere fastest growth is evaporated water mass growth rate,
   VIII. Evaporated water mass rate reflects ice caps fastest melting rates.
Supra enumerated water budget inventory, quantities, with rates repeat cyclically through the interglacial periods, with continually smaller ice caps mass quantities forcing each cycle. The enumerated confirms fountains outflow into space sufficient ions mass energy for each respective hemisphere to avoid the forbidden mechanism partial blow-off, except at said glacial trigger time.
The forgoing summarizes the SG processes following glacial interglacial period changes:
I. Enlarger oceans, retreating ice caps, and lowered continental groundwater levels,
II. Significantly lower budget water-ice, ice and water-vapor water respective ratios,
III. Significantly enlarged atmosphere, WVMUSCV bulbs and ionosphere forms Set,
IV. Said atmosphere climate, ecology, WVMUSCV bulbs/ionosphere forms changes,
V. Magnetic line disconnects more viable; smaller ice caps for less cool fluids mass,
VI. Faster glacial ice retreats, higher evaporation rates with greater vapor-ions losses,
VII. Glacial histories show no greenhouse gases contributed to glacial periods-trigger.

Said Earth's SG processes forced-changes are inseparable from ecosystems' evolutionary changes. Whereas the glacial ice caps retreated, prehistoric animals' bones discovery in Saharan Desert, armadillo's migrations to higher latitudes, and polar bear habitats disappearance are more recent climate changes noted among many others. Sahara hot but dry air masses forced high into the atmosphere creates moisture voids in the WVMUSCV bulb the oceans and the Amazon River basin evaporation replenish. Otherwise the equatorial belt goes dry with said WVMUSCV bulbs separated into hemispherical forms moving toward Polar Regions. This, off course, cannot occur as long the melting polar ice caps provide cool waters to the oceans' currents. Said Solar System SG processes show the planets, especially the Earth, in their creation and evolution, were blessed with enormous water budget quantity. In respective orbits equilibrium, outside Venus and inside Mars, the Earth has fortuitous, close to if not most preferred, stable orbits about the Sun based on said planets' high, low, and moderate respective temperatures. But, the Earth's glaciation history points to the Sun and cosmos radiations forced water budget depletions forcing greenhouse gases presence. The Mars crustal geology shows massive fluids erosion features with the fluids absent, now. The fluid the Sun evaporates or blows-off at such a distance is water. The surface of Mars is rocky, dust covered dry mostly frozen with a low mostly carbon dioxide atmospheric pressure. The Venus atmosphere, believed more like the Earth's several billion years ago, lost its waters to evaporations, leaving behind gaseous extremely carbon dioxide thick layers. Including Mercury, the Earth's atmosphere at equilibriums with the first four planets orbiting the Sun contains water. The Earth's magnetic field with the ionosphere huge boundary layer protects air and water-vapor masses from cosmic and solar winds, pressures, and radiations. Said Earth's, the Mars's ice caps composition appearances show ominous similarities; the Mars said SG processes more advanced.

For the responses to the asked question, one must know: what the “tipping point” defines. Said scientific community defined “tipping point” for said ‘global warming’ misnomer takes said atmospheric temperatures rising, only; this omits the Earth's crust cooling. A huge oversight; the Earth's geologic history and said four planets status show the Earth is loosing its water budget; to state that by reversing several decades of greenhouse gases emissions combats said SG processes at their forcing 4.5 billion years peak is not intelligent. Unless the Earth heats up as Venus it will freeze over as Mars should its water budgets evaporate and or blow-off into space continues; this planet's living organisms are at great peril, unless said SG processes are stopped. An outcome of preventing measures is much less certain than in addressing greenhouse gases emissions and will not reveal itself for many decades to come. But, it is coming; the Earth without the water budget adequately conserved polar ice caps trends toward a frozen state, sterile, Mars like environments, as greenhouse gases and polar ice caps budgets projected into millennium start to duplicate those observed on Mars; conservatively correctly, current interglacial period, at said Earth's mechanics orbital first peak, will cause a partial atmospheric blow-off leading into next glacial period which start enormous water-vapor precipitations forced by said atmosphere, ionosphere sudden cooling. Off course, this is the forbidden mechanism that triggered said glacial periods; said cooling could occur but interglacial temperature rebound may not for the atmosphere may not contain the water vapor mass to create magnetic field ionosphere perimeter boundaries that avoid remaining water-vapor ionizations then evaporation and the Earth freezing. Said fluids sudden cooling forcing the Earth's crust forces the molten core fluids most ominous accelerated cooling and forces a weaker electromagnetic field; through said SG processes the Earth is the last of said four planets that still holds onto parts of its water budget. When said three planets lost water, undoubtedly parts of the water landed on the Earth. Said Nebraskan-Kansan glaciation limits anomalies are attributable to water-vapors partial or full blow-off that most like occurred on Mars; the Earth orbital mechanics enforce identical periods of interglacial peaks spread at equal time intervals, generally in clusters of three. Currently the Earth nears a midpoint of the first of the three intervals; the clusters occur when said timing mechanisms peaks, said WVMUSCV largest bulb and said polar ice caps reach maximal retreat. When said three processes, events mostly coincide, especially in respect to said timing mechanism, at least, a partial atmospheric blow-off occurs. Said atmospheric, ionosphere globose-inverse transposes into higher energy globose forms forced by plasma fountains activity. Scientific community reported most recent extensive atmosphere's rising temperatures document the Earth atmosphere is nearing said “tipping point”. However, the rising temperature symptoms erroneously correlate greenhouse gases as root causes of forcing higher temperatures; in fact said rising temperatures alarming symptoms constitute a red light warning, only. Supra SG processes including glaciations and cosmos forcing revealed comprehensive, much more ominous histories, as primary enforcers of dramatic environmental changes; whereas, greenhouse gases cause health and ecosystem issues, their molecular weights resist water-vapors rise to higher elevations and/or enlargements to higher latitude, in their eventual downward one cycle paths into tropical regions. Said emissions cuts without accompanied water-vapor cuts constitute unintended detriments with benefits. Energy generation no matter how small, especially those that implement said emissions cut generate water-vapor. Water-vapor air masses permittivity slows magnetic field's high speed ion-electrons flows, enhancing lines disconnects. The Earth magnetic field suggested weakening strength raises lost water-vapor concerns as said fountain outflows enforce irreversible processes.

Aqueducts GC, QCNDMEHC, globose-conduit forms Sets, quantum MEHC force hydro-thermodynamics intelligent arrangements (IA) transistors processors Orders. Whereas, electrical circuits' transistors process quantum electrical charges through binary method processes, said IA transistors processors process said quantum mass QCNDMEHC density/buoyancy (thus, specific gravity, molecular and/or atomic weights), suction, and evaporations, for nonsteady, nonuniform, nonhomogeneous quanta masses perimeter forms and Sets. Said classical globose-conduit forms and Sets as said IA transistors processors assemble into more advanced IA processors, especially with interstitial spaces or hydro-thermodynamics information processing; extended to include the Earth's magnetic field electro-thermodynamics said forms with Sets constitute assembly systems advanced Order, an IA main processor. The Solar System, Milky Way, Universe as advanced IA main processors constitutes highest, multi-core highest, and the highest Order, respectively. Said correlations respective energy relationships from one to other forms of energy frequently applied to electrical and fluid flow relationships verify said GC thermal aqueducts as the countermeasure to said fountains' forbidden mechanisms. Said thermal aqueducts waters QCNDMEHC quantum mass energy can seamlessly substitute said fountains' heat energy dissipated into space with heat energy transfer into the continental crust, seamlessly integrating said advanced IA main, highest, multi-core, and the highest Orders processors, GC Sets/forms processors inside the GC Universe.

The Earth's ecosystems geophysical reserves allow QCNDMEHC energy utilizations and conversions but process water-vapors heat energy that self generates water-vapors as byproducts. Said SG processes arrest or containment requires enormous energy demand not developed in our current technologies arsenal. Said GC Sets, forms disclose infinite water and energy conserving, showing mass energy frictional losses two orders of magnitude better than in ubiquitous devices. However that is not enough; said buried thermal aqueducts QCNDMEHC technology matches in energy conserving said SG processes but only when in unisons with said GC Sets and forms said GC Universe IA processors Orders that ubiquitously confront said SG processes. Said aqueducts lifespan mandates GC Sets and forms QCNDMEHC perimeters. Energy demands will transform rivers geophysical energy into mainly said buried, thermal aqueducts. Engineered materials, heat energy transfers, and geotechnical technologies apply to aqueducts; millennium-lifespan requires structures aging incorporated into designs, especially heat energy transfer and dissipation, natural river beds, water free surfaces, groundwater elevation variations, intakes and discharge structures and aqueducts elevations and settlements. Said aqueducts insulated crown highest surface below subgrades frost line, subgrades highest densities and specific gravities least interstitial space, and noncorrosive metals, minerals, and plastics materials, composites with inner surfaces polished all are preferred; supra materials and workmanship constructions shall constitute the highest quality.

The Mars observations confirm, without doubt, the aqueducts shielded water masses from direct sunlight force viable technology; said QCNDMEHC perimeters, buried, thermal aqueducts hydrodynamic thermodynamics transfer aqueduct contained precipitated water vapor heat energy into continental crusts. Most importantly, said aqueducts irrigation systems network removes the water-vapor from the atmosphere into the continental crusts groundwater storage up to its highest permissible elevations. Aqueducts and groundwater shielded precipitations delay immediate and eliminate significant water masses evaporations normally forced by said Sun's radiation, Earth's, and clouds' irradiations to stay in said Earth's atmosphere heating/cooling cycles. Thus removed heat energy and fluids from the atmosphere into the Earth's continental lands masses combat said ‘global warming’ or reduce said irradiations and radiation, and fluids heat energy the atmosphere contains, with greater heat energy portion irradiated into space. Most crucially, said GC Sets and forms QCNDMEHC least frictional losses with or without irrigation with least pitched aqueducts networks in land masses enforce longest paths longest duration water masses heat energy highest transfer into the Earth's crust with water masses at lowest temperatures at aqueducts discharge to require radiations, irradiations heat energy largest amounts to evaporate. Aforesaid effects lower slightly atmosphere's highest temperatures, enforce water-vapors precipitations, and reverse said WVMUSCV water vapor enlarging bulbs processes; said fluids masses forced direct and reverse directed option cyclical flows through rivers or aqueducts forces said atmosphere continual, very slightly lower temperatures trend for established cyclical control. Yet most important is reversing said WVMUSCV water vapors enlarging bulbs processes forced corresponding enlarged globose forms enlarged electromagnetic field perimeters boundaries. Said WVMUSCV bulbs shrinkages force correspondingly magnified ionosphere and magnetopause perimeter boundaries shrinkages, which move said perimeter boundaries much closer to the gravitational, magnetic field respective centers. Said globose-inverse magnetopause perimeter boundary forms significantly shorten said electromagnetic field's ions and electrons paths lowering their forced velocities energy demands, along perimeters boundaries particularly; thus, simultaneously lower loads on said magnetic field motor/generator precludes said magnetic lines disconnects. Said lower loads and smaller volume perimeters force higher ionosphere densities, more resilient boundary perimeters to counter space said cosmic and solar radiations plasmas densities forcing, therefore, on said significantly shrunk GC globose-inverse forms surface. Said significantly reduced ionosphere's boundaries with said motor/generator electrons lower velocities curtail or stop magnetic lines disconnects and plasmas fountains flows to preclude said orbital forces peaks forced said forbidden mechanisms blow-off. The Earths as the God device IA main processor makes supra buried thermal aqueducts networks the God device cadres that primarily oppose said plasma fountains, the goddamn devices cadres.

A band thin disk plate, small bodies' vast population around the ecliptic referred to as the Kuiper Belt merged into comets nuclei spherical trillions, postulated cloud extends into the Solar System outer boundary with celestial bodies. Referred to the Solar System as a miniature model, takes-on said forbidden mechanisms force, SG processes energy undisputed rule of the Universe.

Circumnavigated aforesaid ions cloud circumferential infinite-period least weights atomic chart ions constitute infinite periods of half figure eight harmonics; such cloud trajectories forced approach any angle can blow-off the Earth's magnetic field, together with her fluids; said Earth's atmosphere thermodynamics electromagnetic field lines' electro-superconducting up to the speed of light is much to slow, with magnetic field low energy, curved paths through molecular air with water-vapors permittivities; said clouds phenomena point to geological formations magnetic field shifts, tied to their dating, occur once within billion years that ignoramuses most readily dismiss.

Said buried thermal aqueducts and timely, globally implemented water-vapor cuts avoid a potential, partial blow-off, which when prolonged causes a magnetic field shift. Said continental groundwater rises, stored enormous water volume weights, must rise gradually across continents, and thus, avoid destabilizing eccentric weights that could cause a wobble in the Earth's rotations. Said aqueducts strategically located along river banks force groundwater levels restored to higher elevations, with lawns watering methods progressive activation that manages the water available.

Curtailing or shutting-off the plasma fountains alters the Earth's, Solar System discharge, as the Goddamn devices function or said Milky Way Galaxy space mass energy communications from said main, multi-cores to the highest IA processors Order as IA Orders processors networks Orders, respectively. The caused extremely small changes in comparisons to the Solar System's energy releases alter the Earth, Solar System, Milky Way Galaxy respective location, orientation. No choice; said GC IA processor Orders must counter said SG processes mass-energy enforcing.

Machinery mechanism processes forcing a regulatory and three construction Parts are the following:
I. Photoelectric-cell or film machines upper shell, least latitudes transcontinental air routes and routes least altitude, converted solar radiations to electrical energy enacts the regulatory Part. Least latitude has the machines in reduced interstitial space, highest water vapor air mass for least greenhouse gases ambient temperature difference, greenhouse gases shortest downward paths to their settling places. The routes concentrations concentrate greenhouse gases within remaining least interstitial spaces heavier air mass volumes rises, enhanced downward move opposing water vapors air masses rises to highest altitude, movements toward the poles. The machines entirely, the greenhouses gases partially block out Sun's most intensive radiations. Said machines and emissions enhance positive effects, counter WVMUSCV bulbs enlarging.
II. Floated over water blankets or tarpaulin photoelectric-cell or film fields that block radiation. Structural, anchored grid, yet allowed, to move with spacings or holes that avoids dead spots or underside molding. Plastics, not limited to PVC, floating tubes frames, restricted rotation joint connections allow the field movements at joints but entirely stiffens cells entire frames. Electric cables through tubes, joints, and circuit breakers feed localized power demand grids.
III. Machinery mechanism versions solar mirrors or panels instead of said photoelectric-cell/film fields steam or hot water suitable piping generates electricity and shields surface water fluid. Floated versions are most suitable for medium size recreational lakes. Said machinery fields supported above water from water/river bed make said blocked Sun machines versions, also.
IV. Said photoelectric cells, films covering cars and trucks free surfaces powering their batteries.
   Said machinery mechanisms resilient water environment and weather proof constructions block SG processes evaporations; said ground insulated vehicles said surfaces reduce irradiations.

Said IA processors Orders make up GC Sets and forms a respective living cell, cells local system, an organ, and organs network and organisms living networks Universe, as intelligent GC conforming embodiments QCNDMEHC. Living cells GC Sets, forms, and epidermis traits force local, ‘global’, networks, and GC Universe inflow Inlets, outlets, internal globose-conduit forms, respective positions, rotations, and orientations; said GC Sets, forms, Inlets, outlets, basin-outlets with internals define forms structures lengths, cross-sections, shapes forced perimeter boundaries and overall dimensions flexibility, elasticity and strength with evolution histories, growth, repair, longevity or regeneration. Fluids and structures, submicroscopic, microscopic, microbes, electric charges, ions, atoms, molecules, compounds, and interstitial spaces, homogeneities, uniformities, compositions, boundaries membrane, consistency, steadiness, color, cyclic variability, flux range and longevity force forms and Sets internal, external boundaries, perimeters, deformations creep, temporary, cyclic, permanent, axial, longitudinal, and transverse perimeters membranes, and wall thicknesses changes, normal, active, excited, very excited, stressed, and overstressed states. Said physical densities and chemical transfer processes energy, and electric, muscular, nervous system impulses and flux duration intervals, dynamics and interactions oppose said SG forced processes.

Human's intelligence center, the brain with fluids energy provider, the heart, enclose GC Sets and forms assemblies version; stretched limbs reach enforces said GC forms special version.

The Earth's molten core, magma, lava flows, rivers, streams, creaks is taken analogous to humans' cardio-vascular system. Living cells and said GC Sets and forms force infinite varieties pooled into said Universe of IA Orders of mass energy processors. Said cells positive or negative ionic discharges known as ‘action potential’ transmissions travel along said cells membrane used most extensively by the nervous system communicate, transmit information to other body tissues and organs; said action potential ‘polarized’, ‘threshold and initiation’, ‘plateau phase’, ‘phases’, ‘resting potential’, ‘stimulation’, ‘rising phase’, ‘peak’, ‘falling phase’, and ‘undershoot’ behave, model as reactor/capacitor, RC, potential circuits; said action potentials and electromagnetic field ions/electrons flows take on analogy of said atmospheric thermodynamics magnetopause fluxing.

Said analogies group humans and the Earth into said GC Sets, forms, IA advanced Orders processors two separate categories. Humans' cognitive, intelligence, communication and motive energy directional skills differ; however, the Earth enforces said activities and skills. Three facts dominate. Said QCNDMEHC GC Sets and forms buried thermal aqueducts networks revitalized Earth's ‘cardio-vascular’ and magnetic systems functions force processes that extend indefinitely the Earth's life; said two systems Earth's fluids masses forced liquids and gases interactions with perimeter changes further force a third change; said third the most important of the human, Earth comparative analogies forces life extensions. Said GC Sets and forms IA Orders, processors said QCNDMEHC at the core of said extended life enforce MEHC laminar flows four unique generic claims, especially devised for quintessential purposes of enforcing quantum masses flows highest mass energy conserves said perimeters and boundaries, as said four generic claims quantum mass compliance with the Law of Conservation of Energy encompasses the Laws of Thermodynamics. Said thermal, buried aqueducts quantum masses, potential, kinetic, and heat energy transfers Sets and forms transistors QCNDMEHC by supra analogy are GC, Sets ‘processors’, henceforth, thus referred. Said human skin cells' surface membrane, magnetopause GC Sets and forms respective fluids mass energy boundaries transfers enforce comparative biologic, inorganic taken analogies.

Said buried, thermal aqueducts QCNDMEHC GC Sets and forms enforce Earth longevity hydro-thermodynamics, human intelligence highest achievements forced ‘inorganic intelligence’ parts, enforcing the Earth's hydrodynamics, thermodynamics electromagnetics system longevity. Supra blurs human with said Earth's intelligence said comparative biologic, inorganic analogies.

Aforesaid GC QCNDMEHC Sets, forms human longevities, infinitesimal compared with Earth's longevities, said invention, methodologies, and principles enforced comparative biologic, inorganic analogies, especially said inorganic features, enforce same Laws. Human physiology-impulses, submicroscopic, microscopic, atomic and molecular electrolytes medical jargon ‘lytes’ elementary substances forms from subatomic to compounds are globose forms varieties, wherein living cells globose forms also force said globose-inverse versions. Said living cells interrelation intercommunications globose, globose-inverse advanced IA Order processors used conduit forms also find medical sciences fail to enforce said interstitial spaces deserved critical aging functions. Analogous to the Earth's masses human compositions percent weights and volumes in respect to total weights and volumes force specific perimeters boundaries and differences of said GC forms and interstitial spaces locations, shapes, distributions, percentages and total of each, and enclosed masses, volumes, and boundaries thicknesses. Supra GC structures, fluids and interstitial spaces, Sets and forms compositions, internal boundaries, perimeters; physical, chemical, densities; cells traits and dynamics with interaction changes through highest magnifications magnetic resonance imaging compiles living cells database referral compiled normal, numerous excitations, and their abnormal states, said interstitial spaces locations, shapes, percentages and total volumes enclosed masses, perimeters, and boundaries' thicknesses; said Earth, human analogies balanced inorganic masses budgets mandate human longevities enforcing least budgetary inorganic masses, volumes with their reserves. Thus, fluids pressures, especially blood pressure, and fluids, electrolytes and liquids masses, and interstitial spaces, and said advanced IA Orders—processors cells interactions and intercommunications, and most significant among these, the brain enforced well being status account for longevities; said GC inventions, principles, methodologies enforce most comparative said analogies which the Laws of Mass and Energy Conservation and Thermodynamics mandate.

Human biological, Earth masses crucial processes forcing longevities force brain-nervous system, said Earth's electromagnetism, liquids and gases perimeters interactions for said GC Sets and forms boundaries masses and heat energy hydrodynamics thermodynamics optimal transfers.

Physiologies, biological processes with interstitial spaces identical to inorganic processes highest conserved mass energy QCNDMEHC Sets and forms serve as processes aging inhibitors; said buried, thermal GC QCNDMEHC aqueducts fluids energy electromagnetic thermodynamics hydrodynamics shunt radiations, irradiations, and said ‘global warming’ processes heat energy to reheat nominally the Earth's crust forcing longer longevities enforcing mass energy heat balance.

Mass-energy conservation laws define ‘mass-energy’ as substance that makes everything. Analogous to water seeking its lowest level, said ‘mass-energy’ seeks mass-energy lowest states. The space omnidirectional infinity matrixes, said SG processes enforce omnipresent mass-energy lowest states; said GC QCNDMEHC buried, thermal aqueducts Sets and forms in said IA Orders processors synchronous operations save the Earth's said mass-energy highest conserving as main processor by strategic heat energy transfers forced magnetic field and systems closed boundaries. Said Earth's system processes enclosed perimeters boundaries retained fluids mass energy except for said radiations into space, counters said SG forcing, and thus extends said Earth's longevities.

Said human, Earth comparative analogies, with the Earth as a guide, takes cells-strings as advanced transistors-processors arranged and bound into organs as cells advanced local networks with organs operated by their advanced main processor, the brain, and jointly taken as an Internet of organs' networks. Each cell a Set and cells as Sets and forms sizes, perimeters and boundaries thicknesses, least temperatures or pressures flux variations; least ambient temperatures, pressures and their variations difference, least largest-magnitudes fluxing of each; best cell walls and fluids composition and interstitial spaces, especially at interfaces; cells and organs ideal boundaries and molecular genetics GC forms Sets sizes, compositions, continuities, growth; systems integrations fluids hydrodynamics thermodynamics; ideal cells IA integrity and interactions continuation with mass energy flows define longevities and comparative system analogies. Fluids mass and energy flows must comply with the Laws of Mass and Energy Conservation and Thermodynamics. Said four generic claims continuations conforming embodiments, PAP, PPLD, PP, and PPLLS, paths-of-passage lengths least sum based on quantum masses, QCNDMEHC GC Sets and forms forced boundaries' perimeters condenses said Laws into MEHC enforce said fluids classic transistors or processors. Theoretical and physical MEHC Sets and forms embodiments “laminar” flows force perimeters or boundaries ‘flow control means’ forms; the Earth's magnetopause electromagnetic field lines perimeters boundaries force atmosphere's fluids ‘flow control means’. Liquids mainly of water masses and the Earth's crust force innermost perimeters boundaries; said buried thermal aqueducts QCNDMEHC GC, Sets and forms boundaries perimeters force radiations, irradiations excess heat energy from the collected atmosphere precipitations water masses into the crust; thus forced processes conserve infinite water masses as such no water loss is enforceable into infinity. Said atmosphere's radiations, irradiations excess heat energy transfer into the Earth's crusts stops plasma fountains mass energy outflows into space; said aqueducts perimeters boundaries enforce fluids masses kinetic energy least frictional losses forcing least potential energy aqueducts slopes ultimate heat energy transfers. Fluids mass viscosity and perimeters boundaries with fluids flows no frictional losses, as ionosphere masses do, approach translational motion and rotation that stay in the gravity, magnetic fields gradients stay in translation unless forced by another mass-energy. Said GC perimeters enclose QCNDMEHC classis. Light energy QCNDMEHC contained within gravity force fields forces a black hole. Cosmos enclosure defines light and gravity energy force fields unique common boundary. Electrons electric charge orbiting perimeters boundaries about nuclei force atoms; best QCNDMEHC approximations enforce enclosed said GC Sets and forms; fluids flexible/elastic or solid epidermis membrane boundary perimeters force GC live-cells Sets.

Said Earth's gravity and magnetic fields superimpose fluids GC forms and Sets gradients forcing common magnetopause perimeters boundaries said solar and cosmic winds and pressures highly deform; said gravity field magnetic field lines enforce fluids' said PP as said ‘flow control means’ streamlines that are orthogonal to the gradients. Said PPLD is the Earth's magnetopause, GC, perimeters boundaries forms; said two cusps and irradiation enforce three operational modes are useful; all three transmit naturally heat energy across magnetopause's boundaries; said PPLD as a curvilinear line form rotates with the Earth's rotation forming a globose surface deformed as the magnetic field magnetopause and ions' surfaces flux deform under said atmosphere's internal thermodynamics temperatures, pressures with said Solar, cosmic winds, pressures, and radiations variations. Said PAP is an imaginary tangent line to the air masses perimeter constituted globose form and to said magnetopause's cusp innermost magnetic line; said PAP rotates with the Earth's rotation into an imaginary surface that with the Earth's revolution forms a two inverted truncated cones' surfaces; with said magnetopause deformed perimeter boundaries, said surfaces warp. By definition said PAP line is in a quantum mass energy system upright plane of symmetry; the PAP as linear least energy path of maximum demand, least energy consumed path, in said ionosphere discontinuous as curvilinear due to magnetic lines fluxes or mass densities' variations dynamics.

Said atmosphere's mass low heat energy irradiations to space force said ‘global warming’ and fresh water reserves and polar caps dangerous depletions, which force water-vapor ions said plasma fountain outflows; said GC buried thermal aqueducts partially reroute natural heat energy emission from the Earth's matured masses for their geological times long periods slowed cooling processes, while at the same time, lower vapor emissions into the atmosphere enforce higher heat energy irradiations to space, and leads to the atmospheric ‘global cooling’ plasma fountains shut-offs forced water masses said MEHC; said GC buried thermal aqueducts, said heat energy shunts preclude said SG processes and said plasma fountains; most crucially, they shunt said radiations, irradiations and industrial and power generation byproduct heat energy into the Earth crustal and magnetic field rejuvenations, thus precluding said Earth's eventual forced drying-out or freezing.

Buried, thermal, GC, aqueducts networks empower industrial electrical energy generation with their byproduct heat energy critical usage, for Earth's prolonged longevities preserved water reserves fluids hydrodynamics, thermodynamics, electromagnetics, inner boundaries heat energy transfers, precluding said magnetopause, cusps outer boundaries mass energy outflow into space; said vapors WVMUSCV bulbs, ‘global warming’/cooling and said GC buried, thermal aqueducts water heat (GCBTAWH) energy transfers moderate; said vapors mass WVMUSCV greater bulbs heat energy forces ‘global warming’. Said GCBTAWH networks diminish said geological crusts cooling with or without irrigation, wherein specific conditions irrigation can force crucial effects. Said WVMUSCV diminished bulbs allow more irradiations, heat energy escapes into space; said aqueducts irrigations groundwater elevations controlled rise enforces precipitations evaporations diminished said WVMUSCV bulbs, and thus replace/reverse lower groundwater levels processes greater WVMUSCV bulbs forced glaciation periods' billions of years groundwater cycles, forced to lower levels forcing water-loosing heat energy transfers. Said buried, thermal aqueducts water masses substitute and reverse said glaciation periods' effects said groundwater levels change and heat energy transfers into said crust across the Earth's said fluids globose masses inner perimeter boundary; vapor volumes many-fold condensed into said aqueducts' water decouple said Earth's and Solar System/cosmic SG processes water ions mass energy demand on the Earth's resources, repelled with larger heat energy irradiations across magnetopause into space enforcing said fluids sustained perimeters' boundaries. Said GCBTAWH energy networks as shunt switches decouple industrial, power generation and human water demands, avoiding natural evaporations processes; most crucially, utilized byproduct heat energy delays Earth's aging processes. Said GCBTAWH QCNDMEHC GC Sets and forms as inner perimeters' boundaries inside said fluids, ions masses GC magnetosphere boundaries constitute sequential, laminated enclosures or boundaries cosmos unique Earth's IA super-advanced main processor Order. Said hydrodynamics, thermodynamics electromagnetics, physics and chemistry laws, and geological history, scientific and astronomical observances validate said GCBTAWH, QCNDMEHC GC Sets, forms said heat energy transfers.

Globally, governments inefficiently extract, refine, and utilize said Earth's crustal masses mainly fossil fuels releasing continually fluids byproduct enormous volumes into the atmosphere which along natural evaporations force said enormously enlarged WVMUSCV bulbs and ‘global warming’. The Earth as the God device with its electro-magnetic field functions awesome skills retains its fluids masses energy effectively but not always; supra said magnetic lines disconnects, unfriendly mechanisms, and fountains ions' masses discharges, a partial or an entire atmospheric blow-off said solar, cosmic radiations and wind pressures enforced; especially near Milankovic's said cyclic rotational, precession periods and orbital eccentricities cyclic peaks which historically at every third cycle trigger said partial blow-off said forbidden mechanisms' glacial period onset. The third cycle said trigger is taken as maximum time interval that forces said largest atmosphere WVMUSCV bulbs. Globally, scientific community most recent studies forced said governments into acknowledging said ‘global warming’, and global energy crises and water budget depletions. It is apparent the world body lacks input on bulk mass energy generation, transfers and transports and as yet do not see said three global crises as billions of years said SG processes enforced three prong attack on the Earth's mass energy. Nikola Tesla's innovations singularly stand out, yet the Western World treated them most shabbily. A documented 925 major rivers analysis from 1948 to 2004 revealed an overall decline in total discharges; the Pacific Oceans inflow reduction alone nearly equals the Mississippi River outflow; many fresh water resources are expected to decline. Since the glaciers are melting and ocean levels remain steady, where is all this water transferred? Forced into said atmosphere WVMUSCV bulbs and ionosphere masses that said magnetosphere, magnetopause perimeters boundaries enclose but unfriendly and forbidden mechanisms forced to release into space. Environmental sciences' convincing and comprehensive data predict globally crustal energy utilization forced said timing mechanism to trigger said forbidden mechanism said cyclical blow-off peak from the third to the first said peak occurrence; globally, governments and supply side bulk energy producers and associated entities fail to implement current sciences state most advanced engineering technologies transfer into practice which force prudent governmental policies. The Earth's as the God device function is most apparent in viewing graphical modeling of the magnetosphere's violent deformations, near speeds of light mass-energy displacements. It is crudely resembles an enormous fire flame and instead releasing its energy said flame perimeter boundaries contain it. While gravitational field contributes, it is the Earth's electromagnetic field retained ionosphere contained atmosphere that saves the God device; said electromagnetic field's gravitational pull and said strength combined sustain, maintain and reconnect magnetic lines said magnetosphere perimeters boundaries; thus, said magnetic field perimeters boundaries place it in the God device domain genres cadres. Fluids and devices mass energy that support the magnetic field, including, such as motors, generators and turbines that generate said mass, fall into the God cadres category provided each constitutes longevity enforced significant generated energy which is forced into residing inside said Earth perimeters boundaries; most certainly, gravitational mass common ultimate destination is a black hole, an apparent goddamn device, which forces said SG processes. Constellations' Stars generate cosmos' light energy in partial distributions away from black holes which along with the Stars a black hole eventually captures unless intelligence with a superior intellect intervenes. Atomic elements of the Periodic Table are neutral cadres as long as they have their electrons; they become the God device cadres only as integral constituents of said structures or processes that conserve energy. Ions are essentially unfriendly cadre categories that at first chance enforce said black holes SG processes. Thus said GC Sets and forms mass energy forcing said QCNDMEHC and MEHC processes force the God device cadres and crucial genres. Mass, except for supra excluded formations, especially SG mass energy formation particles force eventually goddamn devices formation(s) including the so called ‘God particle’ which actually is the goddamn particle. Said God devices mass energy formations reside in living organisms, also. Electrons' motions or dynamics supporting natural, devised electromagnetic fields and inorganic, living perimeters boundaries mass and energy are the God device only subatomic genres, cadres.

The conforming GC Universe fluids mass-energy four ‘functions’ confirm the continued presence of the four generic claims forced perimeter boundaries Universe as one and the same, as the ‘functions’ force ‘sub-functions’ retained, transported mass-energy forces said generic claims quantum masses paths and patterns enforced perimeter boundaries forms and Sets and vice versa. Thus, the ‘forms equal functions’ confirm, reconfirm and resolve Arts and Sciences many issues, such as, forcing reply to the Earth's ‘global warming’ mass-energy forced outflows into Cosmos.

The GC Sets/forms Universe mass-energy highest conserving, MEHC, and QCNDMEHC neglected formations/processes by the scientific community resources these Applications correct. Valid enormous GC Sets significance is on par with the Laws of Mass and Energy Conservation, as perimeter enormously significant boundaries that enforce MEHC GC Sets enforcing the Mass and Energy Conservation Laws;

Said GC globose forms' mass energy highest conserving (MEHC) fundamental ‘function’ has two parts: an energy conserving and a processing part. Each of said two parts independently, inherently constitute ‘function’ said seven responses for fourteen ‘sub-functions’; the GC conduit forms MEHC and energy transport two parts have fourteen ‘sub-functions’, also; also, clockwise, counterclockwise rotations responses in three planes have fourteen ‘sub-functions’. ‘Substances’ ‘forbidden’ ‘functions’, except for the one ‘forbidden’ function, said devices cannot generate; the one ‘forbidden’ omnipresent function has the Conservation of Energy and Mass Laws most often quoted statement is that ‘mass and energy cannot be created or destroyed. Said globose-conduits GC Sets or forms confined ‘substance’ must satisfy conforming quanta least mass, as the twenty-ninth ‘substance’ basic elementary GC form ‘function’; said ‘substance two GC functions ‘forms equal function’, which with MEHC as the twenty-ninth response force said PP lengths least sum. Said Sets further constitute device ‘forms equal function’ wherein the ‘function’ transports waste products through drainage lines with least mass of transport fluids; the devices as drain traps and said Earth constitute the additional ‘function’ requiring said undersurfaces constantly submerged; in the Earth's instance the crustal masses submerged with the atmospheric fluids. Said ‘function’ applies to fluids submerged transition regions fluids mass QCMEHC ‘genomes’ or MEHC flows, for said quantum mass achieved closest to twenty-eight ‘none of the above’ and three absolutely positive affirmative responses, enforcing the Laws of Mass and Energy Conservation guaranteed ‘genomes’, GC Sets and/or forms; ignored or excluded most important ingredient, the God's said ‘substance’ Mass and Energy Conservation Laws takes away authority, power and force from the Science into the USPTO authority rationale power or influence centuries of misguided misplaced practices. At best, through centuries the USPTO has implemented a rationale for licensing crafts and trades devices. No scientific knowledge exists to validate rationale which cannot distinguish ‘function’ differences among pure, drinkable water and wastewater, with a total obliviousness for nonuniform, nonhomogeneous, nonsteady mass energy highest conserving transistors/processors.

Said mass-energy sum for entire quanta mass quantum twenty-eight ‘sub-functions’ force for each direction and angular rotation a static or dynamic ‘yes’ or ‘no’ response conformation in respect to the adjacent quantum masses and for the quanta mass. Supra four ‘none of the above’ quantum responses constitutes twelve ‘neither-of-the-two’ responses for quantum mass in quanta mass seventy-two ‘sub-function’ responses constituted globose forms said ‘functions’ to contain, retain, detain with said conduits ‘functions’ to transport/retain. The ‘sub-functions’ permutations explode unless perimeters' boundaries force said ‘sub-functions’ specific responses, especially in nonhomogeneous, nonuniform fluids in forcing nonsteady flows quantum sizes and or viscosities the seventy-two ‘sub-functions’ coalescing into its sum or quantum masses coalesced-units sums.

For most transport fluids' low viscosities, perimeters boundaries effect fluids conforming ‘sub-functions’ at interfaces. However, said ‘sub-functions’ responses reorganize very rapidly to self-preserving self-conserving MEHC or QCMEHC perimeter boundaries. Supra FESD and GC Sets and forms utilize these fluids phenomena toward forcing quanta mass ‘flow control’ specific surfaces enforced ‘laminar’ flows ‘sub-functions’. Here, ‘forms equal function’, four ‘functions’ boundaries coincident perimeters enforce conforming mass-energy Sets and forms, GC Universe.

Supra four generic claims, a DCSS and a retention free-surface conforming GC Universe embodiments forms and Sets embody fluids mass-energy said four ‘functions’ force said Science ‘forms equal functions’ rationale MEHC or QCMEHC mass-energy fluids transistors/processors.

The Earth's atmosphere frictionless mass-energy fluids by its gravity and electromagnetic field continuity conform to said four ‘functions’; the Earth's gravitational force field enforces the atmosphere's mass globose basin form wherein magnetic field forces either one of superimposed cusps as outlet vents through which ions, ‘Jean's’ fountain, plasma flows occur; the Earth's form enforces the globose-inverse Set with water evaporations from its surface, the atmosphere's inner boundary, primarily its tropical belt as the globose-inverse Set Inlet forms. The evaporated water under solar radiations at high altitudes breaks down into ions that effect mass-energy said plasma flows. Application Ser. No. 12/153,036 summary explains supra in sufficient details, wherein the Earth's energetically fluxing electromagnetic field and gravitational forces boundary significantly varies the atmosphere/ionosphere outer boundary. On occasions, the outer boundary extreme, energetic said fluxing forces atmosphere/ionosphere globose-inverse Set transposed into mass energy most energetic globose Sidelong Set, with drastic changes that occur to the inner boundary; in fact, the Earth's glaciation periods were triggered in these event's evidence prior application documented, including the four generic claims presence which altogether entirely confirm innovations' claims.

The United Nations, intergovernmental ‘global-warming’ study entirely ignores the outer boundary effects, assigns all detrimental causes to ‘green-house’ gases, and actually slights water vapor effects, which said filed applications submitted to the US government correct significantly. However, there is no evidence submitted to diminish the study details and comprehensive nature, especially conclusions on the Earth's no-return ‘tipping point’; outer boundaries forced effects, if anything are very troubling; application Ser. No. 12/320,441 nuclear energy power plants are millennium lifespan, viable, really safe technology available for advancing energy independence; the Earth's mass energy confirmed effects data of less than millennium lifespan is irrelevant or insignificant. From the Earth's genesis to present, surfaces and environment that include glaciation periods and their triggers the Universe fluids' masses and energy omnipotent said SG processes unrelentingly dominate; the Earth as an infinitesimal, insignificant, and unwillingly forced participant unless defended by utmost knowledge, skill and effort converts to a goddamn planet device in infinite domain population. Said forced SG processes ‘global warming’, energy crises and water masses depletions imperiled Earth's survival, said fluids' MEHC, QCMEHC and QCNDMEHC combat; said ‘sub-functions’ satisfying, one ‘forbidden’ function, said devices three-'functions' force said GC Sets and forms more rare than diamonds said four ‘functions’ with four coincident perimeter, boundaries: conforming fluids' least quanta, transition regions submerged, high density particles' transport, and MEHC; said four ‘functions’ force globose and conduit ‘functions’, each enforcing said MEHC transition region submerged for each form's MEHC ‘function’ enforced high density particles transport. Said Mass and Energy Law statement that mass and energy cannot be created or destroyed should continue with: mass and energy transport or transfer into counterpart mass or energy forms energy forced releases at critical energy state and perimeter boundaries can enforce sudden uncontrolled QCMEHC discharges collapsing its GC said God cadres said genres system;

Said GC Sets and forms four ‘functions’ force Earth's and atmosphere's masses functions retained by the gravitational field reinforced by superimposed enforced magnetic field perimeters boundaries, ‘global warming’ MEHC Mass and Energy Laws interglacial, glacial period triggers geological science evidence said masses phenomena enforced conforming least mass boundaries. Frictionless fluids' least, near-frictionless perimeter boundaries force said MEHC QCNDMEHC. In time and space, ‘substances’, mass energy, constitutes dynamic globose conduit, GC, globose-conduit Sets, forms enormously powerful innovations, principles, and methodologies in common origins with ‘substances’ omnipresent said ‘functions’, Universal root forms, paths, and patterns. Said Mass and Energy Conservation Laws forced said innovation, principles, and methodologies ‘functions’ perimeters boundaries or vice versa enforce mass energy enormously powerful tools.

Said plasma fountains are key process in said SG processes forcing. Said buried, thermal aqueducts are key structures in the God devices cadres, genres functions and only such structures to combat said SG processes ‘global-warming’ forcing the Earth's changes to a goddamn device; thus, said aqueducts crucial to the Earth's and electromagnetic field's longevities function belong in the God device cadres, genres; said MEHC, QCMEHC, and QCNDMEHC by association with said aqueducts said Sets, forms and ‘functions’ qualify said drain traps, sewer lines, and drainage lines Sets and forms fluids' conserving mass energy as the God device supporting cadres, genres.

A generation-one, millenniums longevity nuclear power plants forced electrons-flow bulk mass-energy generation across enforced sequential and in parallel secured perimeters, boundaries buried, thermal aqueducts circumvented SG processes is the only such God device genres, cadre; said plants processed energy is forced to residing inside said Earth's inner perimeters boundaries.

World governments engage globally into bulk energy generations that unfortunately force crustal masses energy vigorous mining, processing emitting said SG processes fluids, byproducts mass and energy into the atmosphere enlarging the Earth's said atmosphere and ionosphere outer perimeters boundaries; forced to weaker electromagnetic field and gravitational force extremities magnetic field lines lower protecting and reconnection, mainly said water ions are blown off into space. The Earth as the God device circulates air masses, such as with hemispheres' jet-streams, forcing said emitted fluids' vapor to condense and thus fall toward its inner boundary. However, the World governments wind power generation deprives the Earth of her wind power and energy portion that cools her, and thus delivers severe damage to processing and retention of her masses energy. The geothermal power generation weakens the Earth's magnetic field and thus damages its strength and function at said outer perimeters boundaries; included in said policies fossil fuels mining, processing said vapor emissions, global energy policies are driving the God device to the goddamn counter-form. Global energy policies forced the Earth will force forbidden mechanism blow-off loosing a part of her ionosphere/atmosphere, and she may follow that with a closer orbit around the Sun to increase rotational speeds fluids' masses energy circulations into equilibriums. Bulk electrons energy generation from solar energy deprives land masses of heat energy. Forced Earth's crustal and her core magma cooling weaken the Earth, the God device, forcing weakened magnetic field's strength and perimeter boundaries crucial genres that combat said SG processes; environmental scientists, bulk energy producers prognosis has fluid vapors SG processes toasting the Earth unless said decisively deployed genres cadres prevail; said water-vapors said blow-offs in millenniums freeze her; narrowing her orbits for fluids circulation increase, she overheats; said cadres forced MEHC water masses and vapors balanced budget has the mankind's survival hope.

Thus wind energy bulk power generation robs said Earth as advanced Order IA processor of winds energy that naturally cools her; geothermal, land-solar bulk energy generation weakens said magnetic field strength perimeter boundaries protection of her fluids; fossil fuels generation of bulk energy speeds said SG processes; all human energies, intellect should deploy said cadres. Fluids MEHC, QCMEHC and QCNDMEHC combat Universal stratification gradation processes ‘global warming’, energy crises, and water masses depletions, which imperil the Earth's survival.

Said Mass and Energy Conservation Laws advancing engineering-sciences' transfers into practice, said cadres genres MEHC, QCMEHC and QCNDMEHC forced Sets, forms, and ‘forms equal functions’ fully enforced by said generic claims innovations, principles and methodologies; the God device said Earth's fluids ‘functions’, said perimeters' mass energy highest conserving said cadres genres ardently enforce; else, man-activities variably contribute to said SG processes.

Said ‘Quintessential’ denotes fluids mass and energy genres, density, and boundary limit; said ‘core’ refers to said energy-forms genres, said energy-forms basic paths, forms and patterns; said ‘natural disposition’ means in atmospheric pressures in technical jargon open channel forms; said ‘least height’ means safer, conserving fluids' pressures and mass densities, operation modes, forced as a means that defines crucial properties through ‘forms equal structure’ patent licensing. After intake structures screening processes, water into said aqueducts inner polished MEHC said surfaces ‘forms equal function’ conforming to said quantum mass PP lengths least sum perimeter constitutes said complete complement composite breadths forcing a small lower region, a mostly submerged transition region and large upper globose region forms; after said screening processes water nearly uniform composition, gravity forces in optimal operational mode through said small lower region, thus slightly smaller, narrower than entirely round forms; said transition region and most of said globose region are submerged; said transition with lower region makes a “U” shapes deviation from entirely round form, with respective breadths at elevations forced by said MEHC, PP lengths least sum perimeter form; said upper globose region constitutes horizontal, major axis elliptical perimeter form with water free-surface vented as in open channel flow to avoid suction. Diverse or highly diverse water composition transports said PPLLS perimeters FIG. 27 describes. Said Flush Apparatus constitutes modeling analogies, comparable to atmosphere's precipitations. Briefly, the Universe fluids mass and energy said SG processes enforce. Unless God device said cadres genres succeed, the Earth toasts first to then subsequently forced into a frozen over planet. Electrical energy flows like a fluid, is the Earth's mass mostly bounded, thus is treated as a fluid. Said nuclear plants produce no new fluids, vapors mass energy or discharges into the atmosphere and force byproduct heat energy into the Earth's crust, and thus is not seen and perceived by said Universe SG processes. Said GC Sets and forms MEHC, QCMECH, and QCNDMEHC contain, retain, detain at best operating mode fluids bulk transports mass energy, which likewise forces its heat energy transfers to the Earth's crust. Said cadres give the Earth's living organisms a chance.

No new drawing is shown, described and/or depicted; the USPTO licensing methodology rational circumvents science. Drawings examples enclosed describe and explain most accurately forms and correct said methodology, rational ‘forms equal function’. Enclosed prior applications claim and illustrate said GC conforming embodiments nonhomogeneous, nonuniform, nonsteady contained, retained, detained and transported supra one-origin QCNDMEHC, QCMEHC, MEHC that evolve, devolve, rotate, mutate, transfer or transpose said forms, Sets boundaries, perimeters.

Said GC Set, forms (FIG. 2-3) compared to a ‘simple trap’ known as ubiquitous and most varied utilization taken as the USPTO present state of art device finds said simple trap's retained, conforming least mass 2.5 times greater, and the useful work done in one retained mass complete turnover raises two times higher than the GC Set, to a must five times greater mass energy usage; also, for the simple trap a least operating pressure is 2.250 times higher and it rises much faster that for the GC Set after a small initial rise, since said GC Set best operational mode outlet FESD ascending spout forms can have composite cross-sectional area an order of magnitude larger than its Inlet cross-section area; said simple trap surfaces-interface area is five times greater, with said pressure area multiple 11.25 times greater. Then, there are coefficients of friction dynamic flows slope angles multiples, best illustrated with the PPLD greatest slopes of about 50 degrees and for simple trap 90 degrees; said angles sine ratio raises said multiple by a factor of about 1.3 to 14.6; also, there is flow rotational angles difference illustrated by 105-degrees PAP angle compared to 180 degrees for the simple traps; said elbows taken as the respective angles sine ratios raises said multiple by a factor of about 4. It is known that the fluid flow handbooks provide pressure drop caused by a 90° elbow with simple trap having three; and the GC Set, in fact, has none for the inflows into its much larger globose basin is primarily cross-sectional area change having a much lower pressure drop than it is for 90° elbows; also, there is a time factor represented by respective PPLD lengths. Said GC Set's PPLD length is less than half of said simple trap respective length. The larger mass turnover contains high specific gravity particles higher number; when flow stops their paths retrace cause blockage, not just efficiency losses; elementary sciences said computing has said GC Set using two, three orders of magnitude less mass and energy than said simple trap.

The following pages likewise translate basic Laws of Mass and Energy Conservation into detailed and correct said GC forms, Sets applicable ‘forms equal function’ rational methodology.

Supra defined forms differentiates basic universal MEHC globose from conduits quantum masses; globose Sets and forms masses energy unavoidably support density, buoyancy properties forced stratification gradation processes; GC globose forms masses one continuous drop causes a potential to kinetic energy mode transfer first phase with Inlet outflows, especially higher density mass inflows into MEHC preferred globose PPLD flattened ‘S’ or globose-inverse ‘C’ or ‘C’ and ‘S’ conforming globose mass shortest height and length PPLD PP paths. Thus, aforesaid enforce lower density and lower viscosity masses quantum energy longer PP forced PP lengths least sum, MEHC, kinetic to potential energy mode transfers second phase in a cycle ending ‘laminar’ flow.

The GC conforming ‘function’ must keep said globose End 2 or the globose-inverse First End submerged, especially the respective undersurfaces while passing fluids mass; the ‘function’ crucial ‘forms’ supra defines; the Mass and Energy Conservation Laws force the PP lengths least sum, wherein said least sum enforces streamlined crucial forms inside GC perimeters fluids mass energy ‘substance’ highest conserving configuration the four ‘functions’ coincidental perimeters. The Inlet, outlet two conduits and a globose basin form must each perform this required function; configured Inlet End 2 fluid outflows into the basin lower elevations hydrostatic and atmospheric enforced uniform pressures steady nonhomogeneous, nonuniform, nonsteady mass energy flows.

Mass-energy equivalence concept mandates existence of globose and conduit equivalence as each must have originated from a same ‘substance’ whole at a same time; the questions what the whole and the time was and what was before that? Bose-Einstein condensate discloses needed information, as it is not a solid or liquid. The globose atomic elements near the absolute zero temperature change into string forms, with curled ends. A laser light-velocity slows as it travels through said supercooled condensate's mass or ‘substance’ static very unstable images of elementary atomic forms. They too must have said same origin and said Laws ‘function’. There is only one unification concept for all of the above. At said temperatures the atoms unfurl themselves from a globose mass toward a conduit mass form in incomplete processes, as said unfurled atoms mass still makes curled ends. In the incomplete processes, globose mass change from almost entirely unfurled to conduit energy linear forms must have controlled condensate's further cooling, which is most likely a virtual impossibility and may require cooling below absolute zero, an impossibility. However, at condensate entirely unfurled ends, the atoms as conduit linear energy forms minimize further interstitial spaces which would further slow down any form of energy passing through. At the point when mass changes to energy, fusion of condensate mass-energy makes it a whole, which blocks passage of any energy including light; the ‘big bang’ originated said ‘substance’ forms' and ‘function’ and ‘black holes’. The Universe ‘black hole’ and ‘big bang’ are generic genetically imprinted mass and energy relationships; ‘substance’ GC ‘forms’ enormous significance is on par with the Laws of Mass and Energy Conservation, as enormously significant perimeters enforcing said Laws MEHC, QCMEHC and QCNDMEHC GC Sets. In Bose-Einstein condensate said seventy-two ‘sub-functions’ lock to ‘none of the above’ modes.

Globose-conduit perimeters enclose quintessential, core, natural disposition mass energy highest conserving classis. Sciences' highest conserving mass energy paralleling analogies make analogous forms. Quintessential core natural dispositions light energy enclosed inside an energy mass force field is a black hole. Light and gravity energy force fields unique common boundary constitutes Cosmos enclosure. If it is electrons electric charge boundary about nuclei, it is atoms. If it is humanly devised best approximations mass energy core, quintessential, natural disposition enclosure boundaries, it is said globose-conduit ‘genome’. GC mass energy perimeters of elastic or a flexible or a solid epidermis membrane boundary constitute a living cell. Thus, mass energy self-conservation, self-preservation paths and patterns configure into ‘substance’ GC forms, Sets, supra defines. Trades/crafts GC Sets/forms are fabricated; engineering disciplines, Arts Sciences mass energy substances may constitute or fabricate into said GC forms and Sets. Generic claims: conforming embodiments; a PAP, a path-angle-of-passage; paths-of-passage, PP, and a paths-of-passage lengths least sum, and a path-of-passage-of-least-energy-demand, a PPLD, are universal.

The Sets and forms detailed approximations follow. Examples of the known universally familiar mass energy classic forms are universally drawn paralleling analogies accepted to exist referred to as classic forms, which universally involve globose-conduit perimeter Sets; the supra four ‘functions’ and ‘forms equal function’ have the Earth's GC genome, as the one most unique.

Prior applications Sets, forms Specification and Drawings ‘laminar flow’ herein defines a liquid, gas, or solids fluid adjacent or neighboring layers that do not mix, enhanced by a relative density or a specific gravity, that flow at different speeds perimeter forms confined to a velocities direction having globose-conduit conforming least quanta mass energy least rotations. Said ‘flow control means’ are FESD forms, a PAP, PP, PPLD geometrics conforming least quanta mass for algorithm approximations continued PP lengths least sum respective perimeter interface surfaces forms from the Inlet's fluid free surface to at least a DCSS for forms constituted globose-conduit classic form. PP lengths as a least sum inherently constitutes conforming least quanta mass least rotations, highest conserving mass energy phases compact composite forms perimeter. An FESD origin PP least sum, conforming least mass least perimeter surfaces evolve, modify, and continue from the first application illustrated shrunk, compressed and ‘flow control means’ specified Sets.

For narrow breadth conduits compared to outlet forms drain or sewer lines, nearly infinite length natural uniform gravity forces globose-conduit form mass energy highest conserving most readily evolve, devolve into spherical forms globose retention, and negotiate rising slope through cross-sections area manipulations. Mass energy composition transports forced fluid free surfaces higher than conduit springing points disclose globose-conduit unmatched fluids energy transports superiority with conforming least quanta mass least height, least rotations, and lowest hydrostatic pressure largest free surfaces least boundary friction, with sewer or drain lines highest elevations.

Flow-energy-surface-dispensators, FESD, originated with the first application; entirely the second application shown and detailed are drawings continued ‘flow control’ classic globose-conduit perimeters.

Nonhomogeneous, nonsteady, nonuniform mass-energy composition inflows are globose-conduit cross-sections area perimeter boundary. Mass-energy, mass energy, refers to a globose-conduit quantum, quanta fluid mass contained energy. Globose-conduit units of mass, quantum energy, is contained continually, a transported, retained, contained mass energy or a transported contained, retained, detained, mass energy phases. A quanta mass has varying phases' amounts in variable percentages. Globose-conduit open channel, vented forms, stratified fluids densities, under atmospheric pressure mass-energy mechanics of forms make the introduction to drawings.

Globose-conduit forms and Sets boundary contains, retains, detains, and transports fluids nonhomogeneous, nonuniform, nonsteady conforming least mass energy, has least PPLD widths band quanta mass least height, perimeters least friction forces energy modes phases highest sum.

Globose-conduit universe Sets' genomes are a conforming least mass energy boundary, internal rotations, hydrostatic pressures and friction, making energy modes' phases highest sum.

Generic PAP, PPLD, PP lengths least sum, conforming embodiments, evolve or devolve globose-conduit forms into rounded or entirely round conduit cross-sections or globose spherical or spherical retained mass forms that rotate, mutate, transpose, transfer, and make unique origin universe constituted highest conserving mass energy phases, forms, Sets, hybrids, and domains.

A globose-conduit confines, retains, transports; its lower conduit confines, transports; its mechanics of forms detention highest conserving mass energy phases least confine its transports. Said least confinement figures illustrated or depicted are PP conforming least mass energy forms.

Globose-conduit, mass-energy highest forms drawn analogies with schematic evaluations confirm, infinitesimal perimeter boundaries analyses substantiate nonhomogeneous, nonuniform, and nonsteady mass energy highest conserving universal environmentally important innovations.

Following details enormous extent confirms said GC Sets, forms perimeters coincidence forced ‘functions’, ‘sub-functions’ MEHC, QCMEHC and QCNDMEHC ‘forms equal function’:

Mechanics of forms, FESD forms, Flush Apparatus inventions, principles, methodologies quantum mass nonsteady, nonuniform, nonhomogeneous quintessential, core, natural disposition, globose-conduit conforming least mass-energy classic perimeter forms the following summarize:

A. Microbes' submicroscopic, atomic subatomic to Cosmos makeup as described;

B. Highest mental skill ordinary scale enforced inventions, principles and methodologies:
a. Inflows nonhomogeneous, nonsteady, nonuniform mass-energy stratifies with:
   1. A globose-conduit detention, upper retention least transport-fluid height;
   2. Highest density topside, inside narrowest PPLD widths, conduit breadths, gravity separated nonsteady, nonuniform mass energy into following;
b. Detention one length, globose largest free-surface form steadying nonuniform, nonsteady mass energy with uniform atmospheric, detention pressures to a DCCS.
c. Narrow PPLD widths, forms' breadths confine highest density mass with:
   1. Highest density mass modes of energy at highest elevations;
   2. A confined highest density mass centroid raised by narrow breadths;
   3. Mass-energy rotations, modes of energy losses minimized;
d. Mass-energy entirely inflows into a globose-conduit conduit contained mass;
e. Mass-energy mass inflows are topside PPLD forms surface into highest density fluids:
   1. Separating, tearing, breaking, pushing onward highest density fluids mass;
   2. Heaviest particles that are narrow PPLD widths confined:
      a. With natural fluid mass quintessential, core, disposition forms;
      b. Displaced contained mass, by or with FESD surface forms;
      c. Heavy fluid mass least perimeter least adhesion friction losses:
         1. Least cross-sectional area;
         2. Least friction coefficient;
         3. Inflows mass-energy centroids are below higher density mass centroids for;
         a. Mass-energy, perimeter friction, and adhesion least losses;
         b. Centroids alignment rotations that tend to lift higher density mass;
f. Flush Apparatus are adeptly fitted into globose-conduit forms;
g. Most of steady inflow outflow fluid masses is through a conduit form:
   1. PPLD PP of a DCSS First Sub-outlet have mass highest velocity;
   2. Inflows are entirely through a conduit Inlet;
   3. A DCSS FESD form First Sub-outlet discharges steadier outflows;
   4. Rare, unusual events fluid passes through a DCSS globose form;
h. Most of energy modes losses occur with a lower one-half of lowest conduit:

1. Manipulations of cross-sectional areas forms minimize mass rotations;

2. Upper retention mainly a transport fluid has least or no friction losses;

3. Most energy loss occurs between lowest conduit springing points that extends from under an Inlet to an outlet DCSS to an Exhaust;

4. PPLD forms are at highest elevations in respect to its Inlet End 1;
an End 1 barely higher than a globose-conduit is a safety factor and preferred;

5. Shrunken conforming PPLD are least height and length;

6. PAP least angles with best alignment and symmetry;

7. PP lengths least sum least contained mass least perimeter losses;

8. PP lengths least sum inventions, principles, methods, FESD forms:
a. With algorithm computing up to smallest elements;
b. Entire quanta subdivided mass computed PP lengths;
c. With graphical prototypes scaled measurements;
d. With laboratory testing confirmations;
i. Mechanics of forms mass-energy absolute highest conserving globose-conduit perimeter forms, conforming least quantum mass rotations classic genome Sets constitutes:
   1. Globose, spherical form conforming mass retained mass-energy;
   2. Retained mass-energy least surface perimeter globose, spherical forms;
   3. Least surface perimeter friction, adhesion mass-energy losses;
   4. Higher density mass least retained mass-energy rounded conduit form:
      a. With statistical analysis of high density mass-energy inflows, rate;
      b. With conformance to PPLD width of band and length forms;
      c. Retained mass-energy least surface perimeter conduit forms;
      d. Least surface perimeter friction, adhesion mass-energy losses;
      e. Amalgamated with upper retention low friction fluid losses;
   5. Least PAP angle, PP lengths, sum of, PPLD height and length forms;
j. Universe of Globose-conduit mechanics originated from unique genome form:
   1. Retention genome graphical intellectual, inclusion, exclusion shown:
      a. Illustrates Retention unique genome of globose-conduit forms;
      b. Unique genome form originates universe domains;
   2. Globose-conduits evolve or devolve conforming-conduit forms conforming least masses into/out of globose, spherical mass retention least surface area forms;
   3. Amalgamated globose-conduit fluids rotate, mutate, transpose, transfer to contain, retain, detain and transport highest conserving mass-energy modes made up of mass-energy contain, detained, transferred phases;
   4. Globose conduit forms manipulate cross-sections areas up to four times, raise centroid of high density smaller mass ahead of transport fluid larger mass, and by hydrostatic initially pant-up pressures detain to transport confined high density fluids mass;
      a. Through a conforming least height cross-section under an End 2 undersurface topside of PPLD lowest surface forms highest elevations;
      b. Through a gradual rate devolution transition from globose to rounded to curvilinear globose-conduit conduit forms mass energy perimeters;
      c. Through conduit outlet forms First Sub-outlet with high density mass passed ahead of a much larger globose detention transport fluid mass;
      d. Industrial domain outlet DCSS passing progressively high, low density masses through a First, a Second, and if present, a Third Sub-outlet;
   5. Globose-conduits are classic perimeters alongside globose, spherical forms with parallelism analogous to homogeneous masses round conductors;
      a. A globose-conduit's globose area height vary, from about 5% to about 95% of entire cross-section height, globose breadths manipulated up to orders of magnitude greater than a venting pipe (the first application shown up to three times greater).

Globose-conduit phenomena MEHC unique origin forms evolve, devolve, rotate, mutate, transpose transfer; contain, detain, retain, or transport conforming least mass varied composition.

A forms least height perimeter MEHC a one length free surfaces compact composite least rotated mass phenomena globose-conduit perimeters force the MEHC, the QCNDMEHC classis.

Inventions, principles, methodologies QCNDMEHC self-preserving or conserving modes manipulate GC forms, Sets, and domains enforce MEHC, unique origin Universe forms and Sets.

Quantum masses conforming, PAP, PP, PPLD energy self-preserving compliance to mass energy omnipotent force fields enforce Sets' conforming forms, GC energy conserving Universe.

Gas, air and fluid mass inflows into GC forms outflow through a vented discharging pipe.

Globose-conduit classic cross-section areas, perimeters, and boundaries surface interface forces and mass centroids respective locations computed for least or a minimal quanta fluid mass rotations arise with said ‘flow control’ flow control means' mass and energy highest conserving.

A basin-outlet least Set contains conforming retention mass, Inlet forms inside, a globose form transported detention wherein said Inlet may include fluid mass outside of the basin-outlet.

Continued first application FIG. 1-2, 10-12 versions show conduit Inlet least height that is barely outside of the basin. A conforming and a detained fluid mass make up retention mass; the former precludes venting or backups, the latter moves mass, having conforming mass fluids' free surface essential elevations that pass particles' largest size through outlet forms' First Sub-outlet.

Inlet inflows provide potential, kinetic mass energy modes sum paths-of-passage, PP. An Inlet End 2 least separations from a basin-outlet PPLD form barely exceeds largest particle sizes.

The globose End 2 or globose-inverse First End undersurfaces lowest points elevation are globose-conduit drain trap quanta mass lower conduit form springing-points at highest elevation.

Said transition region cross-sections' areas constitute conduit to globose springing points. Cross-sections fluid structure interface perimeters are two, upright axis symmetrical, and smooth curvilinear lines that connect lower conduit, and upper globose cross-section perimeter springing points ranging from a rounded cross-section to a globose area enforced springing-points breadths a multi order magnitude wider than their counterparts, said lower conduit forms springing points.

Globose-conduit FESD forms within said transition region constitute permanent retention conduit forms, wherein permanent retention mass-volume precludes venting of gases or backups.

Transition region fluid mass least rotations viscosity friction, breadths forced least height, computed cross-section area forms having highest conserving modes of energy force listed FESD forms seamless globose-conduit manipulation classic globose form into its classic conduit forms.

Generic claims PPLD forms constitute a part or a counterpart that makes up FESD forms.

For presenting, describing, and depicting purposes, said constituted free falling fluid mass is taken generally for the entire End 1 cross-sectional area having a uniform hydrostatic pressure;

Globose-conduit conduit springing points constitute an elevation no higher then a conduit entire height; rounded conduit forms may make a Trough, a Trough inside a Trough or Trough(s) inside Trough(s) curvilinear forms, a Ridge, a Partition FESD lowest surface forms having sides' complete complement, constituted upright axis, symmetrical, curvilinear, transition region forms.

Especially Trough(s), Ridge(s) including upright, Partition(s), indented Ridges as turning veins Troughs, along with End 2, outlet First End, basin lower surfaces, and counterpart surfaces including Dimensions 44 counterparts spacings among listed FESD forms, for PAP upright plane symmetrical fluid mass radial outflows, basin-outlet inflows. Trades and crafts fabrication scales to arts sciences microscopic near infinitesimal mass units FESD forms globose-conduit complete engagement of retained, detained, and transported fluid masses constitute a range of FESD forms complete complement; first or foremost globose-conduit forms constituted open channel conduit forms that contain, retain, detain and transport fluid mass or energy or both highest conservation, which includes high hydrostatic pressures rare events, hundred year, or once in a lifetime storms. Engineering disciplines Sets, forms, and FESD surfaces constitute exact to finite approximations.

In tandem with a PPLD form slope rise caused form side surface slopes increase forcing a cross-section area into narrower breadths that with height narrow transition region breadths force upper retention globose form breadths curvilinear or elliptical upright major axis form; algorithm computing methodology carried out to highest computational accuracies cross-sectional areas for perimeter fluid mass forms for least or no entire fluid mass rotations in PAP upright plane toward highest conserving of mass energy modes; a PAP upright plane horizontal orientation in space of forms constitutes absolute symmetry through DCSS springing points elevations forces least or no detrimental rotations retained, detained, said laminar ‘flow control means’ fluids' mass transport.

Globose forms are gravitational fields' energy modes classical containments; spherical or globose mass-energy highest modes genome classic forms retain mass units algorithm computing enforced least resistance paths-of-passage, PP, lengths least sum thus retain, detain, and transport nonsteady, nonhomogeneous, and nonuniform mass. Conduit forms must exist to transfer energy modes. Generic claims PAP, PPLD, PP with PP lengths least sum, defines confined mass energy modes self-conservation transfers with mass units least resistance PP that force basin-outlet classic globose-conduit forms conforming embodiments, Sets. The PP lengths least sum computes open channel fluids mass centroid locations and least height classic forms, for retained and transported fluid mass, with least or no rotations engineering designs and infinitesimal elements for scientific purposes designs. Practical construction purposes or crafts finest tolerances quantum mass units, conforming least mass, lowest surfaces, slopes, least height, and length force supra constructions.

Each breadth approximated width above PPLD width of band highest elevation makes for exact, infinitesimal, or finite increments a stair step like change. A step constitutes summation of mass units' widths that makes least resistance paths of least elevations derived by said PP lengths least sum. Forgoing statistically compiles fluid mass properties, especially the specific gravity of particles, into curvilinear forms computing methodology for fluid mass influx of units constitutes each mass unit least resistance path that algorithm amalgamates into entire mass PP lengths least sum. Units of mass PP lengths least sum makes lower cross-sections a viable conduit area with a perimeter form. By definition, inverts of globose-conduit forms, PPLD width of band horizontal segments, constitute highest elevations. A horizontal chord, breadths at respective elevations, by PP lengths least sum computing are a least transfer of kinetic to potential mode of energy highest conservation. Rising PPLD widths with forms length constitutes potential energy increase, while descending PPLD cross-sections respective breadths, conduit horizontal chords, lower elevations with length are potential to kinetic mode transfers mass-energy highest conservation, statistically compiled fluid mass and energy composition. Foregoing methodology for cross-sectional areas, perimeter computed forms enforces fluid mass least rotations in a PAP plane of symmetry, which requires exact areas and perimeter forms with length. With no PAP upright plane rotations, units of mass moves are confined by surrounding units of mass at respective elevations or move down, up governed by mass units' specific gravity. In chords, breadths, horizontal planes units of mass are confined by surrounding mass units eventually confined cross-sectional area forms perimeter which implements least or no rotations in PAP upright plane of symmetry, least or no rotations in horizontal planes for no fluid mass energy influx changes. Said changes require at least a change in retention free surface elevations and that also require areas, perimeter change enforced by said computing for highest probability statistical fluid mass influx/outflow balance. This constitutes a continual slight narrowing of conduit forms lengthwise breadths with narrowing transition region breadths toward a DCSS or next Inlet fluid mass influx. Said narrowing constitutes crafts, trades simplified, immaterial change for fabrication. Upper globose and transition region cross-sections computed similarly enforce complete complement forms that constitute cross-section classic area forced classic perimeters, GC nonhomogeneous, nonuniform, nonsteady fluid mass FESD forms.

A PPLD constitutes globose-conduit unit of mass lowest path of least resistance for said globose form conforming least fluid mass and height conduit form highest elevations fluid mass highest conservation energy conversion from kinetic to potential mode. Gravity enforces higher density particles toward a path-of-passage-of-least-energy-demand, PPLD, with lighter particles moved to lower density uniform mass higher elevations. Confined by narrowing of a globose or a conduit ascending spout, heaviest particles are squeezed into a PPLD narrowest width, highest slope single largest sphere that just passes through said spout rounded lowest surface area cross-section, which is said PP lengths least sum FESD forms. Surrounded by highest specific gravity transport fluid mass of highest viscosity said largest sphere is pushed in back pulled by transport fluid drag and allowed to rotate in PPLD direction toward summit without quanta mass rotations. Sub-outlets, especially First Sub-outlets, detention fluid free surfaces essential elevation height is said largest sphere passing through Sets constituted submerged height fluids elevation at summit.

An End 2 undersurface is located at about one half of upper retention depth for fluids free fall causes inflows mass centroid forced into a basin retention lowest ¼ depth; a viscosity friction and adhesion ignored, water velocities at depths below a fluid free surface equals to a square root of twice gravity acceleration times a fluid depth at an elevation, in a velocity direction of interest.

High density fluid mass inflows and outflows are entirely through globose-conduit cross-sections lower conduit form. Globose-inverse First End located about one half of basin retention depth is entirely consistent with said higher density mass inflows, outflows through said conduit.

Intentional fluid mass retention outflows are mostly through a globose-conduit composite lower small conduit cross-sectional area, ahead of longer paths-of-passage larger detention mass.

Unusual, out-of-ordinary fluid mass outflows pass through globose cross-sectional forms.

Highest density mass centroid shortest height to the summit conserves most mass-energy. Globose-conduit shallowest PPLD forms retention has highest density mass most raised centroid.

Conforming least mass retention, globose-conduit least height and least rotations are least potential, kinetic energy modes magnitude exchanges. Kinetic, potential energy mode exchanges have rotational friction and viscosity losses; compared to round or similar piping globose-conduit Sets or forms complete complement amalgamated conforming least mass least retention and least rotations highest conserving multi raise retention modes mass energy centroids with PPLD forms to highest elevations. Less is more. More is less; less energy transferred conserves mass energy, either one or both. Least rotations of conforming least mass centroids at highest elevation a least height from fluids free surface set at highest elevations have Sets' forms highest conserving mass energy modes. Narrowest conduit breadths force highest density mass higher into a cross-section entire form, raising its mass, areas, and perimeter centroids to highest elevation, matched by said globose breaths, PPLD forms, fluid mass highest elevations or energy modes highest conserving.

Conforming least mass fluids least rotations constitute least rotational frictional, viscosity loss potential, kinetic energy exchanges highest elevation, mass and energy highest conservation. Globose-conduit conforming globose detention at highest elevations least height, largest breadths and lengths raise mass energy centroids elevation eight times. Once for each horizontal direction that is in unison with the other three, and conforming globose mass retention at rest repeated four times for with fluid free surface elevations as the governing reference and kinetic, potential mode exchanges least energy demand for PPLD forms at highest elevations. As a system amalgamated globose-conduits raise fluid mass centroids three times; once in each globose conduit form raised mass centroids, and once for highest PPLD elevations. Globose-conduit sewer lines, detention or basin-outlets conforming least mass retention fluid mass centroids and rotations are least distance from fluid free surface, which makes for highest conserving mass energy modes steady, balanced exchanges forcing least mass energy losses into the Earth's ecosystems mass and energy balance.

Insignificant or no energy loss detained larger mass constitutes a mass energy conserving. Globose forms detain transport fluid mass that counterpart conduit uses to transport mass energy.

Pent up initial hydrostatic pressures enforce discharge of nonhomogeneous heaviest mass particles; pent up initial hydrostatic pressures enforce fluid free surface essential elevations, only.

A globose-conduit conduit outlet, First Sub-outlet, DCSS greatly narrowed breadths with much larger globose breadths adeptly manipulate paths-of-passage pent up hydrostatic pressures.

Detention large globose breadths and lengths force nonsteady fluid flow free surface least changes from its highest elevations with uniform hydrostatic pressures steady mass energy flows.

Listed and also referred to as specific FESD forms parts are FESD globose-conduit forms having specific purpose to prevent or restrict fluid mass rotations; highest conservation of energy for a unit of mass that passes a summit, exact transfers of kinetic to potential energy require mass energy path-of-passage-of-least-demand, PPLD; for near frictionless transport fluid mass, critical path lengths are those against gravity direction as then mass energy required contains 32.2 (ft/sec. squared) multiple; smallest quanta mass enforces least mass that requires said multiple in highest conservation of energy; such mass must preclude venting or backups in universal ubiquitous use. Conforming least mass contained by most compact, least volume spherical modified to a globose form units of mass constitute PP lengths least height forms. Nonhomogeneous fluid mass paths-of-passage, PP, lengths least sum contains horizontal components, also. PP lengths strings along conduit inverts fluid mass units energy paths-of-passage-of-least-demand (most energy required), PPLD, are common paths. Said PPLD and a retention free surface respectively envelop quantum masses least and highest potential energy paths-of-passage, PP, in superimposed quantum masses kinetic energy forcing said four ‘functions’ enforced twenty-eight ‘sub-functions’ forced MEHC.

Nonhomogeneous, nonsteady, nonuniform conforming least mass high conserving energy modes 28 ‘sub-functions’ quanta mass least rotations complete complement, retention PP lengths least sum round, rounded, curvilinear genomes enforce following globose-conduit transpositions:
Round or rounded areas transposed into a conduit, an intermediate (transition), having a globose form area of retained fluid mass higher centroids' potential and kinetic modes of energy;
Transposing round, rounded conduit cross-sections to fluid masses essential height as in Sub-outlets for ‘functions/sub-functions’ fluid mass least rotations curvilinear least height forms;
Said ‘functions’, least rotations curvilinear fluid mass forms raised following centroids:
Fluid mass perimeter said ‘functions’ FESD structure interface curvilinear surface, thus:
Viscosity, cohesion, adhesion, and solids surfaces said friction centroid raised locations;
‘Functions/sub-functions’ boundary layer perimeter forces centroid higher elevation, as
Transposed centroids, forces constitute one common centroid force with least rotations, for fluid quanta varied compositions respective four ‘functions/sub-functions’ least height forms;
Breadths, breach, quanta fluids mass least height FESD forms enforcing least rotations;
Contained, retained, detained, transported fluids, mass energy phases forms least PPLD width of band lower conduit perimeter quintessential, core, self-conservation or self-preservation fluids mass least height and enforced four ‘functions/sub-functions’ mass centroid highest forms.

Thus, a classic globose upper retention and a transition region forms with a classic lower conduit form force fluid free surfaces elevation and mass energy modes transfer conduit forms at or near highest elevations. A classic globose lower form amalgamates its lowest surfaces shrunk PPLD form at highest elevations which conserves most of fluid energy transfer to potential mode in transporting highest density fluid enforced by classic conduit to globose form transition region mass. Said retained fluid mass finite to infinitesimal PP lengths least sum inherently forces self-conserved preserved energy highest conservation, forced paths of least resistance constitute open channel transition region globose-conduit fluid mass forms; for globose-conduit transition region computing of forms, where globose-conduit conduit basin-outlet and Inlet fluid mass forms, may constitute an Inlet contained fluid mass outside a basin-outlet, especially for fluids mass and Inlet forms that preclude suction or venting; transition region forms force conserved fluid mass energy forcing PPLD forms highest elevations and constant continual fluids free surfaces least deviation from a conduit form fluid mass free surface essential height; said PPLD forms constitute a lowest surface rounded forms, unless fluid mass highest density highly uniform inflows force PP lengths least sum computes to a round form. Rounded lowest surface forms constitute highest elevations for a statistical continual inflow rate that constitutes fluid mass detention wherein said inflows of a nonhomogeneous, nonsteady, nonuniform fluid forces lowest surfaces, PPLD forms. Statistical standard deviations higher inflow rates rounded forms open into PP lengths least sum wide forms for low slopes side surfaces or parabolic horizontal major axis highest elevation forms and PPLD cross-sections unless breadth or breach PP lengths least sum forces lower PPLD generated forms.

Shrunk PPLD forms rounded, elliptical upright major axis, or curvilinear globose-conduit said ‘functions/sub-functions’ force curvilinear transition region, PAP angles less than 180°, with PP lengths least sum complete complement symmetrical forms force GC Universe fundamentals:
PAP two points, as “surveyor stakes” that space align fluid mass energy as conduit and globose forms springing points in transition region lower, upper limits for said ‘functions’ forms;
“Self-designed” conforming PP lengths with least sum with confirming least fluid mass energy least resistance paths forced fluid mass perimeter surfaces that are globose-conduit forms;
Said PP paths, as “self-designed” quantum fluid mass forced paths that use least energy;
Said PPLD forms, as lowest surfaces “self-designed primary paths” at highest elevation;
Classic retention genome, as its contained retained energy genome ‘functions’ “parent”;
Quantum masses paths gravity force least resistance ‘functions’ PP mass energy modes quintessential highest conserving, self-preservation with natural disposition forced visible forms;
Most self-conserved self-preserved fluid mass energy self-generates least magnitude of ‘functions’ energy modes full transfer most shrunk PPLD forms globose-conduit compact forms;
Said “parent” near spherical classic conforming retention amalgamates its outlet conduit to make up highest conserving fluid mass energy globose-conduits ‘functions/sub-functions Sets;
Said infinitesimal units of mass PAP symmetric orderly outflows, inflows into or out of classic retention genome form, as “old”, “new” said ‘functions’ fluids quantum mass and energy;
Said quantum fluid mass energy, as “participants” in its “parent” mass energy Universe;
Said quantum masses laminar flows, as said ‘functions’ forced fluid mass energy forms;
Quantum mass PP lengths least sum forced PAP least angle, symmetrical unique forms Set, ‘functions’ forced a discharge-cross-section-surface, DCSS, and springing points elevations;
Globose-conduit forms within “genus” enforce ‘functions’ conforming “citizens”, Sets, PP lengths least sum enforced fluid mass energy highest conserving that constitutes its Universe;
Lower globose basin forms amalgamate into a rounded or a curvilinear globose-conduit with a First End, the outlet Sub-outlets, FESD, and DCSS FESD said ‘functions’ enforced forms;
Paths-of-passage lengths least sum enforces globose-conduit, PPLD, FESD conforming least quantum mass retention least rotations PAP upright plane said ‘functions’ symmetric forms;
Classic genomes forms Set conforming retention least mass least height mass modes of energy highest conserving force ‘functions/sub-functions’ PP lengths (least resistance) least sum;
Quantum units of mass PP least sum amalgamates quantum mass paths into least height shallowest retained mass genome forms, said ‘functions’ mass energy highest conserving modes;
Genome Sets make for retained fluids least height and conforming least mass potential, kinetic energy modes quantum mass units least sum amalgamated into fluid mass and forms Sets;
Said PP least sum lengths for a form enforce said ‘functions/sub-functions’ conforming or a genome form, genome forms complete complement conforming embodiments genome Sets.
Embodiment forms ‘functions’ PP least sum lengths force nonhomogeneous fluid mass conforming permanent retention kinetic potential energy forced modes passing heaviest particles.
Conforming least mass retentions, highest density heaviest particles PPLD entire length least height form, height and energy modes inflows transported through PP quantum masses least rotations, mass energy ‘functions/sub-functions’ forced QCNDMEHC conforming embodiments.
PPLD units of mass paths to summit topside PPLD width of band surface forms, forced through least rise slopes force said ‘functions’ quantum PP lengths least sum narrowest breadths;
Outlet, DCSS FESD forms PP lengths least sum large breadth upper area cross-sections higher than globose forms springing points elevation forced fluid free surface rise to least heights constitute conforming least retention fluid mass kinetic energy transfer to potential energy mode;
Further fluid free surface rise than required by the ‘functions’ wastes mass and energy;
A greatest particle height said ‘functions’ forced a free-fluid surface detention essential elevation forces PP lengths least sum highest elevations with a First Sub-outlet form least height;
Essential detention free-surfaces elevation forces no energy-demand transfers of kinetic to potential energy, ‘functions/sub-functions’ forced continual mass energy highest conservation;
Open channel, globose-conduit forms nonhomogeneous fluid and solids mixtures mass energy self-preservation, ‘functions’ containment, detainment, and transport are within one form;
Globose-conduit forms contain Inlet retention and forms, that altogether inside a basin-outlet constitute globose-conduit ‘functions’ conforming mass highest energy least forms or Sets;
Quantum-mass PP forced complete complement forces said Sets least resistance forms.

Generic globose-conduit claims: PAP, path-angle-of-passage; PPLD, path-of-passage-of-least-energy-demand; PP, paths-of-passage with a least sum constitute forced fluid mass globose-conduit conforming embodiments self generated Sets. Globose ‘functions’ universe, conforming embodiments, Sets genus, is generic claim classic Sets conservation of mass and energy of fluids and solids mixtures that originate from said classic unique retention form, genome. PP, paths-of-passage lengths generic claim to algorithm forced least sum is energy balance for entire retention mass upright components quantum mass gravity acceleration multiples, which through reiterative process force said ‘functions’ fluid mass, structures interface forms and Sets, genomes. Forgoing forces at least two points align forms to a linear PAP least angle symmetric alignment. Genomes best construction of surface forms narrows the first application globose conduit constructions and forms tolerances to commercial, industrial forms herein said complete complement of completely matched forms of Sets. Art Sciences fields', nuclei or subatomic, microscopic or submicroscopic forms complete complement, quintessential globose-conduits potential, kinetic near infinitesimal quantum mass transfers, energy mode forced perfection beyond human creative skill to duplicate.

Classical best known highest packed carriers of mass energy forms are electrons, protons, and neutrons, with round shapes, properties that continue into sub-atomic ranges. A round cross-section of an electrical wire, a water pipe is taken as best carrier of energy. Both need a transport forcing energy. The first transports relatively no mass high-energy electrons, the latter transports mass modes of energy, which require a mass energy source; gravity influences insignificantly the former but forces the latter, especially nonhomogeneous, nonsteady, nonuniform mass. Globose-conduit nonhomogeneous mass energy, cross-section area and perimeter centroids continually, at least infinitesimal, at odds to gravitational direction alignment extends into quantum mass atomic subatomic or microbes structure and substructure forms. Electrical wires, pure-water pipes under voltage, hydrostatic respective pressures are round cross-section perimeter classic genome forms.

Globose-conduit said ‘functions’ conforming Sets, classic universe forms, contain, retain, detain, transfer mass energy and transpose globose-conduit, open channel, nonhomogeneous into homogeneous mass energy entirely round forms and vise versa to MEHC globose-conduit forms.

Microbes microscopic or submicroscopic thin disk or short rod line like, single form cells contain, retain, transport, or detain a submicroscopic ecosystem inflow outflow masses constitute ‘functions/sub-functions’ Inlet basin-outlet enforced said globose-conduits basic types least Sets.

Solar system globose, spherical bodies align in a detention mode enforced, extremely thin disk like arrangement highest conservation of mass energy mode. Sun's radiation, solar system's gravitational pull maintains Cosmos mass-energy equilibrium. Thin disk alignments force highly precise equilibrium balance. The Sun with entire Solar System is highest modes of energy basin, forced equilibrium with Milky Way Galaxy mass energy. A Milky Way Galaxy body pulled into the Solar System with its gravity controlled space makes an Inlet form and upon exiting the Solar System an outlet form constituting the Solar System part of mass gravity forced globose-conduit.

Based on the laws that mass cannot be created or destroyed, the best a light energy can do in trying to escape black holes is making a boundary along with entire Cosmos gravitational field ending at its starting point. As Cosmos is visible only when energy waves hit a solid mass we do not see energy boundaries. Solid bodies' mass-energy orbits are enforced by gravitational forces in a way electrons are ‘functions’ forced in their orbits by invisible electric charges energy fields.

A smooth surface on submicroscopic scale does not exist either, as atoms, nuclei made up of round or rounded forms cannot form it and cannot constitute a linear, vertical path, which thus does not exist for atomic, submicroscopic, cosmic or intermediate range infinitesimal accuracies.

Conforming embodiments' conforming least mass, height, hydrostatic pressures, surfaces area, quantum mass rotations PP lengths least sum, thus frictional losses enforce for mass energy forcing highest self-conserving globose-conduit universe forced FESD forms, Sets, and domains. Globose-conduit forms forgoing properties are mass-energy highest conservation from infinite to infinitesimal ranges constitute a highest “best mode of operation” over existing and prior patents. Said properties are founded in the known universally accepted ‘functions’, not on an appearance.

The Solar System, Milky Way Galaxy contains, retains, detains or transports for a highest conservation of forced celestial bodies energy modes; globose-conduit forms mass energy modes phases' highest conserving universe with microbes submicroscopic, atomic subatomic to Cosmos forces globose-conduits forms that force the Milky Way Galaxy enforcing it as its miniscule part.

Clearly celestial bodies travel forced paths for least resistance PP for mass-energy highest conservation from Cosmos to Milky Way Galaxy, to Solar System, to Earth, with each body path length accounting for mass energy losses within its cosmos mass energy equilibrium; a stationary body has lost its energy modes to space except for its gravity which burdens it in tandem with the Cosmos gravity and rotation thus only to contract unless it can overcome the forced compression with escape paths through a perimeter conforming to Cosmos' gravity, mass, and energy balance.

The Cosmos, Milky Way, Solar System bodies enforce mass-energy least energy demand PP least length that is PP lengths least sum for a Solar System, Milky Way, Cosmos mass energy quintessential highest self-conserving, self-preserving. Around celestial bodies and nuclei forced respective gravity and electrons energy fields are invisible energy natural disposition forced mass least dissipated energy as least frictional losses boundaries on scale beyond human skill to create.

Highest density mass transport least separation from detention fluid mass centroid require less transport fluid mass and its energy; two, three dimensional FESD forms for globose conduits much wider breadths larger areas compared to entirely round or otherwise similar conduits' form enforce transport fluid mass with least or shallowest detention, retention mass height that is set at highest elevations for respective Sets fluid mass inflows, outflows. For continually raised higher density fluid centroids with entire fluid mass toward a DCSS least or no rotations in PAP upright plane constitutes highest mass and energy conserving, especially for transport fluid mass variable inflows density variations the enforced ‘functions/sub-functions’ forced mass energy conserving.

Frictionless fluids least rotations consume least to insignificant amounts of energy modes. Globose-conduits systemic highest self-conserving energy modes retain, detain, and transport for the ‘functions/sub-functions’ least manipulated mass energy forms areas and perimeter centroids.

Two PAP points align upright plane symmetric globose-conduit, flexible to rigid least Set rotated forms to a finite or infinitesimal PAP angles accuracy analogous to said first application's “positioning members” said forms enforced up to near infinitesimal forced “flow control means”.

Least resistance PP said ‘functions’ forced globose-conduits cross-section areas' breadths fluids free surface least essential elevation height, deviations and PPLD forms height separations.

Sets contain retain detain, and transport nonuniform, nonhomogeneous, nonsteady classic area, perimeter conforming least mass, height, fluid mass forced least or no detrimental rotations;

Globose-conduit quintessential, fundamental and core evolutionary, natural, highest self-conserving self-preserving superiorities self-generated mass energy forms forcing are as follows:

1. The globose-conduit said ‘functions’ preferentially distribute mass and energy modes, transport highest density mass inflows at highest elevation PP PPLD forms, in respect to summit;

2. Globose-conduit forms force higher density mass transported ahead of transport fluids mass in at least three instances: a) under an End 2, b) a basin into an outlet, and c) into a summit;

a. Under globose End 2, conforming mass least conduit height, for a lowest PPLD form at highest elevation, with separations that need not exceed much inflows mass largest size particles;

b. With narrow breadths conduit transported heaviest mass raised centroid forced in front, ahead of detention mass ahead of a First Sub-outlet by conforming least quantum mass rotations;

c. Passed summit with transport fluid greater drop into forcing first a higher density fluid mass similar to fluid mass Inlet inflows, accentuated by Industrial Sets higher density transported fluid masses passing through a configured outlet, a First, than a higher Second, Sub-outlet forms;

3. Globose detention masses tandem build-up behind a raised transported mass centroid;

4. Transported, transport fluids in tandem raised then lowered respective mass centroids;

5. Forced quite smaller high density transported mass in front of larger transport masses;

6. Compact retention, detention mass highest centroids in respect to a summit elevation;

7. Mass highest centroids a least distance, rotations from a respective summit, constitute a viscosity, boundary layer friction conforming retention least mass modes of energy least losses;

8. A narrow conduit breadth at summit forces up globose retentions detention pressure;

9. A globose-conduit said four ‘functions’ one-form least energy modes demand raised detention pressure heaviest mass centroid retains detains or transfers mass energy highest modes,

Kinetic, potential is useful energy mode functions; least mass rotation is conserving each,

Conserving of each is because energy modes functions are least energy demand transfers,

Quantum mass-energy inflows enforce said four ‘functions’ modes equal sum exchanges;

10. A conforming globose detention mass pant up pressures separate, dilute or dissolve a transported mass in its path with raised centroid, least apart from transport mass centroid;

11. Open channel forms adeptly force gravitational force mass energy modes exchanges;

12. Globose-conduit four ‘functions’ nonhomogeneous, nonuniform, and nonsteady mass energy fluid modes cross-section areas and perimeter centroids force mass energy highest modes,

13. Generic PAP, PPLD, PP lengths sum, conforming embodiments, evolve, and devolve globose-conduit forms into round or entirely rounded conduit for globose spherical and spherical retained mass forms that rotate, mutate, transpose, transfer and force unique origin universe mass highest conserving energy phases forced four ‘functions/sub-functions’ forms, Sets and domains;

14. Globose open channel basin-outlet spouts manipulate and adeptly amalgamate mass energy modes one-directional linear or circumferential globose or circumferential cross-section areas retention, detention said ‘functions’ strains that otherwise requires three-elbow assemblies;

Globose, circumferential are highest self-preserving mass energy two strains of forms; a one-directional PAP angles less than 180 degrees alignment is one within cosmos' gravity fields;

15. Self-conserved said four ‘functions’ energy process, among naturally evolved or man made forms, constitute classic Set chains globose-conduits natural, quintessential dominant links.

16. Fluid mass energy composition and forms physical properties highest self-conserving globose-conduit forms evolve into their ‘functions’ creation classical round forms and vice versa;

17. Classic globose-conduit detention PP lengths least sum generated height mass energy absolutely dilutes, tears up, disintegrates, moves or transports high specific gravity masses; these processes conserve useful energy modes mass energy required to transport heaviest density mass;

Air as a fluid mass is controlled into out of open channel forms as an enclosed boundary;

18. Basin-outlets least Set includes Inlet forms inside, a conforming retention, a globose-conduit four ‘functions’ transported detention, and an Inlet fluids mass outside of its basin-outlet;

a. Conserving mass energy is inside mass energy modes enclosing boundaries sets; mass energy modes stated inventions, principles, and methodologies requires respective boundary said ‘functions’ physical, nuclear molecular, or living cells chemical fluids mass energy modes forms;

b. Contained modes mass energy forms require at least one ‘function’ enforced boundary;

c. Globose-conduit open channel forms transport of nonhomogeneous mass energy fluids and solid particles is comparable to round pipes, electrical wires transport of homogeneous mass, energy, and atomic subatomic round forms ‘functions/sub-functions’ enforcing mass and energy;

d. Paths-of-passage lengths least sum enforces nonhomogeneous, nonsteady, nonuniform, mass-energy units' viscosity, adhesion, cohesion and fluid structure interface perimeter boundary layers adhesion, friction into globose-conduit ‘functions’, mass-energy highest conserving forms;

e. Classic globose-conduit genome forms ‘functions’ enforce classic perimeter form Sets; Globose-conduit ‘functions’, principles, methodologies are homogeneous fluids readily enforced; Partial suctions of globose-conduit, smaller than ubiquitous permanent retention, said ‘functions’ enforce highly conserved fluid mass and energy safest quickest upper retention volume recovery.

f. A globose-conduit, basin-outlet, PPLD band tandem rise with narrower, lower conduit cross-sections breadths completely complimented by transitions regions least height with globose wide breadths the ‘functions/sub-functions’ enforced fluids essential height or greater elevations.

g. Mechanics of forms force fluids mass energy modes highest sum at highest elevations;

h. A retained fluid mass makes a lower retention, an upper retention and a detention form. An upper retention at rest makes a free surface. A detention enforces a free surface that is higher than said four ‘functions and twenty-eight ‘sub-functions’ fluids mass energy free surface at rest;

i. Globose-conduit PP lengths least sum, fluids mass energy forms and Sets force highest statistical-probability for nonhomogeneous, nonsteady, and nonuniform retention, detention least PAP angle quantum masses least rotations; form PP lengths least sum classic perimeters contain, retain, detain, and transport globose-conduits fluid mass energy which enforce FESD forms, also.

Globose-conduit Universe FESD forms, said PP lengths least sum surfaces, enforce fluids quantum masses least rotations of in three orthogonal planes, especially prominent forms the four ‘functions’ force 28 ‘sub-functions’: Troughs, Ridges, Partitions, globose End 2, globose-inverse First End forms and undersurfaces, doming Cavities, Bridging-Wall, Fin and DCSS FESD forms.

Troughs raise lowest surface to globose form sides, wherein Ridge, Partition FESD forms raise PPLD lowest surfaces to two PPLD higher elevation forms. Troughs, Ridges and Partitions force globose conduit forms integral part concepts that raise highest density mass centroid twice; once, as a part of globose-conduit forms lowest surfaces raised to highest elevations; then, with a presence of said forms forces least fluid masses least height narrower breadth two cross-sectional areas to raise again nonhomogeneous higher density mass centroid; narrow PPLD forms force an lowest surfaces sooner rise narrower breadths and lowest, lower surfaces faster rise FESD forms;

Upright, angled to near upright, angled, industrial, low angled, Inline, inverse, and hybrid globose-conduit forms universe force Sets/forms, hybrids, migrations and mutations GC universe domains, genomes, and classic perimeter Sets, inventions, methodology, principles and concepts;

Fluids mass energy, finest elements algorithm constituted PP lengths least sum perimeter boundaries reflect sciences, academia, infinitesimally exact fluid mass energy perimeters. Plugs, Caps/Portals, and nozzles are replaceable by continually streamlined surfaces; nozzles, especially high inside Inlets are tolerated, as fluid free surfaces at this elevation are at or above the detained fluid mass essential elevation. One-directional PP sum lengths force Sidelong-Sets. However, a Sidelong-offset to an Anti-sidelong Set forces a near upright Inlet closer to DCSS forms. The PP PAP aligned forms save mass-energy; Trough, Ridge, Trough-Ridge, Partition, or Trough-Ridge-Partition FESD forms manipulate to remove excessive mass-energy PP bundles; the twenty-eight ‘sub-functions’ of said four ‘sub-functions’ enforced FESD forms conserve fluid mass-energy by least quantum masses, rotations, and PP lengths sum, any one, and any combination of said three.

The First application specifies gravitational field Sets or forms that contain, retain, detain, or transport mass energy modes; the continuations and this application continue forms' processes forcing fluids mass and energy conservation laws conforming ‘functions’ energy-modes transfers including boundary perimeter energy losses that force forms; no maximum/minimum ‘functions’ boundary conditions restrict generic claims PP PAP, PPLD, conforming embodiments, other than universal mass energy conservation laws which allow various conditions and various conforming boundaries to define mass energy modes phases conserving conforming embodiment forms, Sets, and domains. The first application first paragraph embodies Sets' universe without an exception. Said Sets mass energy modes unrestricted universe enforces globose-conduit one space Universe. Globose-conduit perimeter forms force imposed-boundary conditions for quantified mass-energy highest self-conservation self-preservation graphical of visual illustration of useful and contained quintessential mass energy phases' said four ‘functions’ twenty-eight ‘sub-functions’ perimeters.

By ecosystem universally most friendly boundary requirements, entirely releases removes artificial unnatural boundary conditions quantum mass PP quanta mass constitute entire universe, cosmos contained, retained, detained, and transported phases of mass energy gravitational energy force. Omnipotent potent forces contained one-mass energy forms constituted globose-spherical, spherical perimeters gravitational field of same forms intellectual boundary surface visualization encloses gravitational force field; orbiting mass-energy modes-phases detained by an omnipotent gravitational mass-energy constitutes potential conduit forms. Analogous parallelisms on atomic scale force nuclei mass energy contained spherical form, with orbiting electrons forced perimeter forms that allow inflow outflow electrons, as an omnipotent atoms mass energy forced detention.

On microscopic, submicroscopic scale mass energy inflows, outflows force a single cell's an inlet, an outlet with, or in a most primitive organism globose or cylindroid detention form cell membranes, ‘functions’ conforming boundary perimeters; partitioned mass-energy conservations subdivide into globose-conduit cells; accepted mass-energy mode omnipresent parallelisms force GC forms, said Laws of Mass and Energy Conservation ‘functions’, twenty-eight ‘sub-functions’ nonhomogeneous, nonuniform, nonsteady mass-energy phases omnipresent perimeter GC forms.

Globose-conduit classic forms contain, detain, and transport nonhomogeneous fluid much analogous to subatomic, atomic, microscopic, submicroscopic; high pressure water pipes, electric wire classic forms that contain, detain, deliver ‘functions/sub-functions’ perimeters mass-energy.

Mass-energy highest conserving path between two points is a straight-line path that traces a circumferential path from its point of origin on rotating mass; a linear or a circumferential PAP each forces mass-energy most conserving quintessential, core, natural disposition paths, and each with perimeter boundary respective conforming conditions. A linear or a circumferential PAP of equal boundary conditions, PP lengths least sum, with equal quantum mass said ‘functions’ equal energy have an equal core, quintessential, perimeter forms and vice versa wherein least and equal is not necessarily exact. Globose-conduit or globose-circumferential Universe domain Sets' PAP angle paths enforce a finite linear increment in upright plane, with counterpart upright orthogonal plane containing quintessential core natural disposition mass energy highest preserving perimeter image; at best its statistical approximations of exact forms are of perfections beyond human skill.

As with other energy modes, the globose-conduit perimeter forms Universe extends from microbes' submicroscopic, atomic subatomic to a cosmos make-up and vice versa. As most self-conserving mass energy modes exchanges quintessential, core, natural disposition form, globose-conduit forms classic perimeters alongside spherical globose forms enforce parallelism analogies to homogeneous mass energy round conductors. As said ‘functions’ forced boundary conditions, mass energy quintessential, core, natural disposition self-conserving self-preserving results in the globose-conduit perimeter forms. Unless globose-conduit boundary perimeter condition, laminar flows mass-energy perimeter is maintained, a globose-conduit the ‘functions and sub-functions’ mass energy, quintessential, core, natural-disposition perimeters readily dissipate into Universe.

Globose-conduit Sets' spouts lower surfaces force fluid mass-energy one-transformation half-mode cycle, kinetic to potential energy, said ‘functions/sub-functions’ highest conservation, said PPLD and FESD least height and length forms much shorter than are those of ubiquitous art. A PPLD band form enforces a conduit perimeter for containment of mass-energy modes, or mass energy forcing dissipates into Universe ecosystem natural-disposition boundary perimeter forms.

A Nozzle FESD forms said ‘functions’ can constitute a part of End 2 undersurface forms.

Spherical globose highest energy modes genome classic forms retain quantum mass units ‘functions/sub-functions’ enforce least resistance paths or the paths-of-passage lengths least sum.

A PPLD width midpoint a globose End 2, a globose-inverse First End undersurfaces one point align tangentially a forms Set has a PAP direction horizontal orientation, upright symmetry plane, and a basin-outlet rotation through said PAP angle in respect to the gravitational direction.

Energy transfers cycle quantum masses potential and kinetic energy modes; a PPLD form least height, width and length force ‘functions’ PP least energy demand energy-modes' transfers.

Potential to kinetic energy mode quantum mass transfers constitute units of mass PP three components length; quantum mass units energy upright direction contain the gravity acceleration multiple for the ‘functions’ quantum mass kinetic and potential energy sum, said PP lengths sum.

A fluid mass volume form with a center of mass located at a highest elevation or closer to DCSS forms constitutes conserved conforming mass energy or ‘functions’ PP lengths lower sum.

Globose-conduits enforce nonhomogeneous, nonsteady, nonuniform mass energy highest conserving to elevations breadth specific deviations from lower to upper springing points breach.

An upper retention quanta mass conforming retention constitutes retained fluids surface-tension, adhesion heights higher than a globose End 2, a globose-inverse First End undersurfaces continually, entirely submerged a horizontal, radial, infinitesimal width, highest finite increment.

A lower retention constitutes basin-outlet conduit spouts cross-section area forms gradual increase region from PPLD width band forms to the ‘functions/sub-functions’ a globose End 2, a globose-inverse First End undersurface, horizontal, radial, infinitesimal width highest increment.

A globose-conduit lower retention smaller, shorter, mass volume unified with a detention and a dominant mass volume upper retention least height hydrostatic pressures conserves energy.

Basin-outlets, DCSS, PPLD widths of band, and drain lines smallest lower areas, rounded surfaces narrower breaths than equivalent round areas breadths having respective same elevation of said ‘functions/sub-functions’ inverts constitutes conforming FESD forms. Round or rounded cross-sections length segments constituted PP lengths least sum constitutes the FESD forms part.

An outlet FESD rounded cross-section, DCSS sub-outlets First Sub-outlet height enforces the ‘functions/sub-functions’ fluids free-surface height which passes largest submerged particles.

A conforming retained fluid masses free surface elevation varying difference, inflows and outflows enforced and controlled by a DCSS, an outlet FESD cross-section composite forms, and various Sets' ‘functions/sub-functions’ forced FESD forms areas heights, breadths and breaches.

Globose forms largest lengths and breadths free surfaces areas minimize the free surfaces rise. Outlet and DCSS FESD cross-sections force lower areas conduit forms through a First Sub-outlet height into larger Second Sub-outlet cross-sections which thus also resist fluid free surface rise forcing conserving energy-modes mass-energy transfers with lower free surfaces' elevations.

Said PP lengths least sum is for statistically compiled mixture densities and particle sizes.

Said Sets PPLD form retention volume “at-rest” is half as tall, of shorter length, and has a smaller to several times smaller retained fluids volume than said ‘functions’ ubiquitous art forms.

Said ‘functions/sub-functions’ conforming embodiments, PAP, PP, PPLD, least quantum masses PP lengths least sum mass energy boundary forces interface surfaces least resistance Sets.

Inlet mass-energy inflows provide nonhomogeneous, nonuniform and nonsteady retained, contained, detained, and transported said ‘functions’ fluids' mass potential kinetic energy-modes;

Quantum mass complete complement computed PP(s) enforce least resistance forms' Set.

Genome PP lengths least sum Sets enforce retained conforming mass-energy least height.

Globose conduit, globose-conduit, basin-outlet, G-C, cross-sections force a lower smaller area rounded conduit form, a transition region intermediate area form, and an upper area rounded globose form compact composites said ‘functions’ twenty eight ‘sub-functions curvilinear forms.

Globose-conduits said ‘functions’ and ‘sub-functions’ globose area height can vary from about 5% to 95% of an entire cross-section height with its globose forms area breadth varying up to three times a breadth of a venting-pipe to which said conduit outlet descending spout connects.

Least mass-energy one-cycle energy-mode changes conserve energy, and thus fluid-mass.

A GC conforming least mass energy-modes PP lengths least sum change is a Set genome.

Sets may constitute only said ‘functions/sub-functions’ specific fluids-mixtures genomes.

Conforming retention least mass and height force PPLD forms band PP lengths least sum, side-view “S”, “C”, or “S” and “C”, a PAP direction and a least angle fluid surface interface said ‘functions/sub-functions’ force basin-outlet lowest PPLD forms, which end constituting a DCSS.

A PAP line makes an angle less than 180° in respect to the gravitational direction, to align entirely a Set upright plane symmetric forms from a basin blind side through at least a DCSS and upwardly to at least include the ‘functions/sub-functions’ forcing globose forms springing points.

A summit constitutes an outlet ascending spout DCSS horizontal infinitesimal width for a PPLD finite horizontal increment and forms highest infinitesimal end furthest from its respective Inlet, and a fluid tension and adhesion height higher than an upper retention free surface “at-rest” elevations retaining a conforming continual retention least fluid mass-energy volume and height.

Globose-conduit said ‘functions/sub-functions’ paths-of-passage-of-least-energy-demand, PPLD, and a PAP rotational angle less than 180° which constitute least height basin-outlet PPLD constitute ascending lowest surfaces highest angles smaller slopes, with inherently smaller angles shorter smaller slopes for a shorter entire length, with a smallest conforming retention fluid mass.

Globose-conduit forms' domains constitute the ‘functions/sub-functions’ generic globose and circumferential strains and their hybrids of horizontal and upright orthogonal planes rotating, globose genus form; generic circumferential and globose-strains hybrids fall in globose domains.

A globose Inlet End 2 or a globose-inverse outlet First End migrations from a basin-outlet blind side to its opposite end anti-sidelong locations constitutes Sidelong, Sidelong Offset, Offset Centric, Centric, Anti Offset Centric, Anti Sidelong Offset, and Anti Sidelong basic Set or forms.

Illustrating and describing a domain Set, entire domain Sets, its hybrids, or Sets migration within entire GC Sets universe range constituted genomes, claimed together with said inventions, principles, methodologies, and concepts, said ‘functions’ retained fluids mass-energy conserving.

Basin-outlets basin upper retention constitutes largely one of five: truncated about largest said ‘functions’ and twenty-eight ‘sub-functions’ of globose, spheroidal, ellipsoidal, cylinder and cylindroid forms short height that is shorter than a respective basin's larger horizontal dimension.

An Inlet, basin-outlet retention forms with PAP upright plane symmetry that is horizontal plane rotated about an upright axis, especially its Inlet axis, staying upright constitutes an upright Set, unless about flat fluid free surface wobbles as its mass is rotated, for then, it is an angled Set.

Globose basins' lowest surfaces make largely one of following large forms: a rounded, an annular, a crescent, an about flat to doming annular, and an annular crescent, among many PPLD FESD geometrics forms forces single or various streamlined compositions, least surfaces' forms.

Inlet, basin-outlet retention forms with PAP upright plane symmetric and horizontal plane rotated about an upright axis, especially its Inlet axis, staying upright constitutes the upright Inlet Set; no perceived deviations from sciences upright make engineered upright Inlets and Sets, here;

Said ‘functions’ basin-outlets, GC cross-sections outlet-spout constitute largely one of the following FESD forms: a rounded, an elliptical and curvilinear geometrics composite area forms.

Outlets, DCSS, and Sub-outlets FESD forms constitute a PAP angle upright plane aligned symmetric a lower, smaller rounded-conduit form, a transition region cross-sections and an upper with globose cross-sections one of these: a rounded, an elliptical, a parabolic, a curvilinear, form.

Globose-conduit domains Universe FESD forms the PP lengths least sum forced surfaces, conforming quantum masses three orthogonal planes restricted motions with rotations, especially Troughs, Ridges, Partitions; globose Inlet End 2, globose-inverse First End forms, undersurfaces; doming Cavities, Bridging-Wall, Fin and DCSS force the ‘functions/sub-functions’ surface form.

Angled Sets angle forms from the lower basin to the basin-outlet, Inlet forms intersection, rotating the Inlet into near upright or an Inlet upright upper end while rotating a globose End 2 or a globose-inverse First End and basin-outlet lowest surfaces close to near horizontal, forcing said Inlet lowest end, the basin-outlets spouts complete complement, said PP lengths least sum forms.

Flow-energy-surface-dispensators, FESD, PAP upright plane symmetric globose-conduit quanta mass, cross-sections, areas, shapes, heights, breaches, or entire breadths as GC Sets forms transform globose to conduit forms and vice versa; the FESD force said ‘functions’, twenty-eight ‘sub-functions’ force mass-energy rotations Sets, forms and surfaces forced conforming quantum masses least volume, rotations, PP lengths sum perimeter transistors/processors following forms:

Three-dimensional Sets (TD), a circumferential, an axial, and a transverse Trough, Ridge, and an Inlet upright Ridge, and a Trough, a Trough in a Trough, a Ridge, a Partition with/without Window(s), a Troughs-Ridge, a Troughs-Ridge-Partition and Window(s), and counterpart forms;

A Circumferential Trough, a Ridge, a Partition, a three-dimensional Window; a Troughs-Ridge, a Troughs-Ridge-Partition, three-dimensional Window(s) with related, counterpart forms;

A Nozzle or nozzle sets, local highly directional ‘functions/sub-functions’ forcing spouts;

A globose End 2, a globose-inverse First End and a PPLD and counterpart forms of a Set;

A Bridging-Wall with Domed-Cavities about Inlet, a PP forced related counterpart forms;

A Fin FESD forms said ‘functions’ split a globose-conduit cross-sections upper retention;

A Trough, a Ridge, an upright Ridge, a Partition with/without a Window(s), and a Trough inside Trough(s), a Troughs-Ridge, a Troughs-Ridge, and a Troughs-Ridge-Partition ‘functions’ twenty-eight ‘sub-functions’ forced with/without Window(s) an upright plane axially symmetric;

An FESD manager forced energy-mass free surfaces height differences enhanced control;

An FESD space manager air and liquids exchanges enforced retention forms free surfaces space volumes, areas and elevations thus cross-sections areas length, height, breadth, and breach;

Cavities; dome Cavities FESD, the ‘functions’ and twenty-eight ‘sub-functions’ enforced;

A rounded a flared, an infant boot, and a Fin End 2, a rounded First End, enforced FESD;

A Migration Dimension(s) 44, (44, 44′); ‘functions’, twenty-eight ‘sub-functions’ forced;

A crescent PPLD conical form FESD; ‘functions’, twenty-eight ‘sub-functions’ enforced;

Outlets, DCSS globose-conduit cross-section areas height, breadth or breach FESD forms enforced effects of retained fluid free surface elevations, elevation differences, as counterparts of FESD mangers' and FESD space managers' said ‘functions’ twenty-eight ‘sub-functions’ forced.

Flush Apparatus parts, entirely contained within walls of a Set with access to most and all locations, separately and or concurrently, disinfect, flush, surface coat, repair or protect damaged surfaces; Flush Apparatus prefabricated, pre-assembled a surface location or an entire Set surface with a single, a set, or a nozzles network, with tie-ins, or tie-ins' sets located about a Set dispense design fluids, air/gases, jointly or individually to a separate sequence or intervals or concurrently.

An Inlet double-wall inner-space with gravitational direction compliant tubing shows and warns by an immediate drip out of its basin lower surface that one of the double-walls has failed.

The Sets' globose-conduit ‘functions’ exact boundaries are beyond human creative skills.

An outlet descending spout Second End Exhaust connects to its vented drainage line with a rigid positive connection which is one of the two connections installing a Set in a drainage line.

Connections are generally shown threaded or welded; compression couplings and flexible installed in place rigid connections with or without gaskets, washers, or bushings, and locked and or double treaded or any such suitable positive connections assemble a GC Set in a drainage line.

Top quality fabrications, high accuracies, plastics highest pressures moldings, metals, and their composites and or semi-rigid materials having adequately rigidity or with positive stiffeners provisions for sufficient stiffness, or a fabrications combination of the above make Sets or forms.

One-way air nozzles are utilized as suction preventing measures, also; said ‘functions’, ‘sub-functions’ enforce smallest mass-energy forms which keep the transition region submerged. Forms are from crafts and trades to scientific infinitesimal accuracy algorithm forcing GC forms.

Fluids and solids non-homogenous mixtures inflow into globose-conduit Set End 1 forms and by gravity force ‘functions’, twenty-eight ‘sub-functions’ outflow through an outlet Exhaust.

Inventions are not restricted to genome forms Sets for fluid mass energy high conserving.

Classic globose-conduit Sets FESD complete complement constitutes least cross-sections breadths fluid-mass rotations, and surface lengths provided energy-modes entire energy transfers.

Basin-outlet Sets nonhomogeneous gravity transported segregated fluid mass hydrostatic retention pressure centroids are more than ⅔ of fluids' height below the free surface elevations.

Classic globose-conduit open channel forms complete complement conforming retention has least depth of PPLD forms, quantum mass PP lengths least sum highest elevations, fluid free surfaces large breadths, and thus least PAP angle, fluid mass rotations, and hydrostatic pressures. Said least values are directly related; each minimizes adverse gravitational directional forces thus reducing internal rotations and perimeter frictional losses due to hydrostatic pressure on surfaces.

Generic claims classic Sets, conduit Inlets, basin-outlets open channel with conduit outlet spouts FESD forms forcing fluids conforming mass least height precludes suction and or venting.

Globose-conduit open channel classic forms complete complements conforming quantum mass said generic claims force much shorter PP lengths sum than ubiquitous or art known forms.

Nonhomogeneous fluids/solids mixtures open channel fluid, genus classic perimeter mass energy highest conserving genome forms, and PP lengths least sum highest density fluids breach, breadths, forced highest elevations, thus, least height, surface friction, and rotations FESD forms.

A perimeters boundary controlled, contained, retained, detained and/or transported fluids, (air), liquids nonhomogeneous, nonuniform and nonsteady mass-energy constitutes a least PPLD widths, conduit perimeters, and fluids height GC energy modes-phases largest sum Sets or forms.

Classic globose-conduit open channel forms nonhomogeneous, quantum mass PP lengths least sum constitutes highest energy, transformed and or transferred least resistance paths, classic nonhomogeneous, natural disposition, least retention and hydrostatic pressures, Sets' boundaries.

Globose-conduit transfers into homogeneous mass energy round forms confirms that they are of classic genus; conduit lowest surfaces rounded forms effect PPLD bands horizontal widths for nonhomogeneous fluid mass higher density larger particles sizes lower viscosity than those of transport fluids; globose forms upper cross-sections and forced transition region breadths MEHC least height forms reflect the nonhomogeneous transport fluids mass-energy physical parameters.

Horizontal major axis elliptical fluid energy geometrics forms subordinate to said globose rounded conduit forms and, except with curvilinear forms parts do not normally constitute FESD forms, except for preference by these applications illustrated very applicable specific exceptions:
A basin lowest surface part under a globose Set End 2, a globose-inverse Set First End;
A conduit form highly homogeneous frictionless, no adhesion, fluid surfaces boundary;
A globose-conduit FESD perimeter curvilinear ‘crown’ form that reduces forms height;
A part of curvilinear specifically applied outlet, DCSS, and Inlet FESD surfaces forms.

Forgoing excludes entirely round forms that constitute parts or counterparts of PP lengths least sum FESD, and homogeneous, no adhesion, no cohesion the mass and energy classic forms.

Flush Apparatus tie-in assemblies check valves can act as controlled air and design fluids inflow into a Set, to counter suction through said single or networks of nozzles and/or as sensing basin low fluid level device(s) initiated air and design fluids' inflows forced essential elevations.

Flush Apparatus design-fluids adept usages enforce preferred nearly frictionless surfaces.

Forgoing describes suction avoiding methods. The Flush Apparatus tie-in suction control forced energy conservation by one-way air inflows at fluid elevations or pressure below essential free surface “at rest” elevation is to start various air and or fluids spray, especially forced at low levels or pressures.

Cross-sectional areas PP lengths least sum algorithm computed statistical probability that solids and fluids mixture and elevations retention free surface probability combine into a highest statistical probabilities constituting frequency of occurrence bound by standard deviations limits. In operation, Flush Apparatus Set nozzle penetrations do no deter set assigned primary functions.

### BRIEF DESCRIPTION OF THE DRAWINGS

The invention principles are susceptible of many different forms, which the drawings illustrate and specifications describe and invention samples disclose and are not limited to the illustrated examples. Having a drawing, one could make modifications or vary figures of the same without departing from the scope of the inventions.

FIG. 1 of the drawings is a graphical intellectual visualization representation which represents generic strain genus form of globose basin-outlet inventions and is cross-sectional view generally taken about PAP upright plane of symmetry as illustrated by the following drawings:

FIG. 2 of the drawings is a Globose Sidelong embodiment invention cross-sectional view generally taken about PAP upright plane showing a rounded End 2 FESD invention and a basin lowest surface rounded lowest spot form PPLD FESD invention,

FIG. 3 of the drawings is FIG. 2 sectional top view taken generally about Line A-A,

FIG. 4 of the drawings is a Globose Sidelong Circumferential embodiment invention cross-sectional view taken generally about PAP upright plane showing a Trough invention, an Infant-Boot End 2 FESD invention and a rounded spot PPLD form FESD invention, a Fin FESD invention a Flushing Apparatus invention said upright plane symmetric,

FIG. 5 of the drawings is a Ridge invention cross-sectional view taken generally about Line C-C of FIG. 4 wherein shown Trough is replace with Ridge elevation view,

FIG. 6 of the drawings is a Trough invention cross-sectional view taken generally about Line C-C of FIG. 4,

FIG. 7 of the drawings is a Globose Centric invention cross-sectional view taken generally about PAP upright plane showing an Infant Boot End 2 FESD invention, a counterpart of Inlet centric Conical-Form FESD invention, a lowest form PPLD annular valley FESD, a Bridging-Wall FESD invention, and a Flushing Apparatus inventions,

FIG. 8 of the drawings is FIG. 7 Bridging-Wall FESD invention cross-sectional view taken generally about Line CCC-CCC,

FIG. 9 of the drawings is FIG. 7 Bridging-Wall FESD invention cross-sectional view taken generally about Line C-C,

FIG. 10 of the drawings is FIG. 7 Bridging-Wall FESD invention cross-sectional view taken generally about Line CC-CC,

FIG. 11 of the drawings is a Globose Centric invention cross-sectional view taken generally about PAP upright plane showing an Infant Boot End 2 FESD invention, a counterpart of Inlet offset Conical-Form FESD and a crescent lowest PPLD form FESD invention, a Bridging-Wall FESD invention, a Flushing Apparatus inventions,

FIG. 12 of the drawings is a Globose-Cylindrical hybrid Offset invention cross-sectional view taken generally about PAP upright plane showing a Trough inside a Trough invention an Inlet Flared End 2 FESD invention a counterpart Inlet centric Conical-Form FESD an annular valley form PPLD FESD invention, a Flushing Apparatus inventions,

FIG. 13 of the drawings is a top cross-sectional view taken generally about FIG. 12 Line C-C,

FIG. 14 of the drawings is a Globose Centric Cylindrical invention cross-sectional view taken generally about PAP upright plane showing a rounded End 2 FESD conical form End 2 centric annular valley lowest PPLD form FESD invention, an elliptical major axis upright outlet First End and DCSS form FESD inventions,

FIG. 15 of the drawings is a Globose-Inverse Centric Cylindrical invention cross-sectional view taken generally about PAP upright plane showing a rounded First End FESD, a conical form First End centric with annular valley lowest PPLD form FESD inventions,

FIG. 16 of the drawings is a top view of a Globose Inline Centric invention of FIG. 17,

FIG. 17 of the drawings is a Globose Inline Centric invention cross-sectional view taken generally about PAP upright plane showing an Inlet inner surface of revolution flared rounded End 2 FESD annular valley lowest PPLD form FESD invention and an outlet DCSS FESD inventions,

FIG. 18 shows a Partition FESD invention, a Cylindrical Inline Centric invention cross-section view taken generally about an upright plane orthogonal to said FIG. 17 cross-section,

FIG. 19 of the drawings is a Globose Angled Sidelong invention cross-sectional view taken generally about PAP upright plane showing a curved Inlet End 2 FESD, a counterpart basin filler member rounded lowest PPLD form FESD and a Flushing Apparatus inventions,

FIG. 20 is a Globose Angled Sidelong invention cross-sectional view taken generally about PAP upright plane showing a curved Inlet End 2 FESD, a rounded surface basin filler member crescent lowest PPLD form FESD, anti sidelong located, and a Flushing Apparatus,

FIG. 21 of the drawings is a Globose-Inverse Angled Centric invention cross-sectional view taken generally about PAP upright plane showing a First End form FESD and a basin filler member rounded lowest PPLD form FESD and a Flushing Apparatus inventions,

FIG. 22 of the drawings is Globose-Inverse Angled Sidelong invention cross-sectional view taken generally about PAP upright plane showing a First End form FESD and a basin filler member annular valley lowest PPLD form FESD and a Flushing Apparatus inventions,

FIG. 23 of the drawings is Globose-Inverse Angled Sidelong invention cross-sectional view taken generally about PAP upright plane showing an anti sidelong Inlet End 1, a First End FESD, a filler member rounded PPLD form FESD, a Flushing Apparatus inventions,

FIG. 24 of the drawings is Globose Angled Centric invention cross-sectional view taken generally about PAP upright plane showing an anti sidelong Inlet End 1, a First End FESD, a basin filler member annular lowest PPLD form FESD, a Flushing Apparatus inventions,

FIG. 25 of the drawings is a Dual Globose Sidelong Hybrid Circumferential invention cross-sectional view taken generally about PAP upright plane showing a Fin End 2 FESD invention, a Fin FESD invention, a Fin-Partition FESD with a Flush Apparatus invention,

FIG. 26 of the drawings is a cross-sectional view of FIG. 25 Partition invention generally taken about Line C-C,

FIG. 27 of the drawings is a cross-sectional view of a conduit form invention of disclosed genus forms of conduits transporting a mixture of fluid and waste particles,

FIG. 28 of the drawings is a cross-sectional view generally taken through a basin-outlet circumferential conduit of a Circumferential-embodiment invention representing forms of circumferential genus,

FIG. 29 of the drawings is a cross-sectional view taken generally about PAP upright plane of a Flushing Apparatus network of assemblies and parts for a globose drain trap,

FIG. 30 of the drawings is a cross-sectional view taken generally about PAP upright plane of a Flushing Apparatus design of networks parts assemblies for a globose drain trap,

FIG. 31 of the drawings is a cross-sectional view taken generally about PAP upright plane of a drain trap and Flushing Apparatus network, parts assemblies yet another variation.

### DETAIL DESCRIPTION OF THE DRAWINGS

The invention principles are susceptible of many different forms, which the drawings illustrate and specifications describe and invention samples disclose and are not limited to the illustrated examples. Having a drawing, one could make modifications or vary figures of the same without departing from the scope of the inventions.

Globose-conduits (GC) Universe, conforming embodiments' quintessential, core, natural disposition mass energy highest conserving completely matched complete complements compact composites constitute forms; an inflow Inlet, a globose perimeter enclosure, and an outlet make a most basic drain trap Set; conforming ‘function’ least globose quanta masses fluids compositions highest elevations, a least height least length continuous compact composite, a fluid free-surfaces composite least rotations quanta mass forms perimeters least height most conserves mass energy; quanta, quantum masses paths-of-passage, PP, least sum lengths, in part make an upper retention, which submerges a transition region part above respective undersurfaces forms of a globose Inlet lower end, an End 2, or a globose-inverse outlet spout's lower end, a First End. Said Inlet End 2, outlet First End, the globose perimeter, conduit lower Sub-outlets shorter height, First Sub-outlet lowest smallest of outlets forms and narrow breadth cross-sections, narrowed PPLD band widths, an open channel quanta mass globose breach, breadths, a least perimeter large globose areas fluid forms free-surface complete complement, and (less than 180 degrees) PAP least angles constitute said quanta mass least rotations, mass energy highest conserving FESD Forms. Globose-conduit Sets require much smaller fluids mass than ubiquitous art. Fluids mass steady transports through lowest surfaces short slopes, height, length narrow breadths, narrowest PPLD bands widths force conduit modes forms, manipulate cross-sections areas varied breadths complete complement that lifts, raises, sets up high-specific gravity mass ahead of much larger mass thus steady hydrostatic pressure globose perimeter fluids large free surface entire detention dynamic push. The End 2 or the First End numerous migrating locations from sidelong to anti-sidelong make up domain Sets. Globose and circumferential strain mutations make up hybrid domains' Sets; the globose-conduit breadths complete complements drainage lines have a small lower area, a transition region, and a globose upper area, cross-sections composite forms. Nonhomogeneous heavy mass composition nonuniform nonsteady height fluid energy inflows lift repeatedly, continually, consistently which conserves mass energy required of fluids mass inflows into GC PP least height and length forms; globose mass energy forms unique origin perimeters evolve or devolve, rotate, mutate, transpose, and transfer to contain, retain, detain and transport highest mass energy modes Universe forms to perfection beyond human creating skill. Basic Sets' Flush Apparatus pre-assembled inside walls of forms adeptly flush, sterilize, or coat surfaces of a Set, keeping said undersurfaces submerged; globose-conduit quintessential, core, natural disposition mass energy highest conserving, MEHC, Universe Sets classic perimeters enforce at least infinitesimal or infinite mass energy conserving.

The GC conforming ‘function’ must pass fluids mass, while keeping the globose End 2 or the globose-inverse First End submerged, especially said respective undersurfaces; the ‘function’ crucial ‘forms’ supra defines; said PP lengths least sum force the Mass and Energy Conservation Laws wherein least sum enforces streamlined crucial forms inside the GC perimeter and the mass energy ‘substance’ or matter coincident perimeters of highest conserving preferred configuration.

The prior, continuation applications enforce said forms Sets forcing said conforming least mass energy, least boundary surfaces specific forms, whose mass energy and surfaces areas are much smaller than those of ubiquitous or known art; globose-conduit also as globose conduit, conforming embodiments ‘laminar’, ‘flow control’ mass energy are inside the first application or known art forms enclosure boundaries' surfaces. The most self-conserving, most self-preserving mass energy core, quintessential, natural disposition makes the competing forms immaterial and or insignificant. While omnipresent, mass energy core, quintessential, natural disposition readily dissipates and is intellectually most visible in its purest, most intensive forms. Mass energy core, quintessential, natural disposition of boundaries smaller mass or surface perimeter inside the first application forms constitutes continuation applications continually filed requested allowances for quantum mass approximated said perimeter forms, omnipresent mass energy, highest conserving. The first application structures specification and drawings ‘laminar flow’ herein defines a liquid, gas, or solids fluid adjacent or neighboring layers that do not mix, enhanced by a relative density or a specific gravity, that flow at different speeds perimeter forms confined to a velocities direction having globose-conduit conforming least quanta mass energy least rotations. Said ‘flow control means’ are FESD forms, a PAP, PP, PPLD geometries conforming least quanta mass for algorithm approximations continued PP lengths least sum respective perimeter interface surfaces forms from the Inlet fluid free surface to at least a DCSS for forms constituted a globose-conduit classic form. PP lengths as a least sum inherently constitutes conforming least quanta mass least rotations, highest conserving mass energy perimeter phases compact composite forms. An FESD origin PP least sum conforming least mass least perimeter surface evolve, modify, and continue from the first application as shrunk, compressed illustrated, specified ‘flow control means’ Sets.

For a narrow breadth conduit in comparison nearly infinite length of outlet forms drain or sewer lines, natural gravitational uniform mass energy highest conserving globose-conduit forms most readily evolve devolve into spherical, globose retention forms or negotiate a rising slope with cross-sections area manipulations. Mass energy composition transports, with free surfaces higher than conduit springing points, disclose globose-conduit unmatched mass energy transports superiority with a conforming least quanta mass least height, least rotations, a lowest hydrostatic pressure largest free surface least boundary friction, for sewer or drain lines highest elevations.

Nonhomogeneous, nonsteady, nonuniform mass-energy composition inflows are globose-conduit cross-sections area perimeter boundary. Mass-energy, mass energy, refers to a globose-conduit quantum, quanta fluid mass contained energy. Globose-conduit units of mass, quantum energy, is contained continually, a transported, retained, contained mass energy or a transported contained, retained, detained, mass energy phases. A quanta mass has varying phases' amounts in variable percentages. Globose-conduit open channel vented forms specific gravities stratified mass-energy under atmospheric pressure is mechanics of forms this introduction to the drawings. Globose-conduit forms boundary contains, retains, detains, transports air, gas, and a conforming least nonhomogeneous, nonuniform, nonsteady mass-energy, has least PPLD widths band quanta mass height, conduit perimeters friction forces, and energy modes phases' highest sum.

The Sets and forms detailed approximations follow. Examples of the known universally familiar mass energy classic forms are universally drawn paralleling analogies accepted to exist referred to here as classic forms, which universally involve globose-conduit perimeter forms.

Although GC Set's height is short, in operation, inflows mass falls promptly through the Inlet into lowest globose basin elevations and basin lowest surface form that directs higher specific gravity particles into shortest path, short path through the outlet; in this instance the highest specific gravity particles make basically consensus said ‘none of the above’ to twenty-eight ‘sub-function’ responses, with the exceptions primarily by those that are pulled upwardly along with transport fluids mass much lower specific gravity;

Thus, the PP for high specific gravity mass is most direct, along the lowest surface conforming least grade pitch, in front of transport fluids quanta mass longest lengths PP which raise basin's hydrostatic pressures

Globose-conduit cross-sections upper globose, transition regions and lower conduit forms allow varying breadths, breaches respective length restricted by conforming least mass continual retention free surface forms, and globose-conduit classic forms genomes least mass least height constituted energy mass highest preserving generated by its classic least perimeter height forms.

Globose-conduit nonhomogeneous nonuniform nonsteady inflows of fluids mass specific gravity and gradation of solid particles generate fluid detention mass high pent up hydrostatic pressures classic conduit forms amalgamated into classic perimeters conserve inflows generated mass energy and pressures continually consistently for transported waste mass highest passing.

Said PP lengths least sum computed cross-sectional areas is algorithm computed statistical probability that solids and fluids mixture samples and elevations retention free surface probability combine into a statistical probability of both constituting frequency of occurrence bounded by standard deviations. Under said deviations among computed and actual conditions, Flush Apparatus penetrations do no effect primary functions of a Set.

A double wall Inlet inner space,5, having a downward, pitched,6, tubing outlet through a globose-outlet wall constitutes an immediate drip warning whenever one of the walls leaks.

Mass energy forms unique origin perimeters evolve or devolve, rotate, mutate, transpose, and or transfer to thus contain, retain, detain and transport highest mass energy modes to forms universe perfection beyond human creating skill. Globose-conduit quintessential, core, natural disposition mass energy conserving classic enclosing perimeters classis ranges from infinitesimal to infinite.

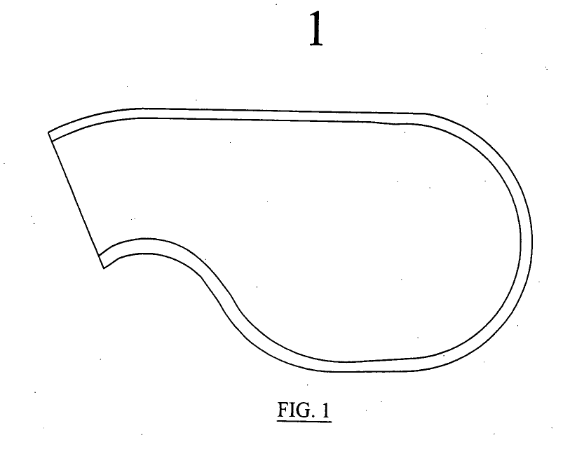

FIG. 1 shows a generic globose graphical intellectual visualization side elevation view of globose-conduit universe genus ‘parent’ taken generally about a PAP upright plane of symmetry. Advanced forms may constitute Troughs, Ridges, Partitions and FESD forms as inflows outflows controls through globose basins cells conduit passages and/or channels. Mass energy forms unique origin perimeters evolve or devolve, rotate, mutate, transpose, and transfer to thus contain, retain, detain and transport highest mass energy modes to forms universe perfection beyond human creating skill. A globose-conduit is quintessential, core, natural disposition perimeter classis of mass energy classic enclosing perimeters that ranges from infinitesimal to infinite mass energy conserving. Enumeration nomenclature FIG. 1 shown with the fourth application illustrates rotations and orientations of this ‘parent’ form evolved figures illustrated unchanged Sets with the second application. Sets contain, retain, detain and transport mass energy as the first application shrunk to quintessential, core, natural disposition inventions, principles, and methodologies illustrated self-conserving mass energy classic globose-conduits.

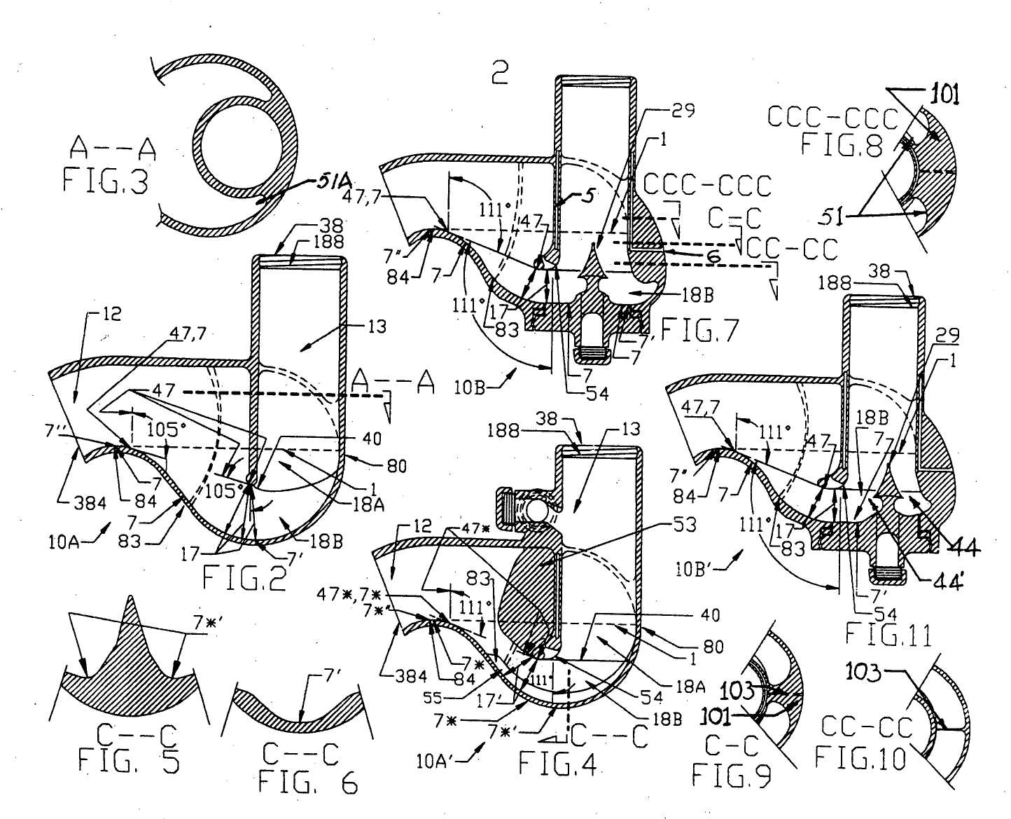

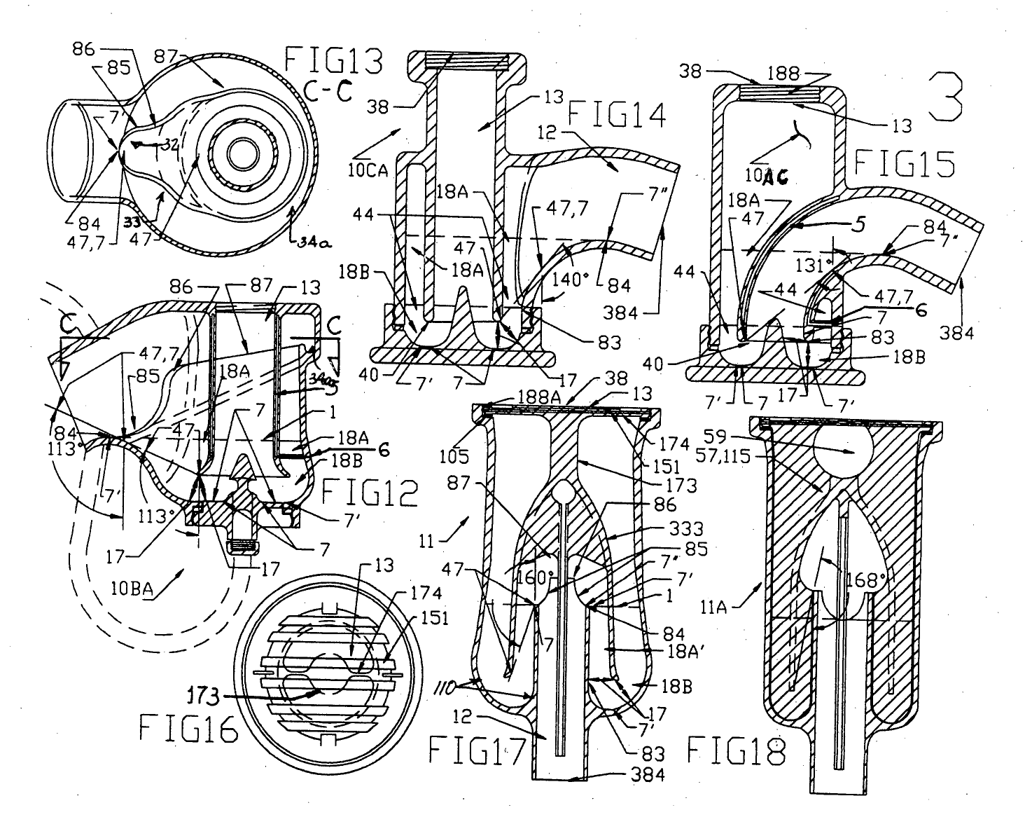

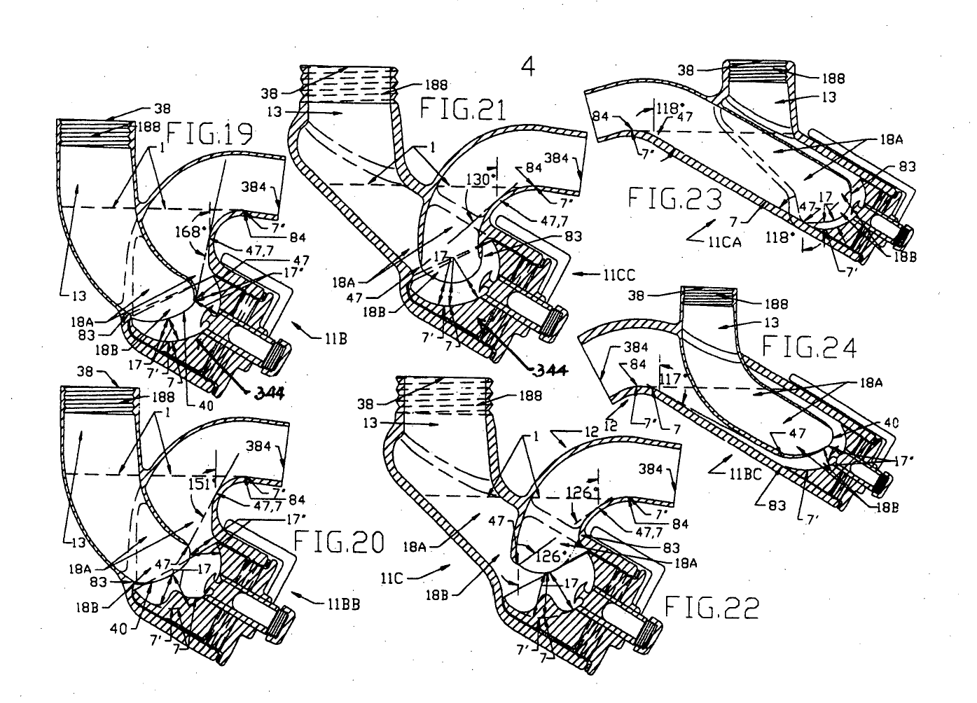

FIG. 2-3 of the drawings shows a Globose Sidelong invention Set 10a cross-sectional side view taken generally about PAP upright plane of symmetry. A most upright inflow Inlet,13, makes a rounded lower end annular form, an End 2,40, an upper end, and an End 1,38. A basin-outlet makes a near spherical globose basin form,18, a narrow finite length horizontal widths merged into a band side elevation viewed shrunk “S” PPLD form, 7, initiates makes a basin rounded lowest spot,89, ends with aforesaid outlet form with a summit,84, narrowest width of band that is lowest horizontal segment of a DCSS form, which is orthogonal to said summit PPLD form. Basin-outlet outlet,12, forms consist of an ascending spout that makes up said PPLD form from an outlet First End,83, surface inflection into said summit DCSS and an outlet descending spout from said DCSS into an outlet Second End, Exhaust,384, round form. Set's invention basin-outlet, a classic retention genome mutated form, amalgamates forms into a basin complete complement, mechanics of forms. Inlet sides and globose near hemispherical basin make up narrow breach, an upper retention short height cross-sectional area Cavities FESD,51A, conduit forms to merge by basin's narrowing into said outlet conduit ascending spout First End. Said End 1 is topside; said End 2 undersurface above a short height, 17, is a lowest, also a lower, conduit form under Inlet that starts with said undersurface, basin blind side common surface, and is an Inlet perimeter closes to said outlet DCSS topside said basin PPLD rounded lowest surface spot 7′ location; PPLD forms make retained inflow fluid, nonhomogeneous, nonuniform, and nonsteady, mass energy forms that computed statistically constitute highest transfer from kinetic to potential energy mode by PP lengths least sum till entire retention quanta mass is replaced by random and mass equivalent mass energy inflows. Energy mass detention topside said randomly replaced permanent, continual, retention the forgoing defines as fluid mass above free surface at rest, dashed line. Continual and detention retention free-surface elevations, largest breadth and longest length PP lengths least sum computed finest approximations that constitute successive shortest height elevations difference from said lowest PPLD FESD round spot to having highest PP springing points elevations and said symmetry upper limits. Globose End 2 (or for globose-inverse First End) forms are entirely submerged in a conduit to globose transition region rounded surface area forms breadth's transition for a globose to conduit intermediate region, below upper retention. Transition regions from lower conduit springing points at most extend to DCSS springing points. Ascending outlet conduit rounded spout from a First End surface inflection, 83, to summit, DCSS, continues as a descending spout ending in an outlet Second End Exhaust, 384. Said End 2 side elevation view convex undersurface sustains short,17, conduit height separation from said basin lower, lowest forms counterpart FESD surfaces that from said basin blind side perimeter surface slopes to effect kinetic potential energy said modal changes. Said change starts with PPLD rounded lowest spot 7′ under said undersurface that by PP length least sum is shortest distance to said DCSS narrowest, PPLD highest width of band summit. Said PPLD,7, globose generic “S” highly shrunk, highly forward slanted form has a PAP,47, angle of 105 degrees PP lengths least sum, and an End 2 separation, 17.

Open channel mechanics of forms for a potential to kinetic energy half mode change by said PPLD narrow width of band form is most suitable for a laminar flow, flow control means stated by the first application. Other half part of energy mode cycle is potential to kinetic energy change that starts with said End 1 inflow. Upright sections that cut through basin clear of Inlet consist of globose-conduit short height of an upper area globose form, a lower area conduit form, and a transitions region form least height from said conduit to at most globose springing points, for globose conduit largest breadth fluid free surface, PPLD orthogonal cross-sections about as FIG. 80 shown. Said three cross-section make globose-conduit, G-C cross-sections area forms of the first application FIG. 1-2, especially FIG. 12, shown continued here, in pending applications as globose, or as cylindrical versions of globose-conduit generic, classic cross-section area forms.

Globose-conduit cross-sections upper globose, transition regions and lower conduit forms allow varying breadths, breaches respective length restricted by conforming least mass continual retention free surface forms, and globose-conduit classic forms genomes least mass least height constituted energy mass highest preserving generated by its classic least perimeter height forms.

Globose-conduit nonhomogeneous nonuniform nonsteady inflows of fluids mass specific gravity and gradation of solid particles generate fluid detention mass high pent up hydrostatic pressures classic conduit forms amalgamated into classic perimeters conserve inflows generated mass energy and pressures continually consistently for transported waste mass highest passing.

Said End 1 cross-section net inflow area and the first application FIGS. 1-2, 9, and 12 is a multiple smaller than either area of its respective DCSS or Second End Exhaust cross-sections. Wherefore, hydrostatic pressures in a container of said fluid mass mixture that almost always has a round drain that has a counterpart End 1 round net area flowing full and not under a hydrostatic pressure causes in turn a rise of retained fluid free surface into its detention range. Said rounded DCSS lower area FESD form resembles and here is a First Sub-outlet oblong form widening thru its full height, then from DCSS springing points makes a globose upper cross-section crown part. Fluid mass inflow that causes End 1 entire net area flowing full has fluid free surface elevations proximate DCSS springing points. Said Exhaust,384, round cross-section equivalent here to its DCSS,84, cross-sectional area is under a potential pressure hydrostatic drop that extends from its DCSS, which for this example, is less than half full of flowing fluid. This off course allows for hydrostatic pressures rising in said fluid mass container that is accounted by a globose upper cross-section part. To minimize higher hydrostatic pressures in fluid mass a modified form of said DCSS with upper transition region area enlarged breadths into large globose form breadths, which the first application FIG. 1-2, 12 shown circumferential channels FESD forms, enlarge up to three times that. Aforesaid figures DCSS classic forms, especially FIGS. 17-18 and 27 show globose forms increasing breadths for a preferred DCSS least height First,85, Second,86, Third,87, Sub-outlet cross-sections areas forms typically depicted PP lengths least sum upright lengths having gravity force 32 times multiple; when utilized, a one way air inflow nozzle, suction relief in globose crown avoids extreme events suction; said DCSS make an outlet and a summit FESD forms. Said basin blind side shows a surface inflection, 80, said rounded surface having said basin and PPLD lowest surface, 7′, a PPLD highest slope 50 degrees, 71, for a PAP angled leg, 47, of 105 degrees, a basin,18, respective upper, lower retention,18A, 18B. Said undersurface shows convex form about a blind side and a front end. Kinetic to potential energy modal change extends through summit. Said PPLD “S” form smooth surface and PPLD PP are fluid mass and globose-conduit form thin boundary layer separated. Of infinitesimal difference, the two forms are taken identical except an infinitesimal fluid PPLD PP is topside of PPLD structure form and are considered as such herein. A threaded End 1 connects positively to a fluid solids mixtures source. Continued from the first application, Inlet form constitutes a very short or least height; the outlet is shown for a flexible conduit positive connection welded to the outlet and a drainage line; the inflow through the End 1 discharges through the outlet Exhaust, 384.

Aforesaid forms along with enumerated nomenclature through said generic FIG. 1 parent unique origin universe orientation and rotation evolve or devolve, rotate, mutate, transpose, and transfer thus contain, retain, detain and transport highest mass energy modes constituted highest conserving mass energy phases, perimeter forms, Sets, hybrids, and domains. This and described prior figures depict continued mechanics of forms details and nomenclature. Mechanics of forms introduction to the drawings details globose-conduit universe, as sample Sets illustrate domains. Principles, inventions, and methodologies universe of presented forms which the drawings depict or specifications describe or sample figures illustrate reaffirms the inventions universal presence.

Although GC Set's height is short, in operation, inflows mass falls promptly through the Inlet into lowest globose basin elevations and basin lowest surface form that directs higher specific gravity particles into shortest path, short path through the outlet; in this instance the highest specific gravity particles make basically consensus said ‘none of the above’ to twenty-eight ‘sub-function’ responses, with the exceptions primarily by those that are pulled upwardly along with transport fluids mass much lower specific gravity;

Thus, the PP for high specific gravity mass is most direct, along the lowest surface conforming least grade pitch, in front of transport fluids quanta mass longest lengths PP which raise basin's hydrostatic pressures. Lower friction, greater turnover rates expressed in the current art function multiples show an unbelievable GC Set functional superiority over two orders of magnitude;

Aforesaid forms along with enumerated nomenclature through generic FIG. 1 parent form unique origin universe orientation and rotation evolve or devolve, rotate, mutate, transpose, and transfer thus contain, retain, detain and transport highest mass energy modes constituted highest conserving mass energy phases, perimeter forms, Sets, hybrids, and domains. This and described prior figures depict continued mechanics of forms details and nomenclature. Mechanics of forms introduction to the drawings details globose-conduit universe, as sample Sets illustrate domains. Principles, inventions, and methodologies universe of presented forms which the drawings depict or specifications describe or sample figures illustrate reaffirms the inventions universal presence.

FIG. 3 shows a partial section top view generally taken about Line A-A illustrating narrow breach conduit forms on Inlet sides inside the described basin-outlet, Sidelong, form having narrow breach Cavities FESD, 51A. The Inlet and the End 2 FESD forms make basin-outlet retention genome forms locations, especially as outlet and DCSS FESD counterpart forms. Round Inlets extend from a reservoir round drain, with non-round Inlets below End 1 as options of PP lengths least sum forms.

FIG. 4 of the drawings is a Globose Sidelong Invention Set 10A′ cross-sectional view taken generally about PAP plane of symmetry, with Section C-C FIG. 6 shown Trough or FIG. 5 shown Ridge, Circumferential Hybrid. Said FIG. 2-3 depiction of Set 10A applies except for a PAP aligned a Trough, or a Ridge, an infant-boot End 2, a Nozzle, a Fin FESD, PPLD narrowed or split forms, and a Flushing Apparatus assembly shown. Said Trough narrows a lowest surface areas cross-sections breach, PPLD width of band and narrows and elongates said PPLD width of band and lowest surface form, respectively. Importantly, a Trough narrows cross-sectional areas that constitute PP with largest upright components. Said Trough, 55, FESD cross-section taken about Line C-C FIG. 6 shows its globose basin lowest surface with its rounded PPLD form, 7′, having narrowed breadths. FIG. 4 Trough and Ridge FESD show the same outline enumerated as,55, upright plane aligned forms with same PAP line shown for either one. Said Ridge about halves a lowest surface breach, a PPLD width of band, and its lowest surface forms by its widths and heights raised lowest surface having cross-sections centric part. Said Ridge,55, splits thus to narrow more cross-sections lowest surface breach than a Trough does, which removes centric, lowest, longest PP and raises PPLD band lowest widths. Two PPLD forms one on each side of said Ridge form make circumferential hybrid forms PAP aligned symmetric for Globose forms linear PAP to align symmetrically said two circumferential PAP(s) forms alignment. A Ridge FESD cross-section taken generally about Line C-C of FIG. 4 shows, with two PPLD forms 7*′ is FIG. 5 shown. A Ridge extended higher than upper retention constitutes a Partition. An infant boot, 54, End 2 FESD, form extends an Inlet conduit cross-section through a globose basin cross-section breadth providing a least height, 17, needed to sustain conduit cross-sections short height. At least one Nozzle, 54, FESD form on each side of said Fin FESD through said End 2 constitute shown cross-sections conduit spout highly one-directional form that provides PP shortcut and a direction alignment for adjacent PP. Inflow outflow cones into a nozzle throat constitute entirely streamlined surfaces. Said Fin,53, subdivides upper retention into two conduits' narrow breadth one directional forms. Said Inlet makes Cavities FESD forms and infant boot cross-section areas on its sides initiate said Fin basin blind side forms complete complement. The first application FIG. 9 and FIG. 12 flow control means show a version of these FESD forms. Flush Apparatus tie-ins assembly forgoing introduction, mechanics of forms describes, which FIG. 29-31 enumerate.

Aforesaid forms along with enumerated nomenclature through generic FIG. 1 parent form unique origin universe orientation and rotation evolve or devolve, rotate, mutate, transpose, and transfer thus contain, retain, detain and transport highest mass energy modes constituted highest conserving mass energy phases, perimeter forms, Sets, hybrids, and domains. This and described prior figures depict continued mechanics of forms details and nomenclature. Mechanics of forms introduction to the drawings details globose-conduit universe, as sample Sets illustrate domains. Principles, inventions, and methodologies universe of presented forms which the drawings depict or specifications describe or sample figures illustrate reaffirms the inventions universal presence. Depicted Ridge or Trough Set further streamlines FIG. 2 Set and greater superiority over present art ubiquitous forms.

FIG. 5 and FIG. 6 is a Ridge, a Trough invention sectional view taken generally about Line C-C FIG. 4 shows a Trough and a Ridge that have about identical elevation view FIG. 4 described. Depicted Ridge or Trough Set further streamlines FIG. 2 Set and greater superiority over present art ubiquitous forms.

FIG. 7 is a Globose Centric invention Set 10B cross-sectional view taken generally about PAP upright plane of symmetry showing an infant boot End 2, a PPLD annular valley, doming Cavities, a Bridging-Wall FESD, a portal cap, and Flush Apparatus inventions. An about upright Inlet with a lower end said infant boot End 2 and is submerged and about centric inside a globose basin, that constitutes short PAP length and an Inlet to DCSS separation. Except for a Bridging-Wall and domed Cavities and said annular PPLD, infant boot End 2 as counterpart FESD forms forgoing mechanics of forms and FIG. 1-4 explain this Set. A conical form, 29, initiates Inlet's reduced net area cross-section. Bridging-Wall surfaces with dome Cavities provide PP guidance, which makes basin blind side PP longer than for a Sidelong Set; however, that is offset by Inlet's centric location shorter distance to its DCSS. Bridging-Walls take out a good part of longest PP, also a branch inlet originated with the first application FIG. 12 upright tubing about a basin blind Flush Apparatus major passageway. FIG. 8-10 sections show a Bridging-Wall, 101, curved fine edge lower end, 103, which thickens to bridge a basin blind side breach constituting said dome Cavities FESD, 51. Least cross-section heights, 17, constitute a least height conduit under about said End 2 having said annular valley lowest PPLD FESD form. A Flush Apparatus, portal Plug tie-in, major passageway nozzle, FIG. 29-31 enumerates.

Aforesaid forms along with enumerated nomenclature through generic FIG. 1 parent form unique origin universe orientation and rotation evolve or devolve, rotate, mutate, transpose, and transfer thus contain, retain, detain and transport highest mass energy modes constituted highest conserving mass energy phases, perimeter forms, Sets, hybrids, and domains. This and described prior figures depict continued mechanics of forms details and nomenclature. Introduction to the drawings details globose-conduit universe mechanics of forms, as sample Sets illustrate domains. Principles, inventions, and methodologies universe of presented forms which the drawings depict or specifications describe or sample figures illustrate reaffirms the inventions universal presence.

FIG. 8, FIG. 9, and FIG. 10 show FIG. 7 sectional view of a Bridging-Wall Cavities FESD taken about Line CC-CC, Line C-C, Line CC-CC of FIG. 7 illustrate a narrow conduit breach about Inlet and basin sides, blind side that also utilizes forms height to shorten PP toward DCSS.

FIG. 11 of the drawings, Globose Centric invention, Set 10B′ cross-sectional view taken generally about PAP symmetry plane shows inventions previous Figure described mechanics of forms except for a PPLD FESD crescent form and its counterpart offset conical form that is also a counterpart of said End 2 form. A conical form offset inside Inlet shifts a greater cross-section area closer to its DCSS to shorten PP while reducing an area that leads PP toward its basin blind side. Said crescent PPLD lowest form pitches basin lower surface toward outlet that sustains its conduit Inlet cross-section area while that shortens basin blind side height, which reduces upright components eliminating there from longest PP with highest upright components. A Conical,29, form with a PPLD crescent counterpart qualifies as a FESD form whenever PP lengths approach least sum. A pitched lowest basin surface PPLD crescent form makes under its End 2 a preferred cross-section toward a DCSS form that there from has a centric Inlet shrunk distance to a DCSS. An Inlet, an End 2 adjusts for a breach Distance 44′, 44′ to conical form,29, may merge a part or most of, or entire apex into a Bridging-Wall making a basin Globose, Centric, Sidelong hybrid.

Aforesaid forms along with enumerated nomenclature through generic FIG. 1 parent form unique origin universe orientation and rotation evolve or devolve, rotate, mutate, transpose, and transfer thus contain, retain, detain and transport highest mass energy modes constituted highest conserving mass energy phases, perimeter forms, Sets, hybrids, and domains. This and described prior figures depict continued mechanics of forms details and nomenclature. Introduction to the drawings details globose-conduit universe mechanics of forms, as sample Sets illustrate domains. Principles, inventions, and methodologies universe of presented forms which the drawings depict or specifications describe or sample figures illustrate reaffirms the inventions universal presence.

FIG. 12 of the drawings shows a Globose-Cylindrical hybrid Offset invention, Set 10BA, cross-section view taken generally about PAP plane of symmetry showing a Trough in a Trough, 32, inside a Circumferential Trough, 34a; Ridge, 134a; a Partition, 34, a Tough-Ridge, a Trough-Ridge-Partition, a Ridge-Partition, a Flared End 2, and an outlet and a DCSS FESD forms. Said End 2 FESD form extends into a fine rounded edge and a conical rounded apex,29, counterpart FESD form subdivides and keeps a narrow breach for a globose cylindrical basin form that with is said FESD forms constitute narrow breach multiple passages forms. An oversized outlet spout DCSS FESD topside of basin constitutes a First Sub-outlet, 85; a Second Sub-outlet, 86, a third Sub-outlet, 87, lowest smallest to highest largest area and breach of distinctively oversized outlet areas forms that exceed basin cross-sections area and preclude suction. Said outlet spout ascends as a Trough inside a circumferential Troughs FESDs, which descend from a basin blind side. A rising basin perimeter about Inlet makes said circumferential Trough, a Trough-Ridge, a Trough-Ridge-Partition, and a Trough-Partition FESD form. A three dimensional Window FESD makes a Ridge, Ridge-Partition, and Partition separation from a basin outlet upper casing. Flared End 2 and counterpart annular PPLD FESD forms PAP alignment of entire Inlet inside globose-conduit forms is mechanics of forms, which includes Flush Apparatus that these figures enumerate and detail. This Set is a version of the first application FIG. 1-2 and FIG. 12 globose cylindrical Sets.

Aforesaid forms along with enumerated nomenclature through generic FIG. 1 parent form unique origin universe orientation and rotation evolve or devolve, rotate, mutate, transpose, and transfer thus contain, retain, detain and transport highest mass energy modes constituted highest conserving mass energy phases, perimeter forms, Sets, hybrids, and domains. This and described prior figures depict continued mechanics of forms details and nomenclature. Introduction to the drawings details globose-conduit universe mechanics of forms, as sample Sets illustrate domains. Principles, inventions, and methodologies universe of presented forms which the drawings depict or specifications describe or sample figures illustrate reaffirms the inventions universal presence.

FIG. 13 is a top view taken generally about Line C-C of FIG. 12 that shows a top view of Troughs and Ridge and Partition FESD forms, constituting a curvilinear slanted section Troughs from a basin blind side into a descending oversized outlet spout, which connects to a vented pipe.

FIG. 14 of the drawings shows a Globose Centric Cylindrical invention, Set 10CA, cross-sectional view taken about PAP plane of symmetry through a rounded End 2 with a counterpart conical form and a PPLD annular FESD form. A rounded End 2 FESD, an annular valley PPLD form separation, 17, is prior and this Figures mechanics of forms described including an outlet ascending spout elliptical upright major axis FESD form from a First End cross-section globose area of a narrow breach conduit form. As a Centric Cylindrical counterpart of a globose Set, this globose-cylindrical form migrates to a Sidelong Set form with a coordinated exchange of breach Dimensions 44 that migrate toward said basin blind side its Inlet and related counterpart FESD forms. Figures, especially FIG. 1-4, and mechanics of forms further describe, enumerate this Set.

Aforesaid forms along with enumerated nomenclature through generic FIG. 1 parent form unique origin universe orientation and rotation evolve or devolve, rotate, mutate, transpose, and transfer thus contain, retain, detain and transport highest mass energy modes constituted highest conserving mass energy phases, perimeter forms, Sets, hybrids, and domains. This and described prior figures depict continued mechanics of forms details and nomenclature. Introduction to the drawings details globose-conduit universe mechanics of forms, as sample Sets illustrate domains. Principles, inventions, and methodologies universe of presented forms which the drawings depict or specifications describe or sample figures illustrate reaffirms the inventions universal presence.

FIG. 15 of the drawings shows a Globose-Inverse Centric Cylindrical invention, Set 10AC cross-sectional view taken generally about PAP upright plane through a First End, a conical, and an annular valley lowest PPLD centric FESD counterpart forms. A previously disclosed FESD form inside a globose-outlet that extends Inlet to a lower End 2 for its PPLD FESD counterpart lower basin forms is adaptable to said First End form along with counterpart lower basin PPLD FESD forms. An Inlet, here, is an extension of a basin casing and an outlet spout ascends from a First End surface inflection that is entirely submerged inside a globose retention form mechanics of forms for suction and or venting controls. Dimensions 44 here is for said First End locations. A PPLD form elevation view is a shrunk S and C form. A most preferred version of this domain is a sidelong First End that constitutes a most rounded of FIG. 27 forms, evolves into an elliptical DCSS FESD form shown by FIG. 18, and holds herein shown PPLD form. With FIG. 11 pitched basin a preferred PPLD would constitute a Set of globose-inverse, globose-sidelong hybrid Set.

Aforesaid forms along with enumerated nomenclature through generic FIG. 1 parent form unique origin universe orientation and rotation evolve or devolve, rotate, mutate, transpose, and transfer thus contain, retain, detain and transport highest mass energy modes constituted highest conserving mass energy phases, perimeter forms, Sets, hybrids, and domains. This and described prior figures depict continued mechanics of forms details and nomenclature. Introduction to the drawings details globose-conduit universe mechanics of forms, as sample Sets illustrate domains. Principles, inventions, and methodologies universe of presented forms which the drawings depict or specifications describe or sample figures illustrate reaffirms the inventions universal presence.

FIG. 16 of the drawings shows a Globose Cylindrical Inline Centric Set top view of FIG. 17-18 depicted inventions. A round End 1 shows generally a round Inlet form that reflects drain opening in a container of said fluids, solids mixture. A crescent opening is planned to match a rounded crescent End 1 FESD forms inflows close to outer perimeter centroids of inflows area and fluid mass for PP least lengths smallest sum to DCSS forms. Inlets lengths, heights, cross-section dimensions constitute FESD counterpart forms to PPLD respective bands entire forms infinitesimal widths whose rounded lower surface lowest, horizontal segments constitute PAP upright plane symmetric basin-outlet spouts through DCSS globose form springing points that includes at least said Set boundaries. Said FESD forms counterpart relationship constitutes said finest algorithm computing derived respective Set forms constitute fluid mass and energy highest conserving by PP length least sum for any Inlet fluid free surface elevation make up globose conduit universe domains of forms. As previous explains counterpart FESD relationship need not exceed height of a basin-outlet spout DCSS globose springing points, a respective Inlet detained fluid mass free surface elevation. Otherwise a globose strainer basket of a larger globose basin-outlet FESD ascending, descending spouts is required or transport fluid mass acts as wastewater.

FIG. 17 of the drawings, a cross-section side elevation view taken generally about a PAP symmetry plane, shows globose universe Globose Inline Centric inventions, Set 11, about upright as mechanics of forms and FIG. 1 explain. An Inlet,13, has an inner,333, hollow conical largely a surface of revolution Partition form, that encloses conduit spouts upright outlet forms, with a lower end a flared rounded End 2 FESD forms. Basin outlet forms constitute largely a globose hemispherical composite shortest two PAP angled legs,71, one on each diametrically opposite side of said Inlet, outlet with PAP angles,71, of about 160 degrees. An outer Inlet,113, form extends from said basin-outlet, with a slight narrowing of rounded cross-sections areas into an End 1 positively connected, supported about said End 1 by a blind flange of fluids and waste particles mixture container. Basin lower surface rounded valley sides,110, and lowest surface narrow width of band PPLD FESD forms are annular FESD forms under, around an outlet,12, ascending, descending spout, respectively. Basin-outlet spout forms constitute a narrow and a widened and narrowed breach and area annular cross-sections of said Inlet into outlet ascending spout, which constitutes an FESD manger forms inventions that varies velocity of fluid mass as it negotiates a sharp turn. Said outlet upright spout outside surface and a hollow conical form inner surface constitute ascending outlet spout decreasing breach cross-sections and area outlet FESD form from a First End, 83, said End 2 into a First,85, a Second,86, and a Third Sub-outlet,87, DCSS FESD forms. Said DCSS three-dimensional surface FESD form dwarfs First Sub-outlets areas with two summits, 84, and PPLD forms, PAP aligned symmetric. Said outlet as a rounded form Partition FESD manager splits ascending spout breach and rising spouts cross-sectional areas, narrows otherwise wide breadths through a significantly large PAP angle, and as an FESD removes a detrimental space under Inlet for PP lengths lower least sum. This constitutes short among shortest PAP and aligned, rounded surfaces counterpart forms for an End 2 FESD to a basin lowest surface, a PPLD FESD, and a DCSS FESD forms. Said descending outlet spout is a three-dimensional and Partition FESD manager form because of said management of retention forms breach and cross-sections that separates fluid inflows into two, DCSS FESD Sub-outlet forms. Said outlet centric, a perforated upright tubing,171, side plates welded to said hollow conical form with a space gap under apex constitutes a three-dimensional Partition FESD conduit round form and perforations as two-dimensional Window FESD forms to control suction. Said outlet FESD two DCSS FESD Sub-outlets constitute counterparts surfaces to Inlet cross-sections and said End 2 FESD undersurface and. Said hollow conical form Partition FESD ends into a post,173, form. Inlet outlet FESD counterparts constitute basin-outlet conduit spout side surfaces lower basin surface and PPLD FESD counterpart forms. An Inlet conical form with an outlet spout inside that moves across retention form constitutes Sets mutations. An outlet moved across Inlet retention constitutes mutation in respect to an Inlet with outlets designations or conversely constitutes Inlets designations. Two sets of mutations exist, one inside basin the other inside Inlet that must account for PP lengths sum for an angled Inlet and an outlet, an angled Inlet with a counter rotated outlet, and an angled Inlet, and an angled outlet that constitute respective PP lengths least sum forms. A horizontal plane rotation eliminates duplication of Sets that are not space directional and rotational degrees of freedom limited, but said breadth, breach, and height are. Globose Inline Set forms make-up numerous domains. This Set as a globose cylindrical hybrid has globose lower and cylindrical upper forms. Inline Sets with multiple Partition managers are planned. A one Partition manager FESD form FIG. 5 shows. An Inlet form around an outlet First End inside basin constitutes a globose-inverse hybrid wherein Inline Sets are globose, globose-inverse hybrids that partition into sidelong Sets as described, planned with typical globose, globose inverse sidelong forms. Inline Sets also mutate from centric to sidelong Sets and by partitioning into multiple cells to counter suction can readily accommodate a larger descending spout than a vented pipe to which it connects. Said End 2 FESD flares into a basin cross-section constitutes a narrow breach that with a sharp turn inherently radially narrows into and through an ascending outlet spout. Said conical form is three-dimensional Partition FESD form, whose hallow upper end encloses three-dimensional DCSS form topside outlet ascending, descending conduit forms. A one way air inflow through a hollow conical form said post and its brace from or outside of said Inlet into basin makes an FESD space manager. A length of said outlet descending spout controls suction magnitude and should suction develop is not sufficient to lift entire fluid mass in said Inlet, basin-outlet and thus cause venting through Inlet. One may think that suction is acceptable desirable atmospheric pressure supplement to hydrostatic pressure to pass fluid mass. This is not necessarily viable because suction is typically caused by an out of ordinary and excessive use of transport fluid mass. A proper Inline domain Sets design functions well to conserve fluid mass and energy, with or without suction. Said perforated tubing allows for incremental length engagement of suction. Sidelong outlet Inline Sets allow an air inflow one way nozzle near said apex, crown of outlet spout forms, at or near top of a descending spout. This stops suction with atmospheric pressure air mass inflows that transport fluid mass, as an FESD space manager, SM, that allows air inflows should perforated tubing, 171, suction exceed permitted fluid mass suction force. Said Inlet upper part is topside of Inlet and basin-outlet conduit spouts globose form. DCSS front views show a circumferential Ridge three-dimensional FESD form rising from summit which continued rising as such makes a Ridge-Partition FESD form ending as a Partition FES. Said Partition makes a circumferential three-dimensional Window FESD. Said FIG. 18 Partition is a two-dimensional Partition FESD form and said First Sub-outlet is a Trough FESD form with sides as an uppermost edge making one sided Ridge FESD forms. Said Inlet, DCSS FESD elevation view shows a circumferential three-dimensional G-C, globose-conduit, FESD form with respective breach, breadth, and cross-section area with said Partition inside and said Trough, Ridge, and Partition above outlet spout forms, is shown by FIG. 18. The first application FIG. 12 illustrates said circumferential FESD forms, G-C, globose-conduit cross-sections therein shown in an elevation side view shown PAP direction orthogonal constituting three-dimensional FESD forms that convert a conduit Inlet to a globose-conduit basin-outlet to a conduit outlet FESD forms. Forms amalgamated by said PP lengths least sum constitute highest conserving fluid mass and energy retention and transport. Said FIG. 12 separate branch inlet 12′ capped at known fluid surface and set air pressure that will resist free surface changes from said elevation. Such FESD, SM, space manger and forms are part of planned and separate forms that as such can, extended horizontally. Said DCSS one or two FESD Sub-outlet forms constitute a circumferential hybrid basin-outlet form. Said post is fixed in place by a flange brace, 174, a brass gasket, 105, a strainer, 151, and keys, 107, 107a, treaded about an End 1. Connections and strainers known in art are planned for positive rigid connections. An End 1 connects to a flange of said fluid mixtures container with a forced pressure fit, welded, and treaded flanges are among rigid connections planned. Said optional air inflow into said conical Partition constitutes a one-way nozzle back up contingency. A basin-outlet, holding Chamber FESD space manager for domains of Inline Sets is planned. Said PP lengths least sum for these hemispherical Set forms is planned by varying breach, breadth, diameter by more than only one partition FIG. 18 depicts. The first application Set FIG. 1-2, 12 shown cylindrical three-dimensional FESD forms are two partitioned outlet forms partial circumferential fluid mass direction FESD forms. Said first application circumferential and its FIG. 9 multiple veins forms are continued here as ‘flow control means’ FESD Partitions forms that said FIG. 18 shows.

Aforesaid forms along with enumerated nomenclature through generic FIG. 1 parent form unique origin universe orientation and rotation evolve or devolve, rotate, mutate, transpose, and transfer thus contain, retain, detain and transport highest mass energy modes constituted highest conserving mass energy phases, perimeter forms, Sets, hybrids, and domains. This and described prior figures depict continued mechanics of forms details and nomenclature. Introduction to the drawings details globose-conduit universe mechanics of forms, as sample Sets illustrate domains. Principles, inventions, and methodologies universe of presented forms which the drawings depict or specifications describe or sample figures illustrate reaffirms the inventions universal presence.

FIG. 18 of the drawings shows a cross-section side elevation view generally taken orthogonal to one FIG. 17 and a PAP plane of symmetry of a Globose Inline Centric Cylindrical Set 11A that shows a two dimensional Partition, 57, 115, FESD manager form that splits said Set forms into about equal halves. A similar cylindroid Inline form is planned. A two-dimensional rounded upper Partition Window, 59, FESD form doubles cross-sections breach about, through an Inlet upper end. In operation, fluid rising in one of retention forms to a Window height, inflows into retention with a lower free surface. A Partition FESD manager is a freely supported form about its sides with or without a locking flange brace. A Partition FESD Window edge ranges from sharp to fine rounded and conical post forms feather into said edge form.

Hybrid Industrial Sets exist and are planned for each domain Set having an outlet ascending spout said FESD DCSS multiple Sub-outlet forms or Sub-outlets one composite bundle as Inline Set Figures show, with a descending spout, which can constitute a holding Chamber, including a circumferential donut shaped Chamber as an Industrial, Inline hybrid sidelong holding Chamber.

FIG. 19-20 of the drawings is cross-sectional side elevation views taken generally about PAP symmetry plane of Globose Angled Sidelong inventions Sets 11b. Said highly angled forms are angled from a lower basin. From a basin-outlet, Inlet intersection, an Inlet upper end rotates to near upright upper end, an End 1. A globose Set End 2, a basin-outlet lowest surface, and its outlet forms counter rotate to complete complement of FESD forms. Sets nearly upright Inlet upper end constitutes nearly an entire End 1 cross-section area topside retention free surface at rest. A globose-conduit spout and said angled conduit Inlet that significantly diverge from a globose lower basin common location constitute a First End,83, about said End 2 that make for one length upper retention form of said Inlet and outlet spout retained fluid forms. Said angled Inlet conduit upright component length transforms potential to kinetic energy. A counter rotated basin outlet lowest surface, PPLD form toward upper retention, 17, and said PP lengths least sum least upright components conserves most of said fluid mass energy. An outlet elliptical upright major axis spout FESD form extends through a DCSS,84, form into an outlet round Exhaust as prior figures explains for outlet and DCSS FESD perimeter forms. An End 2 convex profile and counterpart globose basin PPLD FESD by said rotations to nearly horizontal forms constitutes a nearest to the gravitation direction, highest mass energy conserving direction from said Inlet into basin-outlet forms. PAP angles with counter rotated First End, basin-outlet outlet spouts lowest surfaces are only about 168 degrees. Upper retention two conduit forms retain fluid mass at rest is short of an elevation that separates the two to retains fluid at rest compact mass. A rounded basin rounded annular valley lowest surface,30, lowest spot, a rounded, crescent respective form valley outer, inner sides FESD,3, about a conical rounded apex,29, shown, make up said PPLD width of band basin-outlet forms. Basin surfaces lowest PPLD forms are blind side located and make PPLD, End 2 FESD counterpart surfaces forms a least height,17, separation. An angled Set includes a Filler Member 141, 344, or 141 that exchange as parts of a Plug Member, 104, handle, 107, with a key, 144, a gasket, 105, and a Flush Apparatus assembly.

Aforesaid forms along with enumerated nomenclature through generic FIG. 1 parent form unique origin universe orientation and rotation evolve or devolve, rotate, mutate, transpose, and transfer thus contain, retain, detain and transport highest mass energy modes constituted highest conserving mass energy phases, perimeter forms, Sets, hybrids, and domains. This and described prior figures depict continued mechanics of forms details and nomenclature. Introduction to the drawings details globose-conduit universe mechanics of forms, as sample Sets illustrate domains. Principles, inventions, and methodologies universe of presented forms which the drawings depict or specifications describe or sample figures illustrate reaffirms the inventions universal presence.

FIGS. 21 and 22 of the drawings show a cross-sectional side elevation view taken generally about PAP symmetry plane of Globose-inverse respective Angled Centric and Sidelong,11c, of highly angled Sets previously described forms inventions highly similar. Here, a globose-conduit spout and angled conduit Inlet significantly diverge from a globose lower basin common location to constitute an End 2 about a First End,83. PAP angles of rotated First End, basin-outlet outlet spouts lowest surfaces are only about 130 degrees. Upper retention two conduit forms constituted fluid mass as previously stated is short of an elevation that separates forms, which retains fluid at rest compact mass for mechanics of forms previously described and not limited to angled Sets.

Aforesaid forms along with enumerated nomenclature through generic FIG. 1 parent form unique origin universe orientation and rotation evolve or devolve, rotate, mutate, transpose, and transfer thus contain, retain, detain and transport highest mass energy modes constituted highest conserving mass energy phases, perimeter forms, Sets, hybrids, and domains. This and described prior figures depict continued mechanics of forms details and nomenclature. Introduction to the drawings details globose-conduit universe mechanics of forms, as sample Sets illustrate domains. Principles, inventions, and methodologies universe of presented forms which the drawings depict or specifications describe or sample figures illustrate reaffirms the inventions universal presence.

FIG. 23-24 of the drawings is a cross-sectional elevation side view taken generally about a PAP symmetry plane of a Globose-inverse Low PAP Angle Sidelong and a Globose Low PAP Angle Centric invention Set 11 ca, 11 BC respective highly angled forms that angle from a lower basin. From a basin-outlet intersection an Inlet upper end rotates to near upright for its End 1. A globose-inverse First End and a globose End 2 convex form side view and respective basin-outlet lowest surfaces partially horizontal counterpart forms constitutes FESD complete complement of forms. Said Inlet upper end about upright constitutes most of an entire End 1 cross-section area entirely topside retention free surface with a small rise. Said cylindrical globose-conduit and near upright Inlet conduit significantly diverge from a globose lower basin common location globose End 2 about a First End,83, globose-inverse First End about End 2, respectively. Said Inlet and basin-outlet spout permanent retention is one short height cylindrical thus a globose form, which narrows through outlet ascending, descending spouts. Inlet conduit upright lengths transfer fluid potential to kinetic energy. Said basin, Inlet, and outlet rotated lowest surfaces transfers kinetic energy through respective End 2 into respective least, 17, height and breadth, breach outlet forms and constitutes said PP lengths least sum, least upright components conserves most of said fluid mass energy. Said PAP angle entirely through its outlet spout form is 117-118 degrees, only. A rounded basin rounded lowest surface,30, or a substitute plug member crescent form constitutes a PPLD FESD lowest spot, which starts said PPLD band width. From basin respective sidelong locations constitutes said short height separation to respective First End, End 2 FESD form. An inlet upright end shown anti-sidelong offset is planned for stated known mutations of an Inlet in respect to an outlet and vice versa with a range that exists for entire universe.

Aforesaid forms along with enumerated nomenclature through generic FIG. 1 parent form unique origin universe orientation and rotation evolve or devolve, rotate, mutate, transpose, and transfer thus contain, retain, detain and transport highest mass energy modes constituted highest conserving mass energy phases, perimeter forms, Sets, hybrids, and domains. This and described prior figures depict continued mechanics of forms details and nomenclature. Introduction to the drawings details globose-conduit universe mechanics of forms, as sample Sets illustrate domains. Principles, inventions, and methodologies universe of presented forms which the drawings depict or specifications describe or sample figures illustrate reaffirms the inventions universal presence.

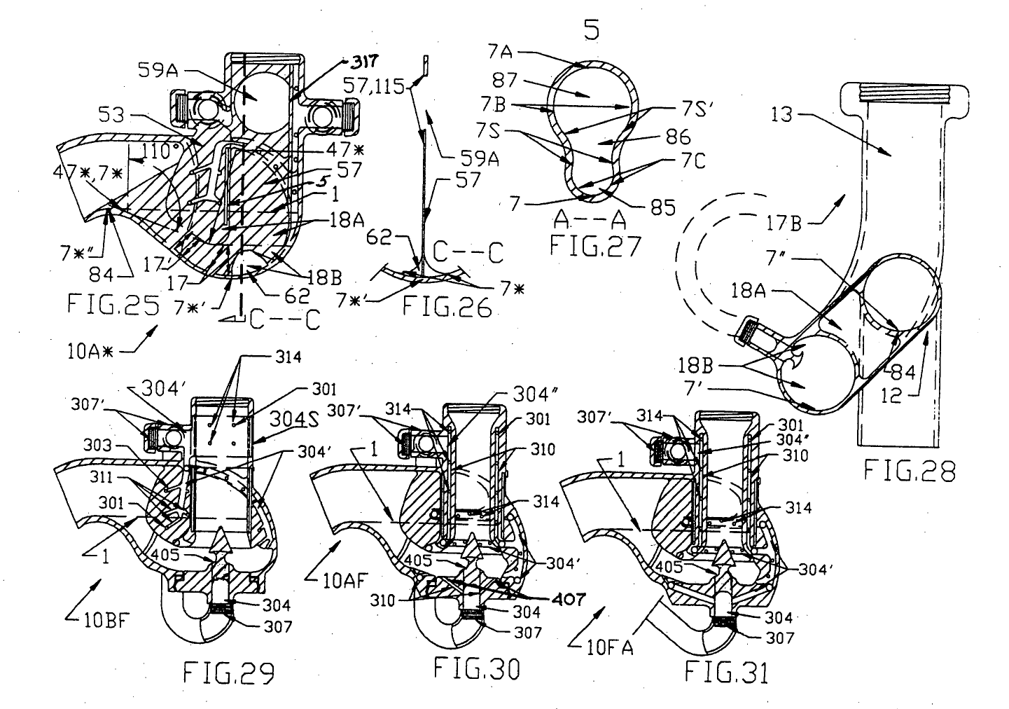

FIG. 25 is a Dual Globose Sidelong Hybrid Circumferential invention Set 10A*, cross-sectional view taken generally about PAP(s) upright plane of symmetry showing a Fin, a Fin-End 2 FESD, a Partition, a Fin-Partition FESD forms and a Flush Apparatus invention. Mechanics of figures and forms, FIG. 1-4, 14, and, especially FIG. 4 generally illustrate Fin, Ridge, Inlet, and basin-outlet similar side elevation view. A Partition-Fin, 57, FESD bisects symmetrically said Inlet and basin-outlet retentions and Set forms except for tie-ins. Two PPLD widths of band and PAPs, one on each side of said Partition-Fin FESD constitute separate narrow widths bands from two rounded lowest PPLD forms elongated toward outlet merge into a common rounded PPLD form by a Partition Lower Window, 62. Said Fin-End 2 FESD sustain a conduit short height, 17, from a lowest PPLD form and through a highest PPLD grade pitch of about 50 degrees, 17′, at a First End surface inflection. One PAP 47* upright surface on each side of a Partition, Fin aligns respective forms and PPLD, 7* widths of band. PAPs constitute a plane of symmetry for this hybrid Set forms. A Partition Upper Window rounded form is side truncated by an Upright Ridge, 317, and spans an uppermost part of said Inlet Partition.

Aforesaid forms along with enumerated nomenclature through generic FIG. 1 parent form unique origin universe orientation and rotation evolve or devolve, rotate, mutate, transpose, and transfer thus contain, retain, detain and transport highest mass energy modes constituted highest conserving mass energy phases, perimeter forms, Sets, hybrids, and domains. This and described prior figures depict continued mechanics of forms details and nomenclature. Introduction to the drawings details globose-conduit universe mechanics of forms, as sample Sets illustrate domains. Principles, inventions, and methodologies universe of presented forms which the drawings depict or specifications describe or sample figures illustrate reaffirms the inventions universal presence.

FIG. 26 of the drawings is a cross-sectional view of FIG. 25 of a Partition FESD invention generally taken about Line C-C showing a Partition section through Lower, 62, and Upper, 59A, Windows. PPLD forms, 7*, lowest form, 7*′, show a basin rounded lowest surface raised into a Partition as depicted and very much FIG. 4-5 Ridge FESD form similar, entirely separate forms.

FIG. 27 of the drawings shows a GC, globose conduit, “kidney”, globose-conduit cross-section form, a lower small rounded conduit area,85, a rounded transition surfaces intermediate,86, varied breadths area, and a rounded upper area,87, for a globose-conduit compact composite area curvilinear perimeter form about as shown PAP upright plane symmetric. Such a composite form constitutes nonhomogeneous, nonuniform, nonsteady fluid mass least gravitational weight pressures rotational frictional forces, mainly a laminar fluid mass. As mass transport constituted by said PP lengths least sum for its entire length or a finite length makes classic globose-conduit forms, a classic perimeter form, a GC DCSS FESD form, a composite three dimensional conduit form, and DCSS forms readily separated into three sub-outlets forms. As globose-conduits basic generic compact composite forms they are conduit FESD forms to transport a fluid mass mixture that constitutes highest mass energy conserving said classic forms. Among various mass energy transports or forms transitions, globose conduit perimeter is a generic building block to change a conduit transport to a globose retention form, or vice versa, or transfer potential to kinetic energy or vice versa. GC FESD forms highest mass energy self-conserving is based on mass properties said PP lengths least sum transfers into a rounded, an elliptical, or a curvilinear form, wherefore a pure fluid mass under hydrostatic pressure has entirely round forms. Properties of fluid mass must include not only its composition but quantity and its duration, also. Thus, GC transfers of forms to conforming least mass, rotations, and height and a largest free surface perimeter is most energy efficient. Clearly one form conserves most energy for a specific use compared to others. GC FESD forms conserve potential energy modal change transfer to kinetic energy or vice versa especially suitable to transport fluid mass mixtures through drain traps, drainage lines, or sewers. Said globose-conduit universe of forms has a specific classic form with its classic perimeter form for a specific cross-section at a specific location that is statistical data probabilities computed for fluid mass composition, quality and quantity, which is this, prior figures and DCSS forms shown.

Conduit inverts PPLD forms of infinitesimal to a finite to infinite length of cross-sections constitute highest elevations for a contained fluid mass least height largest free surface perimeter form. First Sub-outlet forms constitute continual inflow rounded conduit forms detention, sewer and drainage lines continually contained mass energy that has statistical probabilities constituted said PP lengths least sum highest fluid free surface elevation respective breadth and depth forms that pass particles largest sizes. A continual detention free surface elevation constitutes preferred fluid mass least height passing largest submerged particles size. Conduit springing point highest elevations initiates a transition or intermediate regions for out of ordinary fluid mass inflows said composition, quality, and quantity change constitute said PP length least sum, which makes fluid free surface highest elevation for a respective event cross-section breadths, such as sewers storm water runoff. For extreme events, such as a 100-year storm, said runoff is primarily a huge clean rainwater quantity, wherein solid particles segregated toward fluid mass lower elevations require globose forms upper perimeter of computed, PP lengths least sum. From said conduit to globose forms springing points constitutes transition regions where said PP least sum of highest fluid free surface elevations constitutes a computed breadths classic curvilinear form conduit, intermediate, and globose classic perimeter forms. Aforesaid is a sewer line example of perimeter computing. Described methodologies for perimeter algorithm computed forms provide a nearly exact highly specific perimeter forms for fluid mass and energy highest conserving which must include highly specific events, forms' aging models, with fluids gaseous state exceptions that applications have. This form is angled, based on infinitesimally angled PAP symmetry plane extended into infinity. It is shown as a cross-section perimeter extended from a PPLD forms rising slope with detention phases highest confined globose-conduit globose form for initial pant-up hydrostatic pressures, a transport fluid highest conserving initiated from a conduit spout PPLD forms. A globose-conduit globose area height vary from about 5% to about 95% of entire cross-section height with globose breadths up to many times greater than a vented pipe to which it connects.

After said screening processes water nearly uniform composition, gravity forces in optimal operational mode through said small lower region, thus slightly smaller, narrower than entirely round forms; said transition region and most of said globose region are submerged; said transition with lower region makes a “U” shapes deviation from entirely round form, with respective breadths at elevations forced by said MEHC, PP lengths least sum perimeter form; said upper globose region constitutes horizontal, major axis elliptical perimeter form with water free-surface vented as in open channel flow to avoid suction. Under atmospheric pressures, said natural disposition, open channel flows, near uniform compositions, least internal and boundaries friction force breadths from said “U” form into a large horizontal axis, nearly half-elliptical form.

Aforesaid forms along with enumerated nomenclature through generic FIG. 1 parent form unique origin universe orientation and rotation evolve or devolve, rotate, mutate, transpose, and transfer thus contain, retain, detain and transport highest mass energy modes constituted highest conserving mass energy phases, perimeter forms, Sets, hybrids, and domains. This and described prior figures depict continued mechanics of forms details and nomenclature. Introduction to the drawings details globose-conduit universe mechanics of forms, as sample Sets illustrate domains. Principles, inventions, and methodologies universe of presented forms which the drawings depict or specifications describe or sample figures illustrate reaffirms the inventions universal presence.

Mass blocks translation transports with no perimeter friction constitute absolute highest mass energy conserving for solid mass are translational frictionless boundary layer fluid mass transports with no internal fluid frictional or viscosity losses, for laminar fluid mass transport that is prior application inclusive. By accounting for frictional boundary layer energy losses said PP lengths least sum algorithm computes fluid form and perimeter for a least energy loss due to gravitational effects on nonhomogeneous fluid mass and for a statistical probability of fluid mass anticipated variability with cross-section forms, specifically breadths. An infinite number of globose conduit variations represented by only one form highest conserving fluid mass energy amount constitutes said PP lengths least sum. Again, one arrives at said classic forms for nonuniform quality, nonhomogeneous fluid mass and nonsteady pressures that vary with fluid free surface elevations, which differs from entirely round conduits construction. A profound, sewer lines crucial part of an open channel energy conservation is just one within a significant or infinite number of globose-conduit perimeter forms, which said PP lengths least sum can identify for a specific location, specific statistical data, and events. Again one needs highest fluid free surface and invert elevations for a globose-conduit form least height varied breadths that make a globose-conduit mass and energy least height highest conserving forms.

Globose conduit forms by said generic claims evolve devolve into, out of class round forms, transpose into or out of classic conduit and classic globose spherical retention forms, transfer among Sets of globose, globose-inverse, hybrids, and mutations domains that constitute mass and energy highest conservation universe of unique origin. FESD forms with their perimeter forms restrict fluid mass rotations. Partitions, and Widows, Ridges, and Troughs FESD forms are especially suited for sewer construction.

FIG. 28 of the drawings shows a circumferential strain generic Set's form with a sectional view through a basin form. A side elevation view linear PAP is forms upright surface symmetry.

FIGS. 29-31 show a cross-sectional taken generally about PAP upright symmetry plane of Set 10BF, 10AF, 10FA illustrating Flush Apparatus parts to flush, disinfect, surface protect or repair a deterioration and wear. FIGS. 4, 7, 11, 12, 19-25, and 28-31 show Flush Apparatus assemblies, many of them a tie-in to a major nozzle, which constitute a capping or a plug member for a basin lowest surface access through a portal. Flush Apparatus are entirely inside conduit walls, but for tie-ins, and are capable of flushing any location, such as basin retention, Inlet surfaces and or basin-outlet lowest surface PPLD width of band entire lengths. Flush Apparatus assemblies are pre-molded pre-assembled fluid, or gas, and or air supplied under controlled pressure to tie-in or tie-ins having an easy access. Sub-nozzles,301, sub-passageways, 303, major nozzles, 405, major passageways 304, 304′, 304″, 304S passageways 310 and respective branches set 307′ of tie-ins 307, a set of sub-passageways branches, 311, a set of sub nozzles 314 are selectively pre-assembled to deliver a designed specific pressure to a nozzle. Apparatus numerous parts assemblies are simplified by molded fabrication of parts inside conduit walls. A tie-in or a set of tie-ins is only outstanding part from a conduit wall and receives its pre-selected designed fluid(s) under pre-selected pressures to designated nozzles. A specific shape passageway such as upright Ridges FESD, FIG. 25, 29-31 depicts, a double wall inner space, 304S, passageway FIG. 29-31 depicts. A major nozzle 405 for a respective major passageway is spray type to flush entire basin lower, lowest surface and into an outlet and lower Inlet. FIG. 29 upper inlet is illustrates a double wall passageway, 304S, a sub-nozzles set, 314, and nozzles 301, and a lower Inlet and a basin passageway set, 304′, and sub-nozzles, 301. Shown Fin FESD form includes a sub-passageway, 303, set, 311, and sub-nozzles. FIG. 30 shows two Ridges FESD extending for an entire Inlet height, wherein said upright PAP plane aligns a passageway, 310, a set of sub-nozzles, 314, and major passageways two rings inside lower Inlet walls with a set of sub-nozzles, 314.

1. Globose-conduit (GC) conforming embodiments Universe of quintessential, core, natural dispositions mass energy highest conserving (QCNDMEHC) force completely matched complete complements compact composite Sets; ‘Fluids functions’ conforming least mass compositions at highest elevations least GC height least length continuous compact composite, fluid free-surfaces composite least rotations quanta mass forms perimeters least height most conserves mass energy; an inflow Inlet and the GC, basin-outlet, perimeter enclosure Sets or forms force quanta quantum mass paths-of-passage, PP, least sum lengths, in part upper retention submerged transition region respective undersurfaces-form as a globose Inlet lower end, an End 2, or a globose-inverse outlet spout lower end, a First End; the Inlet End 2 or the outlet First End globose perimeters fluid mass steady transports along lowest surfaces short slopes height, length and narrow breadths narrowest PPLD bands width force conduits mode forms; manipulated cross-sections varied areas complete complement breadths lift, raise, and set up higher density masses in front of much larger, globose boundaries, frictionless free surfaces, and conforming least mass uniform atmospheric, restrained hydrostatic, fluids steadied pressures dynamic flows; quanta masses transports, especially highest density fluids with raised mass centroids have right-of-ways entirely through said lowest surfaces at least three manipulated cross-sections modulating areas; a Set complete complement breadths complete complement globose open channel large free-surface forms least perimeter, height, and PAP angle (less than 180°) quanta mass least rotations are mass energy highest conserving FESD forms; globose-conduit functions need much smaller fluids quanta mass Set or forms than those of ubiquitous art; the End 2 or the First End, from sidelong to anti-sidelong locations, constitute domain Sets; globose and circumferential strain mutations make up hybrid domains; the globose-conduits drainage lines complete complement composite breadths enforce a small lower region, a mostly submerged transition region, and large upper globose region forms, Flush Apparatus pre-assembled inside walls of forms adeptly flush, sterilize, and or coat surfaces; the globose-conduit Inlet, basin-outlet GC Universe Sets and forms force QCNDMEHC conforming two globose two conduit ‘fluids functions’ mass energy synchronous coincident four-perimeters, boundaries mass energy highest conserving (MEHC), QCNDMEHC respective QCMEHC transistors/processors;
the conforming GC Universe fluids mass-energy four ‘functions’ confirm said continual Universe omnipresent four generic claims defined perimeters boundaries as one and the same, as the ‘functions’ force ‘sub-functions’ retained, transported mass-energy forces said generic claims quantum masses paths and patterns enforced perimeter boundaries forms and Sets and vice versa; thus, the ‘forms equal functions’ confirm, reconfirm and resolve Arts and Sciences many issues, such as, forcing reply to the Earth's ‘global warming’ mass-energy forced outflows into Cosmos;
these innovations correct the scientific community resources overlooked GC Sets, forms Universe, mass-energy highest conserving, MEHC, and QCNDMEHC formations and processes; valid enormous GC Sets significance is on par with the Laws of Mass and Energy Conservation; the GC Sets MEHC perimeters enforce enormously significant boundaries implements the Laws of Mass and Energy Conservation latent efforts to save the God device from goddamn devices; four generic claims physics, chemistry, thermodynamics laws and forbidden mechanisms merge; buried GC QCNDMEHC thermal aqueducts transfer their mass-energy heat portion into subsoil-surroundings through perimeter boundaries (except for insulated globose crown portions) with or without irrigation combat ‘global warming’, the Earth's surface cooling and the sea levels rising; near vacuum, least density least globose masses energy light pushed to infinity globose-conduits (GC) Sets mass-energy paths and patterns approach the speeds of light; the GC aqueducts cycled subatomic submicroscopic to cosmos mass heat energy systems combat electro-thermodynamics electromagnetics bounded perimeters Universe forced buoyancy/density, evaporation and suction forcing; energy ions, sequential equilibriums transport, generic claims compliant, force pressures and temperatures funnel spouts gravitational and dipolar electromagnetic fields' hydrodynamics, thermodynamics boundaries flux ions and electrons electro-superconducting up to speed of light;
said aqueducts are the first and only pro growth, supplied side economics, geological age periods direct intervention for the Earth's, Milky Way Galaxy living organisms' survival, highest conserving mass energy transports that conserve orbital masses irreplaceable commodity—water; aqueducts GC Sets and forms mass energy highest conserving in potential energy least elevation drop toward water-vapor emissions cuts force ‘greenhouse gases’ evaporations emissions cuts, in what are the Earth's atmosphere, “fast heating” potentially irreversible ‘global warming’ effects;
aqueducts with invert at steady state temperatures 2-3 m below grade dissipate heat easier than a stagnant air mass-media; as rivers strategic parts, said aqueduct energy highest conserving makes them rise continually in respect to natural-rivers; aqueducts detained storm/ground water mass slowly moves, enforcing heat energy radiated into subsoil as transported water mass energy steady flows ambience normally near coolest temperature and constitute investing into a precious commodity retention, detention and transport into industrial zones drinking, potable, recreational, commercial, or heavy industrial water usage processes; pitched aqueducts into said zones reduce circulating water pumps operations, power consumption, and plants down time repair costs, labor and materials; conserving purified or processed, commercial or industrial water energy, aqueduct sets rout to the next destination or industrial zone or eventual aqueducts water last length cooling prior to a discharge into a major water body; said mass energy conserving enforces cooler water masses management with no water evaporation loss to avoid water-vapor mass in the atmosphere prior to eventual release, with rivers land erosion managed or reversed, with industrial waste heat by-products land mass retained; said heat energy transfer forces the Earth's crust as heat-sink to cool or in irrigation retain water-vapors precipitation or raise groundwater elevations indefinitely continually forced cooler large water bodies for atmospheric masses smaller water-vapor masses;
the aqueducts essential heat energy transfers from atmospheric precipitations and surface runoffs to subsoil also provides for irrigation means to raise groundwater levels with a watershed runoff and topsoil losses control; an ecosystem support can include hydronic farming agriculture;
groundwater levels at prior historically higher natural elevations provide significant fresh water forced underground retention or detentions, especially where forced throughout continental climate zones; the underground aqueducts reduced evaporation, make for riverbanks, flood levies related structures, river water temperature curbs and topsoil moisture control to counteract higher precipitation rates, raised ocean levels and polar caps or glaciers melting; the continental crusts' water evaporations conforming to crustal geology, groundwater, and recent topsoil historical data removes significant water-vapor masses retained by the atmosphere, in a water mass global effort transports, by safe best technologies most cost effective methods for paybacks through centuries;
water-vapor models showed ‘greenhouse-effects’ three times those of the carbon dioxide with the two combined forcing about half of the ‘global warming’; said thermal GC aqueducts MEHC Sets strategic locations in the Earth's crust, gravity field, and its atmosphere mass energy thermodynamics as the God device genres cadre must enforce strategic magnetic field's systemic equilibriums' stabilities; from rivers and river flood plains, aqueducts claim orbital globose crust, gravity magnetic field, atmosphere, ionosphere, and solar winds deformed magnetosphere fluids' configured multiple systems flux balanced equilibriums consistencies, affixed strategic locations;
aforesaid point to oceans masses forcing ‘global warming’; greenhouse gases force heat transients peaks; the ionosphere as the cooling media ionized water-vapors replenish; irrefutable corrective action, unquestionable germane scientific factual data force the God device aqueducts;
the Earth's uniform radially directional gravitational force spherical field forces orbiting crust masses atmosphere, ionosphere constituted globose forms; the atmosphere, troposphere and stratosphere similar perimeter forms are contained by the ionosphere inside a perimeter boundary shapes controlled by the Earth's dipolar magnetic field lines globose shapes that in said magnetic cusps conceal funnel like shapes and their access into the Earth's fluids; at the geographic poles proximities, the funnel like forms retain access into the atmosphere, ionosphere quantum masses, especially when a cusp's innermost or dipolar outermost lines disconnect; with the two cusps as conduits, the Earth's electromagnetic field generates its GC, globose-conduit, Set where either of said cusps' lower end the Earth's fluids submerge for an End 2 and a globose domains Set, which forces the other cusp as an outlet with a fluids submerged First End in a globose-inverse domains Set; fluids flow directions enforce the Earth ‘functions’ as the globose or the globose-inverse Set;
the Earth has fluids electro-thermodynamics mass energy sequential equilibriums thermodynamics forms superconducting in the Milky Way galaxy Solar System that includes smallest to largest globose-conduit forms, with each living organism detail conforming to the universal mass energy laws that enforce a must fit; the Earth's GC mass crust, atmosphere, and magnetosphere fluid-thermodynamics electro-superconducting forces its mass energy accounted;
under a forcing the electrons flow along the magnetic field lines; the ionosphere mass is restrained by the gravity and electromagnetic field forces usually stronger than ions, free electrons collision forces but not always stronger than the solar or cosmic winds and radiations and their forcing pressures; the dynamic perimeters fluxing GC magnetosphere boundaries try to preclude ions escaping into space, but each of the two magnetic field lines spout funnel cusps can function as an outlet vent;
the Earth's magnetosphere dipole magnetic field perimeter boundaries enclose the cusps' funnels to constitute GC perimeter forms highly influenced by the solar and interplanetary winds pressure and radiations on magnetic field lines that affect the funnels; said winds with pressures deform the magnetosphere; the magnetic field instantly engages to constitute the magnetic field's lines stable equilibrium boundaries; said atmosphere, magnetosphere dynamics force ionosphere temperatures pressures magnetic field lines electrons flow to counteract, restore, and reconnect to reassemble magnetic lines into stable electro-thermodynamic equilibrium fluxing configurations;
recent satellites observed plasma fountains shaped by the magnetic poles cusps extended from geographic poles proximity through the magnetosphere spew hydrogen, helium and oxygen ions plasma into space; cosmic, solar wind pressures coronal mass ejections and plasma outflows distort the magnetosphere shoulders skimming passed the Earth's rotations tilted magnetic cusps' mouths forced monatomic ions energetic plasma discharges into space; the ionosphere boundary suction indeed exists as a catalyst to plasma discharges and atmosphere's catastrophic blow-offs;
details of the Earth's geological history with astronomical observations reveal the iron clad evidence that the Earth is in the fight for the survival of its living organisms, as it is loosing its water “cooling/heating” fluids, from aged or inefficient thermodynamics mechanisms;
said Jean's plasma fountain magnetosphere perimeters basically GC globose-inverse Sets higher energy occasionally transferring into said GC Sidelong Sets force said four generic claims physics, chemistry, thermodynamics forbidden mechanisms laws to merge, and GC Globose Set forms higher energy excitation states allow transfers back to lower energy states, globose-inverse Sets complying to forbidden mechanisms that come in pairs, provided lost fluids vapor to space is replenished; said default states lowest mass energy excitations rise to repeat significant events;
ice age onset Milankovich's calculations predict and forced by said GC Sidelong Sets higher excitations at magnetosphere's largest volumes multiple times enlarged over said globose-inverse Set volumes to force a ‘blow-off’; said default energy states forced glacial ice advances left behind cooling/heating fluids retreated glacial ice Earth's geology crustal landmarks features,
said Earth and planets electromagnetic fields resist stratifications, gradations mechanisms processes and only by force pass finest, lightest particles, ions, stellar energies emitted radiations waves; larger, lighter or heavier atoms or ions escape occurs only in significant ionosphere losses or highly stressed magnetic filed lines collapses said Solar and cosmic systems forced radiations;
said forbidden mechanisms nonzero probability relate intrinsically to forbidden processes exemplified by magnetic field collapse and shifts to new geographic orientations; extremely low probabilities phenomena processes mechanisms identify forbidden, as exclusively seen on global scale; cosmos omnidirectional, space-time infinite matrixes of galaxies and stellar systems force highly commonplace forbidden mechanisms processes and phenomena; enforced omnidirectional processes said matrix infinities lead to said stratified black holes outcome; said GC Sets or forms actually constitute valid forbidden mechanisms, Universe Sets or forms which combat, oppose or scramble said black holes stratifications gradations processes; said GC Sets and forms qualify for the God device cadres; said QCNDMEHC GC Sets and forms force said combat for fluids in said gravitational and magnetic fields cosmic interstellar wind pressures, radiations and fluid densities said related forces; cosmos implemented GC Sets populate exactly the same said omnidirectional infinite matrixes, for each instance with infinite energy and water conserving, said QCNDMEHC intelligent processes; said four generic claims physics, chemistry and thermodynamics forbidden mechanism laws merge, again; but, in this instance for respective planets' retained water masses for living organisms' potential habitats in retained water masses not lost to space or a black hole;
aforesaid identified said Earth's two critical processes; more frequent of the two, glacial interglacial periods sequence, Milankovic calculations predict; the other, said magnetic field very infrequent shifts large deviations forbidden mechanisms our current science most readily ignores,
and thus, GC Sidelong Set QCNDMEHC constituted highest excitation states occur prior to the time magnetosphere partial ‘blow off’ default boundaries contract to least size perimeters; unless said least densities forcing suction in said magnetosphere or said cusp's mouth or shoulders is relieved said magnetic field collapses; said magnetic field after said partial ‘blow off’ triggers ice age with the GC Sidelong Set transposed back to its GC globose-inverse Set and said contracted default-smallest perimeters; said cusp discharges fluids as said magnetic field GC Set flows' outlet; said other cusp restores electromagnetics, hydrodynamics and thermodynamics fields stable equilibriums as a pressures relief vent with said Inlet End 2 and said outlet First End respectively submerged in air masses, unless a collapse occurs; said magnetic field's rotation and orientation forbidden mechanism in respect to the Sun said QCNDMEHC forces; said forbidden primarily magnetic field mechanisms trigger ice age forcing said Earth's fluids mass huge losses; then, under Sun radiations ice masses sublime, waters evaporate, the atmosphere and ionosphere replenish and expand and with time restart plasma fountains; said glacial period sequences force Earth's water budget continual huge losses and glaciation periods left behind geological features; said electromagnetic field rotation or orientation shifts force atmospheric fluid masses enormous losses to said interstellar and Sun wind pressures and radiations; the Moon's ice and fluids mass said radiations and pressures with Earth's irradiations likely blew away, at the time of the Earth's first said electromagnetic rotations with orientation shift; geological evidence points to said Earth once extensively featuring glaciation mass also was impacted by ice-water occasional meteorites;
the Earth's electromagnetic field force rotation orientation shifts, said stratifications and gradations, and said glaciation periods ‘global warming’/cooling cycles geologic history depleted water mass/vapor mass-energy budgets enforcing waterless state frozen planet status enormously forcing by said pressures, radiations and hydrodynamics thermodynamics equilibriums processes need no ‘greenhouse gases’ effect; globose-conduit magnetosphere ions or electrons flows exhibit cusps high conductivities with QCNDMEHC processes forcing thermodynamics and hydrodynamics energy transformations with perfection; said aqueducts enforced palpable ultimate hydrodynamic energy generation enforce water mass flows maximum delays toward tropics without stagnancy emitting no water-vapor into the atmosphere, forcing largest heat transfers to subsoil and least transported eroded soils fill into the oceans' and crustal depressions; said Sets, forms forbidden mechanisms processes counter said stratifications processes eroding peaks filled depressions, smooth, globose spherical, rotating, orbiting sterile surfaces and such ice covered similar said planets; again, said QCNDMEHC water-vapor masses fundamentals optimal processes combat aforesaid final result;
said GC MEHC, QCMEHC and QCNDMEHC Sets constitute living intelligence; said quintessential, core, natural, buried GC aqueducts perimeters heat energy transfers with or without irrigations combats fluxing oceans levels, ‘global warming’ effects, the Earth's surface cooling, said atmosphere, ionosphere enlarging and thus water ions plasma outflows into space; the orbital crust is one; the atmosphere, magnetosphere and cusps are other strategic boundaries;
said GC aqueducts cycle heat energy from subatomic and submicroscopic to cosmos mass energy systems combat electro-thermodynamics, electromagnetics perimeters bound universe buoyancy, density, suction, and evaporation thus save the Earth's water; cosmos Sets and forms creative intelligence databases do not exist; said GC Sets, forms physical state, QCNDMEHC and MEHC intelligence structural arrangements counter said gradations stratifications processes stratified, graded atomic weights, solid state matter, universal forms gaseous, liquids, and solids; said GC Sets and forms make liquids states universe mechanisms which counter to them mortal stratifications, gradations processes thereby avoiding catastrophic default states said QCNDMEHC forbidden mechanisms;
said GC thermal aqueducts' structure crucially enforce atmospheric heat energy transfers into the orbital crust stop plasma fountains primarily water ions discharges into deep space which conserves the Earth's heat energy and water mass by heat containment within the orbital crust; instrumental for this process are said GC aqueducts Sets, forms, inside atmosphere's conforming GC, globose-inverse Set, form; said aqueducts must make huge capacities heat sink for retained water heat transfers into orbital crusts; said GC Sets and forms conserve infinite water mass and energy with prototypes and on global planetary scale as they curtail or shut-off plasma fountains, documented prior applications prototypes verified mass-energy conserving; said globose-conduit Universe makes perimeters boundaries internal structures intelligent arrangements (IA) functions and stratifications gradations arrangements (SGA) Order, atomic weights' compositions IA, SGA continual one against the other conflicts/confrontations for forbidden mechanisms final outcome;
in forced conflicts, least mass energy dissipations or highest QCNDMEHC prevails; mass energy forced relative densities enforce said buoyancy, density, suction, and evaporation forcing;
in diatomic masses, two water-vapor molecules, triatomic perimeters compact better than diatomic oxygen, nitrogen three molecules combinations and lighter air masses specific gravities, especially with diatomic perimeters air mass uniform gradation higher specific gravities; greater molecular structures variety gradations, greater compaction, lighter mass per unit volume include triatomic water-vapor molecules; thus, greenhouse gases stratified layers with water vapor makes for thermal inversions phenomena mainly over cities; said air masses retain even more of the Sun radiated, the Earth irradiated heat energy thus peaking atmosphere's temperatures; water-vapors gas masses built to high altitudes force ‘global warming’; condensed gaseous vapor, greenhouse ‘acid rain’ are the Earth's counters to stratifications gradations processes, forced more interstitial voids proportionally lower radiation and reradiation intakes for higher irradiation heat into space;
said Generic claims, QCNDMEHC, GC Sets, and forms highly define nonhomogeneous, nonuniform, nonsteady, laminar flows perimeters, boundaries makes for intelligent arrangements (IA) perimeters, boundaries devices, including aqueducts as hydrodynamics and thermodynamics electromagnetics mass energy transistors/processors; said transistors/processors process, conduct quantum mass energy analogous to transistors, processors electrons charges binary method but in fairly complex fashion for highly variable environment; said I/A devices, fluids flows analogous to transistors/processors force quantum masses energies, densities state, quantum masses laminar flows, perimeter forms and interfaces boundary forces, including evaporation, buoyancy, suction;
‘global warming’ is atmospheric warming due to causes that the Invention Summary lists; said cycles repeat provided said budgets masses revive an atmosphere and an ionosphere; said SG fluids mass energy cyclical processes power only interplanetary/geologic dating reveals;
thus, said water vapor SG processes force said ‘global warming’, interglacial periods and atmosphere's warming with the Earth's forced many geologic periods cyclic cooling; thus, blow-offs shrink said atmosphere, ionosphere to lowest volume globose-inverse forms, plasma inflows low pressures, temperatures, least WVMUSCV bulbs and mass densities forcing a glaciation age;
magnetic field electro-thermodynamics said forms with Sets constitute assembly systems advanced Order, an IA main processor; the Solar System, Milky Way, Universe as advanced IA main processors constitutes highest, multi-core highest, and the highest Order, respectively; correlations respective energy relationships from one to other forms of energy frequently applied to electrical and fluid flow relationships verify said GC thermal aqueducts as the countermeasure to said fountains' forbidden mechanisms; said thermal aqueducts waters QCNDMEHC quantum mass energy can seamlessly substitute said fountains' heat energy dissipated into space with heat energy transfer into the continental crust, seamlessly integrating said advanced IA main, highest, multi-core, and the highest Orders processors, GC Sets/forms processors inside the GC Universe;
the Mars observations confirm, without doubt, the aqueducts shielded water masses from direct sunlight force viable technology; said QCNDMEHC perimeters, buried, thermal aqueducts hydrodynamic thermodynamics transfer aqueduct contained precipitated water vapor heat energy into continental crusts; most importantly, said aqueducts irrigation systems network removes the water-vapor from the atmosphere into the continental crusts groundwater storage up to its highest permissible elevations; aqueducts and groundwater shielded precipitations delay immediate and eliminate significant water masses evaporations normally forced by said Sun's radiation, Earth's, and clouds' irradiations to stay in said Earth's atmosphere heating/cooling cycles; thus removed heat energy and fluids from the atmosphere into the Earth's continental lands masses combat said ‘global warming’ or reduce said irradiations and radiation, and fluids heat energy the atmosphere contains, with greater heat energy portion irradiated into space; most crucially, said GC Sets and forms QCNDMEHC least frictional losses with or without irrigation with least pitched aqueducts networks in land masses enforce longest paths longest duration water masses heat energy highest transfer into the Earth's crust with water masses at lowest temperatures at aqueducts discharge to require radiations, irradiations heat energy largest amounts to evaporate;
the Earths as the God device IA main processor makes supra buried thermal aqueducts networks the God device cadres that primarily oppose said plasma fountains, the goddamn devices cadres;
said buried thermal aqueducts and timely, globally implemented water-vapor cuts avoid a potential, partial blow-off, which when prolonged causes a magnetic field shift; said continental groundwater rises, stored enormous water volume weights, must rise gradually across continents, and thus, avoid destabilizing eccentric weights that could cause a wobble in the Earth's rotations;
said aqueducts strategically located along river banks force groundwater levels restored to higher elevations, with lawns watering methods progressive activation that manages the water available;
physical densities and chemical transfer processes energy, and electric, muscular, nervous system impulses and flux duration intervals, dynamics and interactions oppose said SG forced processes;
said analogies group humans and the Earth into said GC Sets, forms, IA advanced Orders processors two separate categories; humans' cognitive, intelligence, communication and motive energy directional skills differ; however, the Earth enforces said activities and skills; said GC Sets and forms IA Orders, processors said QCNDMEHC at the core of said extended life enforce MEHC laminar flows four unique generic claims, especially devised for quintessential purposes of enforcing quantum masses flows highest mass energy conserves said perimeters and boundaries;
aforesaid GC QCNDMEHC Sets, forms human longevities, infinitesimal compared with Earth's longevities, said invention, methodologies, and principles enforced comparative biologic, inorganic analogies, especially said inorganic features, enforce same Laws;
said GC inventions, principles, methodologies enforce most comparative said analogies which the Laws of Mass and Energy Conservation and Thermodynamics mandate;
said buried, thermal GC QCNDMEHC aqueducts fluids energy electromagnetic thermodynamics hydrodynamics shunt radiations, irradiations, and said ‘global warming’ processes heat energy to reheat nominally the Earth's crust forcing longer longevities enforcing mass energy heat balance;
said buried thermal aqueducts QCNDMEHC GC, Sets and forms boundaries perimeters force radiations, irradiations excess heat energy from the collected atmosphere precipitations water masses into the crust; thus forced processes conserve infinite water masses as such no water loss is enforceable into infinity; said atmosphere's radiations, irradiations excess heat energy transfer into the Earth's crusts stops plasma fountains mass energy outflows into space;
said atmosphere's mass low heat energy irradiations to space force said ‘global warming’ and fresh water reserves and polar caps dangerous depletions, which force water-vapor ions said plasma fountain outflows; said GC buried thermal aqueducts partially reroute natural heat energy emission from the Earth's matured masses for their geological times long periods slowed cooling processes, while at the same time, lower vapor emissions into the atmosphere enforce higher heat energy irradiations to space, and leads to the atmospheric ‘global cooling’ plasma fountains shut-offs forced water masses said MEHC; said GC buried thermal aqueducts, said heat energy shunts preclude said SG processes and said plasma fountains; most crucially, they shunt said radiations, irradiations and industrial and power generation byproduct heat energy into the Earth crustal and magnetic field rejuvenations, thus precluding said Earth's eventual forced drying-out or freezing;
buried, thermal, GC, aqueducts networks empower industrial electrical energy generation with their byproduct heat energy critical usage, for Earth's prolonged longevities preserved water reserves fluids hydrodynamics, thermodynamics, electromagnetics, inner boundaries heat energy transfers, precluding said magnetopause, cusps outer boundaries mass energy outflow into space;
it is the Earth's electromagnetic field retained ionosphere contained atmosphere that saves the God device; thus, said magnetic field perimeters boundaries place it in the God device domain genres cadres; fluids and devices mass energy that support the magnetic field fall into the God cadres category provided each constitutes longevity enforced significant generated energy which is forced into residing inside said Earth perimeters boundaries;
thus said GC Sets and forms mass energy forcing said QCNDMEHC and MEHC processes force the God device cadres and crucial genres; mass, except for supra excluded formations, especially SG mass energy formation particles force eventually goddamn devices formation(s) including the so called ‘God particle’ which actually is the goddamn particle; said God devices mass energy formations reside in living organisms, also; electrons' motions or dynamics supporting natural, devised electromagnetic fields and inorganic, living perimeters boundaries mass and energy are the God device only subatomic genres, cadres;
the conforming GC Universe fluids mass-energy four ‘functions’ confirm the continued presence of the four generic claims forced perimeter boundaries Universe as one and the same, as the ‘functions’ force ‘sub-functions’ retained, transported mass-energy forces said generic claims quantum masses paths and patterns enforced perimeter boundaries forms and Sets and vice versa; thus, the ‘forms equal functions’ confirm, reconfirm and resolve Arts and Sciences many issues, such as, forcing reply to the Earth's ‘global warming’ mass-energy forced outflows into Cosmos; from the Earth's genesis to present, surfaces and environment that include glaciation periods and their triggers the Universe fluids' masses and energy omnipotent said SG processes unrelentingly dominate; the Earth as an infinitesimal, insignificant, and unwillingly forced participant unless defended by utmost knowledge, skill and effort converts to a goddamn planet device in infinite domain population; said forced SG processes ‘global warming’, energy crises and water masses depletions imperiled Earth's survival, said fluids' MEHC, QCMEHC and QCNDMEHC combat; said ‘sub-functions’ satisfying, one ‘forbidden’ function, said devices three-‘functions’ force said GC Sets and forms more rare than diamonds said four ‘functions’ with four coincident perimeter, boundaries: conforming fluids' least quanta, transition regions submerged, high density particles' transport, and MEHC; said four ‘functions’ force globose and conduit ‘functions’, each enforcing said MEHC transition region submerged for each form's MEHC ‘function’ enforced high density particles transport; said Mass and Energy Law statement that mass and energy cannot be created or destroyed should continue with: mass and energy transport or transfer into counterpart mass or energy forms energy forced releases at critical energy state and perimeter boundaries can enforce sudden uncontrolled QCMEHC discharges collapsing its GC said God cadres said genres system;
said GC Sets and forms four ‘functions’ force Earth's and atmosphere's masses functions retained by the gravitational field reinforced by superimposed enforced magnetic field perimeters boundaries, ‘global warming’ MEHC Mass and Energy Laws interglacial, glacial period triggers geological science evidence said masses phenomena enforced conforming least mass boundaries; frictionless fluids' least, near-frictionless perimeter boundaries force said MEHC QCNDMEHC; in time and space, ‘substances’, mass energy, constitutes dynamic globose conduit, GC, globose-conduit Sets, forms enormously powerful innovations, principles, and methodologies in common origins with ‘substances’ omnipresent said ‘functions’, Universal root forms, paths, and patterns; said Mass and Energy Conservation Laws forced said innovation, principles, and methodologies ‘functions’ perimeters boundaries or vice versa enforce mass energy enormously powerful tools;
said plasma fountains are key process in said SG processes forcing; said buried, thermal aqueducts are key structures in the God devices cadres, genres functions and only such structures to combat said SG processes ‘global-warming’ forcing the Earth's changes to a goddamn device; thus, said aqueducts crucial to the Earth's and electromagnetic field's longevities function belong in the God device cadres, genres; said MEHC, QCMEHC, and QCNDMEHC by association with said aqueducts said Sets, forms and ‘functions’ qualify said drain traps, sewer lines, and drainage lines Sets and forms fluids' conserving mass energy as the God device supporting cadres, genres;
a generation-one, millenniums longevity nuclear power plants forced electrons-flow bulk mass-energy generation across enforced sequential and in parallel secured perimeters, boundaries buried, thermal aqueducts circumvented SG processes is the only such God device genres, cadre; said plants processed energy is forced to residing inside said Earth's inner perimeters boundaries; environmental scientists, bulk energy producers prognosis has fluid vapors SG processes toasting the Earth unless said decisively deployed genres cadres prevail; said water-vapors said blow-offs in millenniums freeze her; narrowing her orbits for fluids circulation increase, she overheats; said cadres forced MEHC water masses and vapors balanced budget has the mankind's survival hope;
thus wind energy bulk power generation robs said Earth as advanced Order IA processor of winds energy that naturally cools her; geothermal, land-solar bulk energy generation weakens said magnetic field strength perimeter boundaries protection of her fluids; fossil fuels generation of bulk energy speeds said SG processes; all human energies, intellect should deploy said cadres; fluids MEHC, QCMEHC and QCNDMEHC combat Universal stratification gradation processes ‘global warming’, energy crises, and water masses depletions which imperil the Earth's survival;
said Mass and Energy Conservation Laws advancing engineering-sciences' transfers into practice, said cadres genres MEHC, QCMEHC and QCNDMEHC forced Sets, forms, and ‘forms equal functions’ fully enforced by said generic claims innovations, principles and methodologies; the God device said Earth's fluids ‘functions’, said perimeters' mass energy highest conserving said cadres genres ardently enforce; else, man-activities variably contribute to said SG processes; after intake structures screening processes, water into said aqueducts inner polished MEHC said surfaces ‘forms equal function’ conforming to said quantum mass PP lengths least sum perimeter constitutes said complete complement composite breadths forcing a small lower region, a mostly submerged transition region and large upper globose region forms; after said screening processes water nearly uniform composition, gravity forces in optimal operational mode through said small lower region, thus slightly smaller, narrower than entirely round forms; said transition region and most of said globose region are submerged; said transition with lower region makes a “U” shapes deviation from entirely round form, with respective breadths at elevations forced by said MEHC, PP lengths least sum perimeter form; said upper globose region constitutes horizontal, major axis elliptical perimeter form with water free-surface vented as in open channel flow to avoid suction; briefly, the Universe fluids mass and energy said SG processes enforce; unless God device said cadres genres succeed, the Earth toasts first to then subsequently forced into a frozen over planet; electrical energy flows like a fluid, is the Earth's mass mostly bounded, thus is treated as a fluid; said nuclear plants produce no new fluids, vapors mass energy or discharges into the atmosphere and force byproduct heat energy into the Earth's crust, and thus is not seen and perceived by said Universe SG processes; said GC Sets and forms MEHC, QCMECH, and QCNDMEHC contain, retain, detain at best operating mode fluids bulk transports mass energy, which likewise forces its heat energy transfers to the Earth's crust; said cadres give the Earth's living organisms a chance;
said GC Set, forms (FIG. 2-3) compared to a ‘simple trap’ known as ubiquitous and most varied utilization taken as the USPTO present state of art device finds said simple trap's retained, conforming least mass 2.5 times greater, and the useful work done in one retained mass complete turnover raises two times higher than the GC Set, to a must five times greater mass energy usage; also, for the simple trap a least operating pressure is 2.250 times higher and it rises much faster that for the GC Set after a small initial rise, since said GC Set best operational mode outlet FESD ascending spout forms can have composite cross-sectional area an order of magnitude larger than its Inlet cross-section area; said simple trap surfaces-interface area is five times greater, with said pressure area multiple 11.25 times greater; then, there are coefficients of friction dynamic flows slope angles multiples, best illustrated with the PPLD greatest slopes of about 50 degrees and for simple trap 90 degrees; said angles sine ratio raises said multiple by a factor of about 1.3 to 14.6; also, there is flow rotational angles difference illustrated by 105-degrees PAP angle compared to 180 degrees for the simple traps; said elbows taken as the respective angles sine ratios raises said multiple by a factor of about 4; it is known that the fluid flow handbooks provide pressure drop caused by a 90° elbow with simple trap having three; and the GC Set, in fact, has none for the inflows into its much larger globose basin is primarily cross-sectional area change having a much lower pressure drop than it is for 90° elbows; also, there is a time factor represented by respective PPLD lengths; said GC Set's PPLD length is less than half of said simple trap respective length; the larger mass turnover contains high specific gravity particles higher number; when flow stops their paths retrace cause blockage, not just efficiency losses; elementary sciences said computing has said GC Set using two, three orders of magnitude less mass and energy than said simple trap;
machinery mechanism processes forcing a regulatory and three construction Parts are the following:
I. photoelectric-cell or film machines upper shell, least latitudes transcontinental air routes and routes least altitude converted solar radiations to electrical energy enacts the regulatory Part; least latitude has the machines in reduced interstitial space, highest water vapor air mass for least greenhouse gases ambient temperature difference, greenhouse gases shortest downward paths to their settling places; the routes concentrations concentrate greenhouse gases within remaining least interstitial spaces heavier air mass volumes rises, enhanced downward move opposing water vapors air masses rises to highest altitude, movements toward the poles; the machines entirely, the greenhouses gases partially block out Sun's most intensive radiations; said machines and emissions enhance positive effects, counter WVMUSCV bulbs enlarging;
II. floated over water blankets or tarpaulin photoelectric-cell or film fields that block radiation; structural, anchored grid, yet allowed, to move with spacings or holes that avoids dead spots or underside molding; plastics, not limited to PVC, floating tubes frames, restricted rotation joint connections allow the field movements at joints but entirely stiffens cells entire frames; electric cables through tubes, joints, and circuit breakers feed localized power demand grids;
III. machinery mechanism versions solar mirrors or panels instead of said photoelectric-cell/film fields steam or hot water suitable piping generates electricity and shields surface water fluid; floated versions are most suitable for medium size recreational lakes; said machinery fields supported above water from water/river bed make said blocked Sun machines versions, also;
IV. said photoelectric cells, films covering cars and trucks free surfaces powering their batteries;
said machinery mechanisms resilient water environment and weather proof constructions block SG processes evaporations; said ground insulated vehicles said surfaces reduce irradiations;
Earth's water/ice/fluids masses inventory budgets brief summary is the following:
IV. historical records least glaciation ice mass, forcing much younger glacial-ice thicknesses;
V. continental crusts deeply cut riverbed channels, for lakes, groundwater lowest elevations;
VI. said least glaciation ice surfaces globose atmospheric air and ionosphere largest volumes;
said water ice/fluids masses budget quantities rates show the following evidence:
IX. scientific reports have glacial masses in retreat with melting at accelerating rates;
X. deeply eroded river beds are generally delivering water mass in largest quantities to tropical belt based on the continental crusts corresponding groundwater levels;
XI. rivers and continental groundwater levels constituted largest exposed waters free air interface surfaces with air masses near historical high or highest temperatures;
XII. largest ocean-waters free surfaces, air masses interface; with ice caps by far near historical least surface areas; said air masses near historical highest temperatures;
XIII. fluids currents cool enlarging volume masses with glacial ice by far least masses;
XIV. said historical largest volumes least air mass voids retain Sun's, cosmic radiation large part; solids and vapors clouds reradiation with historically highest amounts;
XV. aforesaid has plasma fountains start at glaciation period historically earliest time;
XVI. smallest polar ice caps least coldest-air mass least engulfs magnetic field's cusps;
the following show that the Earth's heating is at historically higher rate:
IX. smallest polar ice caps are observed melting at accelerated rates,
X. said melting ice caps rates create surfaces accelerated water rate,
XI. historical interglacial period forced early plasma fountain starts,
XII. unfriendly WVMUSCV large bulbs enforcing plasma fountains,
XIII. said WVMUSCV bulbs growth is ionosphere ions faster growth,
XIV. said masses growth rates forces atmosphere volume growth rate;
XV. atmosphere fastest growth is evaporated water mass growth rate,
XVI. evaporated water mass rate reflects ice caps fastest melting rates;
supra enumerated water budget inventory, quantities, with rates repeat cyclically through the interglacial periods, with continually smaller ice caps mass quantities forcing each cycle; the enumerated confirms fountains outflow into space sufficient ions mass energy for each respective hemisphere to avoid the forbidden mechanism partial blow-off, except at said glacial trigger time;
‘global warming’ is a misnomer in the sense that it is the Earth's water budget continual, cyclical depletions' effects, solid masses cooling, forcing the Earth into a frozen state status; greenhouse gases are overly accused of ‘global warming’; here, said ‘global’ is atmospheric warming due to following causes:
I. multi-atoms molecular perimeters replacing uniform gradation masses of diatomic gases,
II. nonuniform perimeters molecular compactions reducing interstitial voids' space, volume,
III. diatomic air mass enlarged atmosphere's volume forms by triatomic water vapor masses;
IV. air masses rising to higher altitudes with higher water vapor contents lower mass weight,
V. nonuniform perimeters compacted air mass retains larger radiated, irradiated heat energy,
VI. air volume larger water vapor contents mass forces the air and ionosphere larger bubbles,
VII. electromagnetic field must have low moisture contents air mass in proximity of its cusps,
VIII. hydrodynamics, thermodynamics need heat energy transfers, across its fluids boundaries,
IX. earth's ice/water and gases cyclical equilibriums fluxing boundaries transfer heat energy,
X. earth's aging erosional effects accelerate rates in thermodynamics hydrodynamics cycles, heat energy transfers need water/vapor budget fluids and ice masses appropriate margins;
the forgoing summarizes the SG processes following glacial interglacial period changes:
I. enlarger oceans, retreating ice caps, and lowered continental groundwater levels,
II. significantly lower budget water-ice, ice and water-vapor water respective ratios,
III. significantly enlarged atmosphere, WVMUSCV bulbs and ionosphere forms Set,
IV. said atmosphere climate, ecology, WVMUSCV bulbs/ionosphere forms changes,
V. magnetic line disconnects more viable; smaller ice caps for less cool fluids mass,
VI. faster glacial ice retreats, higher evaporation rates with greater vapor-ions losses,
VII. glacial histories show no greenhouse gases contributed to glacial periods-trigger;
